(19) United States
(12) Patent Application Publication
(10) Pub. No.: US 2020/0318212 A1
(43) Pub. Date: Oct. 8, 2020

(54) HIGHLY-PERMEABLE SOFT-MAGNETIC ALLOY AND METHOD FOR PRODUCING A HIGHLY-PERMEABLE SOFT-MAGNETIC ALLOY

(71) Applicant: Vacuumschmelze GmbH & Co. KG, Hanau (DE)

(72) Inventors: Jan, Frederik FOHR, Rödermark (DE); Johannes TENBRINK, Mömbris (DE); Niklas VOLBERS, Bruchköbel (DE)

(21) Appl. No.: 16/759,319

(22) PCT Filed: Oct. 25, 2018
(86) PCT No.: PCT/EP2018/079337

§ 371 Date: Apr. 24, 2020

(30) Foreign Application Priority Data
Oct. 27, 2017 (DE) 10 2017 009 999.5
May 24, 2018 (DE) 10 2018 112 491.0

(51) Int. Cl. C21D 9/46; H01F 1/147; H02K 1/02; C22C 38/52; C22C 38/50; C22C 38/48; C22C 38/46; C22C 38/44; C22C 38/42; C22C 38/06; C22C 38/04; C22C 38/02; C22C 38/00; C21D 8/12; C21D 8/00; C21D 6/00

(52) U.S. Cl. CPC C21D 9/46; C22C 2202/02; H02K 1/02; C22C 38/52; C22C 38/50; C22C 38/48; C22C 38/46; C22C 38/44; C22C 38/42; C22C 38/06; C22C 38/04; C22C 38/02; C22C 38/005; C22C 38/001; C21D 8/1283; C21D 8/1272; C21D 8/1261; C21D 8/1222; C21D 8/1233; C21D 8/005; C21D 6/008; C21D 6/007; C21D 6/005; C21D 6/004; H01F 1/147

(57) ABSTRACT

A soft magnetic alloy is provided. The soft magnetic alloy consists essentially of 5 wt %≤Co≤25 wt %, 0.3 wt %≤V≤5.0 wt %, 0 wt %≤Cr≤3.0 wt %, 0 wt %≤Si≤3.0 wt %, 0 wt %≤Mn≤3.0 wt %, 0 wt %≤Al≤3.0 wt %, 0 wt %≤Ta≤0.5 wt %, 0 wt %≤Ni≤0.5 wt %, 0 wt %≤Mo≤0.5 wt %, 0 wt %≤Cu≤0.2 wt %, 0 wt %≤Nb≤0.25 wt % and up to 0.2 wt % impurities.

This U.S. national phase patent application claims the benefit of PCT/EP2018/079337, filed Oct. 25, 2018, which claims the benefit of DE application no. 10 2017 009 999.5, filed Oct. 27, 2017, and DE application no. 10 2018 112 491.0, filed May 24, 2018, the entire contents of which are incorporated herein by reference for all purposes.

### BACKGROUND

### 1. Technical Field

The present invention relates to a soft magnetic alloy, in particular a high permeability soft magnetic alloy.

### 2. Related Art

Non-grain-oriented electrical steel with approx. 3 wt % silicon (SiFe) is the most common crystalline soft magnetic material used in laminated cores in electric machines. As the electric-powered vehicle sector progresses, more efficient materials that performance better than SiFe are needed. In addition to sufficiently high electrical resistance, this signifies that a higher level of induction in particular is desirable to provide high torques and/or compact components.

Even more efficient materials are desirable for use in sectors such as the automotive industry and electric-powered vehicles. Soft magnetic cobalt-iron (CoFe) alloys are also used in electric machines due to their extremely high saturation induction. Commercially available CoFe alloys typically have a composition of 49 wt % Fe, 49 wt % Co and 2% V. In compositions of this type both a saturation induction of approx. 2.35 T and a high electrical resistance of 0.4 μΩm are achieved. It is, however, also desirable to reduce the material and production costs of CoFe alloys resulting, for example, from the high Co content, additional manufacturing steps and scrap content.

### SUMMARY

The object of the present invention is therefore to provide an FeCo alloy that has lower material costs and is easy to work in order to reduce the production costs of the alloy, up to and including laminated cores, and at the same time to achieve high power density.

According to the invention, a soft magnetic alloy, in particular a high permeability soft magnetic FeCo alloy, is provided that consists essentially of:

| | | | | |
|---|---|---|---|---|
| 5 | wt % | ≤ Co | ≤ 25 | wt % |
| 0.3 | wt % | ≤ V | ≤ 5.0 | wt % |
| 0 | wt % | ≤ Cr | ≤ 3.0 | wt % |
| 0 | wt % | ≤ Si | ≤ 3.0 | wt % |
| 0 | wt % | ≤ Mn | ≤ 3.0 | wt % |
| 0 | wt % | ≤ Al | ≤ 3.0 | wt % |
| 0 | wt % | ≤ Ta | ≤ 0.5 | wt % |
| 0 | wt % | ≤ Ni | ≤ 0.5 | wt % |
| 0 | wt % | ≤ Mo | ≤ 0.5 | wt % |
| 0 | wt % | ≤ Cu | ≤ 0.2 | wt % |
| 0 | wt % | ≤ Nb | ≤ 0.25 | wt % |
| 0 | wt % | ≤ Ti | ≤ 0.05 | wt % |
| 0 | wt % | ≤ Ce | ≤ 0.05 | wt % |
| 0 | wt % | ≤ Ca | ≤ 0.05 | wt % |
| 0 | wt % | ≤ Mg | ≤ 0.05 | wt % |
| 0 | wt % | ≤ C | ≤ 0.02 | wt % |
| 0 | wt % | ≤ Zr | ≤ 0.1 | wt % |
| 0 | wt % | ≤ O | ≤ 0.025 | wt % |
| 0 | wt % | ≤ S | ≤ 0.015 | wt % |

residual iron, wherein Cr+Si+Al+Mn≤3.0 wt %, and up to 0.2 wt % of other impurities. The alloy has a maximum permeability μₘₐₓ≥5,000, preferably μₘₐₓ≥10,000, preferably μₘₐₓ≥12.000, preferably μₘₐₓ≥17,000. Other impurities include, for example, B, P, N, W, Hf, Y, Re, Sc, Be and other lanthanides other than Ce. (wt % denotes weight percent)

Owing to the lower Co content, the raw material costs of the alloy according to the invention are less than those of an alloy based on 49 wt % Fe, 49 wt % Co, 2% V. The invention provides for an FeCo alloy with a maximum cobalt content of 25 per cent by weight that offers better soft magnetic properties, in particular appreciably higher permeability, than other FeCo alloys with a maximum cobalt content of 25 per cent by weight such as the existing commercially available FeCo alloys e.g. VACOFLUX 17, AFK 18 and HIPERCO 15. These existing commercially available alloys have a maximum permeability of less than 5000.

The alloy according to the invention has no significant adjustment in order and can therefore, unlike alloys with over 30 wt % Co, be cold rolled without first undergoing a quenching process. Quenching is a difficult process to control, particularly where large quantities of materials are concerned, as it is hard to achieve sufficiently fast cooling rates and ordering with the resulting embrittlement of the alloy may therefore take place. The lack of an order-disorder transition in the alloy according to the invention simplifies industrial-scale production.

Marked order-disorder transitions in alloys like that observed in CoFe alloys with a Co content greater than 30 wt % can be determined by means of differential scanning calorimetry (DSC) because they cause a peak in the DSC measurement. No such peak is observed in a DSC measurement carried out under the same conditions for the alloy according to the invention.

At the same time, however, in addition to an appreciably higher permeability level never previously attained for this type of alloy, this new alloy offers both significantly lower hysteresis losses than previously known commercially available alloys with Co contents of between 10 and 30 wt % and higher saturation. The FeCo alloy according to the invention can also produced cost-effectively on an industrial scale.

Owing to its higher permeability, the alloy according to the invention can be used in applications such as rotors and stators in electric motors in order to reduce the size of the rotor or stator and thus of the electric motor, and/or to increase output. For example, it makes it possible to generate a higher torque at the same physical size and/or weight, a solution that would prove advantageous if used in electrically-powered or hybrid motor vehicles.

In addition to a maximum permeability μₘₐₓ≥5,000, preferably μₘₐₓ≥10,000, preferably μₘₐₓ≥12.000, preferably μₘₐₓ≥17,000, the alloy can also have an electrical resistance ρ≥0.25 μΩm, preferably ρ≥0.30 μΩm, and/or hysteresis losses P_{Hys}≤0.07 J/kg, preferably hysteresis losses P_{Hys}≤0.06 J/kg, preferably hysteresis losses P_{Hys}≤0.05 J/kg, at an amplitude of 1.5 T, and/or coercive field strength H_{c} of ≤0.7 A/cm, preferably a coercive field strength H_{c} of ≤0.6 A/cm, preferably a coercive field strength H_{c} of ≤0.5 A/cm, preferably H_{c} of ≤0.4 A/cm, preferably H_{c} of ≤0.3 A/cm, and/or an induction B≥1.90 Tat 100 A/cm, preferably B≥1.95 T at 100 A/cm, preferably B≥2.00 T at 100 A/cm.

The hysteresis losses P_{Hys} are determined from the re-magnetisation losses P at an amplitude of induction of 1.5T across the y-axis intercept in a plot P/f over the frequency f by linear regression. The linear regression is carried out using at least 8 measured values distributed approximately evenly over a frequency range of 50 Hz to 1 kHz (e.g. at 50, 100, 200, 300, 400, 500, 600, 700, 800, 900 and 1000 Hz).

In one embodiment, the alloy has a maximum permeability μₘₐₓ≥μₘₐₓ≥10,000, an electrical resistance ρ≥0.28 μΩm, hysteresis losses P_{Hys}≤0.055 J/kg at an amplitude of 1.5 T, a coercive field strength H_{c} of ≤0.5 A/cm and an induction B≥1.95 T at 100 A/cm. This combination of properties is particularly advantageous for use as or in a rotor or stator of an electric motor in order to reduce the size of the rotor or stator and thus of the electric motor, and/or to increase output, or to generate higher torque at the same weight.

The soft magnetic alloy can therefore be used in an electric machine, e.g. as or in a stator and/or rotor of an electric motor and/or generator, and/or in an transformer and/or in an electromagnetic actuator. It can be provided in the form of a sheet with a thickness of 0.5 mm to 0.05 mm, for example. A plurality of sheets made of the alloy can be stacked together to form a laminated core to be used as a stator or rotor.

The alloy according to the invention has an electrical resistance of at least 0.25 μΩm, preferably a minimum of 0.3 μΩm. Eddy current losses can be reduced to a lower level by selecting a slightly smaller strip thickness.

The composition of the soft magnetic alloy is set out in greater detail in further embodiments, with 10 wt %≤Co≤20 wt %, preferably 15 wt %≤Co≤20 wt % and 0.3 wt %≤V≤5.0 wt %, preferably 1.0 wt %≤V≤3.0 wt %, preferably 1.3 wt %≤V≤2.7 wt % and/or 0.1 wt %≤Cr+Si≤2.0 wt %, preferably 0.2 wt %≤Cr+Si≤1.0 wt %, preferably 0.25 wt %≤Cr+Si≤0.7 wt %.

In one embodiment, the sum is defined in greater detail, with 0.2 wt %≤Cr+Si+Al+Mn≤1.5 wt %, preferably 0.3 wt %≤Cr+Si+Al+Mn≤0.6 wt %.

The soft magnetic alloy may also contain silicon, with 0.1 wt %≤Si≤2.0 wt %, preferably 0.15 wt %≤Si≤1.0 wt %, preferably 0.2 wt %≤Si≤0.5 wt %.

Aluminium and silicon can be interchanged such that in one embodiment the total Si and Al (Si+Al) is 0 wt %≤(Si+Al)≤3.0 wt %.

The alloys according to the invention are almost carbon-free and contain at most 0.02 wt % carbon, preferably ≤0.01 wt % carbon. This maximum carbon content should be regarded as an unavoidable impurity.

In the alloys according to the invention calcium, beryllium and/or magnesium may be added in small amounts of up to 0.05 wt % only for deoxidation and desulphurisation. In order to achieve particularly good deoxidation, it is possible to add up to 0.05 wt % cerium or cerium Mischmetal.

According to the invention, the improved magnetic properties can be achieved by heat treatment geared to the composition as described below. It has been shown, in particular, that ascertaining the phase transition temperatures for the selected compositions and determining the heat treatment temperatures and cooling rate in relation to the phase transition temperatures thus ascertained leads to improved magnetic properties. The fact that the alloys according to the invention with a cobalt content of at most 25 per cent by weight have no order-disorder transition so that the manufacturing process does not require quenching to avoid ordering and the resulting embrittlement, is also taken into account.

Conventionally, CoFe alloys are used in strip thicknesses ranging from 0.50 mm to a thin 0.050 mm. In processing the strip, the material is conventionally hot rolled and then cold rolled to its final thickness. During cooling after hot rolling an embrittling adjustment in order takes place at approx. 730° C. and to ensure sufficient cold rollability special intermediate annealing followed by quenching is therefore also required to suppress the adjustment in order. The alloy according to the invention does requires no quenching since it has no order-disorder transition. This simplifies production.

To achieve the magnetic properties, CoFe alloys are subjected to a final heat treatment also referred to as final magnetic annealing. The stock is heated to the annealing temperature, held at the annealing temperature for a certain length of time and then cooled at a defined speed. It is advantageous to carry out this final annealing at the highest possible temperatures and in a clean, dry hydrogen atmosphere since at high temperatures, firstly, the reduction of impurities by means of hydrogen is more efficient and, secondly, the grain structure becomes rougher and so soft magnetic properties such as coercive field strength and permeability improve.

In practice, the annealing temperature in the CoFe system has an upper limit since a phase transition from the magnetic and ferritic BCC phase to the non-magnetic and austenitic FCC phase takes place at approx. 950° C. in the binary system. When elements are added to the alloy, a two-phase region in which both phases coexist occurs between the FCC phase and the BCC phase. The transition between the BCC phase and the mixed two-phase or BCC/FCC region occurs at a temperature T_{Ü1} and the transition between the two-phase region and the FCC phase occurs at a temperature T_{Ü2}, where T_{Ü2}>T_{Ü1}. The position and size of the two-phase region also depends on the nature and scope of the alloy making process. If annealing takes place in the two-phase region or in the FCC region, remnants of the FCC phase may impair the magnetic properties after cooling and incomplete retransformation. Even if retransformation is complete, the additional grain boundaries created have an damaging effect since coercive field strength behaves inversely proportionately to grain diameter. Consequently, the known commercial available alloys with Co contents of approx. 20 wt % undergo final annealing at temperatures below the two-phase BCC+FCC region. As a result, the recommendation for AFK 18 is 3 h/850° C. and that for AFK 1 is 3 h/900° C., for example. The recommendation for VACOFLUX 17 is 10 h/850° C. At such low final annealing temperatures and owing to the relatively high magneto-crystalline anisotropy (K₁ approx. 45,000 J/m³ at 17 wt % Co), the potential for particularly good soft magnetic properties in these FeCo alloys is limited. With VACOFLUX 17 strip, for example, the maximum permeability that can be reached at a typical coercive field strength of 1 A/cm is approx. 4,000 and its application is therefore limited.

In contrast to these known final annealing processes, the composition according to the invention permits a heat treatment that produces better magnetic properties than the standard single-step annealing with furnace cooling used with FeCo alloys, irrespective of the temperature range in which the single-step annealing takes place. The additives are selected such that the lower limit of the two-phase region and the BCC/FCC phase transition are pushed upwards to allow annealing at high temperatures, e.g. above 925° C. in the BCC-only region. Annealing heat treatments at such high temperatures are not conceivable with the FeCo alloys known to date.

Moreover, the width of the two-phase region, i.e. the difference between the lower transition temperature T_{Ü1} and the upper transition temperature T_{Ü2} is kept as narrow as possible owing to the composition according to the invention. As a result, the advantages of high final annealing, i.e. the removal of potential magnetically unfavourable textures, the cleaning effect in H₂ and the growth of large grains, are maintained by final annealing above the two-phase region in conjunction with cooling through the two-phase region followed by a holding period or controlled cooling in the BCC-only region without the risk of magnetically damaging remnants of the FCC phase.

It has been found that compositions with a phase transition between the BCC-only region and the mixed BCC/FCC region exhibit appreciably improved magnetic properties at higher temperatures, e.g. above 925° C., and with a narrow two-phase region, e.g. of less than 45K. Compositions with this specific combination of phase diagram features are selected according to the invention and heat treated accordingly in order to guarantee a high permeability of greater than 5000 or greater than 10,000.

Vanadium was identified as one of the most effective elements in an Fe—Co alloy, increasing electrical resistance and at the same time pushing the two-phase region up to higher temperatures. With a lower Co content, vanadium is more efficient at increasing transition temperatures. With the Fe-17Co alloy, it is even possible to increase the transition temperatures above the value of the binary FeCo composition by adding approx. 2% vanadium.

In the Fe—Co system, from approx. 15% cobalt the BCC/FCC phase transformation takes place at temperatures lower than the Curie temperature. Since the FCC phase is paramagnetic, the magnetic phase transition is now determined by the BCC/FCC phase transformation rather than the Curie temperature. Sufficiently large amounts of vanadium push the BCC/FCC phase transformation over the Curie temperature T_{c}, making the paramagnetic BCC phase visible.

However, if the vanadium content is too high, the width of the mixed region is increased. These compositions have lower maximum permeability values even though the phase transition between the mixed BCC/FCC region and the BCC-only region takes place at higher temperatures. Consequently, it has been established that that the composition has an influence both on the temperatures at which the phase transitions take place and on the width of the mixed region, and should therefore be taken into account when selecting the composition. In order to achieve the highest permeability values, the heat treatment temperatures can be selected in relation to the temperatures at which the phase transitions for this composition take place.

It has thus been found that a more precise determination of the temperatures at which the phase transitions take place is advantageous for a certain composition wen optimising the production process. These temperatures can be determined by means of differential scanning calorimetry (DSC) measurements. The DSC measurement can be carried out with a sample mass of 50 mg and at a DSC heating rate of 10 Kelvin per minute, and the phase transition temperatures thus determined can be used when heating and cooling the sample to determine the temperatures for heat treatment.

Chromium and other elements can be added in order, for example, to improve electrical resistance or mechanical properties. Like most other elements, chromium reduces the two-phase region of the binary Fe-17Co alloy. As a result, the amount of element to be added in addition to vanadium is preferably selected such together with vanadium it produces an increase in the two-phase region as compared to the binary FeCo alloy. In addition, the impurities and elements that have a particularly strong stabilising affect on the austenite (e.g. nickel) must be kept as low as possible.

The following contents have proved preferable in achieving very good magnetic properties:

cobalt content of 5 wt %≤Co≤25 wt %, with contents of 10 wt %≤Co≤20 wt % being preferred and contents of 15 wt %≤Co≤20 wt % being very particularly preferred;

vanadium content of 0.3 wt %≤V≤5.0 wt %, with contents of 1.0 wt %≤V≤3.0 wt % being preferred, and the following sum: 0.2 wt %≤Cr+Si+Al+Mn≤3.0 wt %.

The alloys according to the invention are almost carbon-free and have at most 0.02 wt % carbon, preferably 0.01 wt % carbon. This maximum carbon content should be regarded as an unavoidable impurity.

Only small amounts of calcium, beryllium and/or magnesium up to 0.05 wt % can be added to the alloys according to the invention for deoxidation and desulphurisation.

To achieve particularly good deoxidation and desulphurisation up to 0.05 wt % Cer or misch metal can be added.

The composition according to the invention allows a further improvement. Cobalt has a higher diffusion coefficient in the paramagnetic BCC phase than in the ferromagnetic BCC phase. As a result, by separating the two-phase region and the Curie temperature T_{c}, vanadium allows a further temperature range with high self diffusion, thereby allowing a larger BCC grain structure and thus better soft magnetic properties due to heat treatment in this range or cooling through this range. In to addition, the separation of two-phase region and Curie temperature T_{c} signifies that during cooling both the passage through the two-phase BCC/FCC region and the transition to the region of the BCC-only phase take place completely in the paramagnetic state. This also has a positive effect on the soft magnetic properties.

According to the invention, a method is provided for the production of a soft magnetic FeCo alloy, this method comprising the following. A preliminary product (precursor) is provided with a composition consisting substantially of:

| | | | | |
|---|---|---|---|---|
| 5 | wt % | ≤ Co | ≤ 25 | wt % |
| 0.3 | wt % | ≤ V | ≤ 5.0 | wt % |
| 0 | wt % | ≤ Cr | ≤ 3.0 | wt % |
| 0 | wt % | ≤ Si | ≤ 3.0 | wt % |
| 0 | wt % | ≤ Mn | ≤ 3.0 | wt % |
| 0 | wt % | ≤ Al | ≤ 3.0 | wt % |
| 0 | wt % | ≤ Ta | ≤ 0.5 | wt % |
| 0 | wt % | ≤ Ni | ≤ 0.5 | wt % |
| 0 | wt % | ≤ Mo | ≤ 0.5 | wt % |
| 0 | wt % | ≤ Cu | ≤ 0.2 | wt % |
| 0 | wt % | ≤ Nb | ≤ 0.25 | wt % |
| 0 | wt % | ≤ Ti | ≤ 0.05 | wt % |
| 0 | wt % | ≤ Ce | ≤ 0.05 | wt % |
| 0 | wt % | ≤ Ca | ≤ 0.05 | wt % |
| 0 | wt % | ≤ Mg | ≤ 0.05 | wt % |
| 0 | wt % | ≤ C | ≤ 0.02 | wt % |
| 0 | wt % | ≤ Zr | ≤ 0.1 | wt % |
| 0 | wt % | ≤ O | ≤ 0.025 | wt % |
| 0 | wt % | ≤ S | ≤ 0.015 | wt % |

residual iron, where Cr+Si+Al+Mn≤3.0 wt %, and up to 0.2 wt % of other impurities due to melting. The other impurities may, for example, be one or more of the elements B, P, N, W, Hf, Y, Re, Sc, Be or other lanthanides other than Ce. In some embodiments the preliminary product has a cold-rolled texture or a fibre texture.

The preliminary product or the parts manufactured from the preliminary product are heat treated. In one embodiment, the preliminary product is heat treated at a temperature T₁ and then cooled down from T₁ to room temperature.

In an alternative embodiment, the preliminary product is heat treated at a temperature T₁, then cooled down to a temperature T₂ that is above room temperature, and further heat treated at temperature T₂, where T₁>T₂. The preliminary product is not cooled to room temperature until it has been heat treated at temperature T₂.

The preliminary product has a phase transition from a BCC phase region to a mixed BCC/FCC region to a FCC phase region, as the temperature increases the phase transition between the BCC phase region and the mixed BCC/FCC region taking place at a first transition temperature T_{Ü1} and, as the temperature continues to increase, the transition between the mixed BCC/FCC region and the FCC phase region taking place at a second transition temperature T_{Ü2}, where T_{Ü2}>T_{Ü1}. Temperature T₁ is above T_{Ü2} and temperature T₂ is below T_{Ü1}.

The transition temperatures T_{Ü1} and T_{Ü2} are dependent on the composition of the preliminary product. The transition temperatures T_{Ü1} and T_{Ü2} can be determined by means of DSC measurements, the transition temperature T_{Ü1} being determined during heating and the transition temperature T_{Ü2} being determined during cooling. In one embodiment, at a sample mass of 50 mg and a DSC heating rate of 10 Kelvin per minute the transition temperature T_{Ü1} is above 900° C., preferably above 920° C., and preferably above 940° C.

In one embodiment, the solidus temperature of the preliminary product is taken into account when selecting temperatures T₁ and T₂. In one embodiment, 900° C.≤T₁<Tₘ, preferably 930° C.≤T₁<Tₘ, preferably 940° C.≤T₁<Tₘ, preferably 960° C.≤T₁<Tₘ, and 700° C.≤T₂≤1050° C. and T₂<T₁, Tₘ being the solidus temperature.

In one embodiment, the difference T_{Ü2}−T_{Ü1} is less than 45K, preferably less than 25K.

In one embodiment, the cooling rate over at least the temperature range from T₁ to T₂ is 10° C./h to 50,000° C./h, preferably 10° C./h to 900° C./h, preferably 20° C./h to 1000° C./h, preferably 20° C./h to 900° C./h, preferably 25° C./h to 500° C./h. This cooling rate can be used with both of the heat treatments described above.

In one embodiment, the difference T_{Ü2}−T_{Ü1} is less than 45K, preferably less than 25K, T₁ is above T_{Ü2} and T₂ is below T_{Ü1}, 940° C.≤T₁<Tₘ, where 700° C.≤T₂≤1050° C. and T₂<T₁, Tₘ being the solidus temperature, and the cooling rate is 10° C./h to 900° C./h at least over the temperature range T₁ to T₂. This combination of properties of the alloy, i.e. T_{Ü2} and T_{Ü1}, can be used with the heat treatment temperatures T₁ and T₂ to achieve particularly high permeability rates.

In one embodiment, the preliminary product is heat treated at above T_{Ü2} for a period of over 30 minutes and then cooled to T₂.

In one embodiment, the preliminary product is heat treated at T₁ for a period where 15 minutes≤t₁≤20 hours, and then cooled from T₁ to T₂. In one embodiment, the preliminary product is cooled from T₁ to T₂, heat treated at T₂ for a period t₂, where 30 minutes≤t₂≤20 hours, and then cooled from T₂ to room temperature.

In embodiments in which the preliminary product is cooled down from T₁ to room temperature, the preliminary product may than be heated up from room temperature to T₂ and heat treated at T₂ according to one of the embodiments described here.

As the alloy has no order-disorder transition, no quenching is carried out over the temperature range from 800° C. to 600° C. The cooling rate from 800° C. to 600° C. may, for example, be between 100° C./h and 500° C./h. However, a slower cooling rate can, in principle, also be chosen. The aforementioned cooling rates can also quite easily be carried out until room temperature is reached.

The preliminary product can be cooled from T₁ to room temperature at a rate of 10° C./h to 50,000° C./h, preferably from 10° C./h to 1000° C./h, preferably from 10° C./h to 900° C./h, preferably from 25° C./h to 900° C./h, preferably from 25° C./h to 500° C./h.

The cooling rate from T₂ to room temperature has less influence on magnetic properties so the preliminary product can be cooled from T₂ to room temperature at a rate of 10° C./h to 50,000° C./h, preferably 100° C./h to 1000° C./h.

In a further alternative embodiment, the preliminary product is cooled from T₁ to room temperature at a cooling rate of 10° C./h to 900° C./h. In embodiments with slow cooling from T₁ to room temperature, e.g. with a cooling rate of less than 500° C./h, preferably less than 200° C./h, a further heat treatment at temperature T₂ can be dispensed with.

Following heat treatment, the soft magnetic alloy may have the following combinations of properties:

a maximum permeability μₘₐₓ≥5,000, and/or an electrical resistance ρ≥0.25 μΩm, and/or hysteresis losses P_{Hys}≤0.07 J/kg at an amplitude of 1.5 T, a coercive field strength H_{c} of ≤0.7 A/cm and an induction B≥1.90 T at 100 A/cm, or

a maximum permeability μₘₐₓ≥10,000, and/or an electrical resistance ρ≥0.25 μΩm, and/or hysteresis losses P_{Hys}≤0.06 J/kg at an amplitude of 1.5 T, and/or a coercive field strength H_{c} of ≤0.6 A/cm, preferably H_{c}≤0.5 A/cm and/or an induction B≥1.95 T at 100 A/cm, or

a maximum permeability μₘₐₓ≥12.000, preferably μₘₐₓ≥17,000 and/or an electrical resistance ρ≥0.30 μΩm, and/or hysteresis losses P_{Hys}≤0.05 J/kg at n amplitude of 1.5 T, and/or a coercive field strength H_{c} of ≤0.5 A/cm, preferably H_{c}≤0.4 A/cm, preferably H_{c}≤0.3 A/cm and/or an induction B≥2.00 Tat 100 A/cm.

In certain embodiments the soft magnetic alloy has one of the following combinations of properties:

a maximum permeability μₘₐₓ≥5,000, an electrical resistance ρ≥0.25 μΩm, hysteresis losses P_{Hys}≤0.07 J/kg at n amplitude of 1.5 T, a coercive field strength H_{c} of ≤0.7 A/cm and an induction B≥1.90 T at 100 A/cm, or

a maximum permeability μₘₐₓ≥10,000, an electrical resistance ρ≥0.25 μΩm, hysteresis losses P_{Hys}≤0.06 J/kg at an amplitude of 1.5 T, a coercive field strength H_{c} of ≤0.6 A/cm and an induction B≥1.95 T at 100 A/cm, or

a maximum permeability μₘₐₓ≥12.000, an electrical resistance ρ≥0.28 μΩm, hysteresis losses P_{Hys}≤0.05 J/kg at an amplitude of 1.5 T, a coercive field strength H_{c} of ≤0.5 A/cm and an induction B≥2.00 T at 100 A/cm,

a maximum permeability μₘₐₓ≥17,000, an electrical resistance ρ≥0.30 μΩm, hysteresis losses P_{Hys}≤0.05 J/kg at an amplitude of 1.5 T, a coercive field strength H_{c} of ≤0.4 A/cm, preferably H_{c} of ≤0.3 A/cm and an induction B≥2.00 T at 100 A/cm.

In one embodiment, the maximum difference in coercive field strength H_{c} after heat treatment measured parallel to the direction of rolling, measured diagonally (45°) to the direction of rolling or measured perpendicular to the direction of rolling between two of these directions is at most 6%, preferably at most 3%. In other words, the maximum difference in coercive field strength H_{c} measured parallel to the direction of rolling and measured diagonally (45°) to the direction of rolling is at most 6%, preferably at most 3%, and/or the maximum difference in coercive field strength H_{c} measured parallel to the direction of rolling and measured perpendicular to the direction of rolling is at most 6%, preferably at most 3%, and/or the maximum difference in the coercive field strength H_{c} measured diagonally (45°) to the direction of rolling or measured perpendicular to the direction of rolling between these two directions is at most 6%, preferably at most 3%. In rotor and stator applications, this anisotropy, which is extremely low for soft magnetic FeCo alloys, leads to uniform properties along the periphery and there is therefore no need to rotate rotor and stator sheets by layer to provide sufficient isotropy of the magnetic properties in the laminated core.

The heat treatment may be carried out in a hydrogen-containing atmosphere or in an inert gas.

In one embodiment, heat treatment is carried out in a stationary furnace at T₁ and in a stationary furnace or a continuous furnace at T₂. In another embodiment, heat treatment is carried out in a continuous furnace at T₁ and in a stationary furnace or a continuous furnace at T₂.

Prior to heat treatment the preliminary product may have a cold-rolled texture or a fibre texture.

The preliminary product may be provided in the form of a strip. At least one strip may be manufactured from the strip by stamping, laser cutting or water jet cutting. In one embodiment, heat treatment is carried out on stamped, laser-cut, electrical discharge machined or water jet-cut laminations manufactured from the strip material.

In one embodiment, after heat treatment a plurality of sheets are stuck (adhered) together using insulating adhesive to form a laminated core, or surface oxidized to form an insulating layer and then stuck, or laser welded together to form a laminated core, or coated with an inorganic-organic hybrid coating and then processed further to form a laminated core.

In some embodiments, the preliminary product takes the form of a laminated core and the laminated core is heat treated according to one of the embodiments described here. The heat treatment can thus be carried out on stamp bundled cores (progressively stacked cores) or welded laminated cores manufactured from laminations.

The preliminary product can be produced as follows. A molten mass may, for example, be provided by vacuum induction melting, electroslag remelting or vacuum to arc remelting, this molten mass consisting substantially of:

| | | | | |
|---|---|---|---|---|
| 5 | wt % | ≤ Co | ≤ 25 | wt % |
| 0.3 | wt % | ≤ V | ≤ 5.0 | wt % |
| 0 | wt % | ≤ Cr | ≤ 3.0 | wt % |
| 0 | wt % | ≤ Si | ≤ 3.0 | wt % |
| 0 | wt % | ≤ Mn | ≤ 3.0 | wt % |
| 0 | wt % | ≤ Al | ≤ 3.0 | wt % |
| 0 | wt % | ≤ Ta | ≤ 0.5 | wt % |
| 0 | wt % | ≤ Ni | ≤ 0.5 | wt % |
| 0 | wt % | ≤ Mo | ≤ 0.5 | wt % |
| 0 | wt % | ≤ Cu | ≤ 0.2 | wt % |
| 0 | wt % | ≤ Nb | ≤ 0.25 | wt % |
| 0 | wt % | ≤ Ti | ≤ 0.05 | wt % |
| 0 | wt % | ≤ Ce | ≤ 0.05 | wt % |
| 0 | wt % | ≤ Ca | ≤ 0.05 | wt % |
| 0 | wt % | ≤ Mg | ≤ 0.05 | wt % |
| 0 | wt % | ≤ C | ≤ 0.02 | wt % |
| 0 | wt % | ≤ Zr | ≤ 0.1 | wt % |
| 0 | wt % | ≤ O | ≤ 0.025 | wt % |
| 0 | wt % | ≤ S | ≤ 0.015 | wt % |

residual iron, where Cr+Si+Al+Mn≤3.0 wt %, and up to 0.2 wt % of other impurities. Other impurities may be one or more of the other B, P, N, W, Hf, Y, Re, Sc, Be or other lanthanides other than Ce. The molten mass is solidified to form an ingot and the ingot is mechanically formed to form a preliminary product with final dimensions, this mechanical forming being carried out by means of hot rolling and/or forging and/or cold forming.

In one embodiment, the ingot is mechanically formed to form a slab with a thickness D₁ by means of hot rolling at temperatures between 900° C. and 1300° C. and then mechanically formed to form a strip with a thickness D₂ by means of cold rolling, where 1.0 mm≤D₁≤5.0 mm and 0.05 mm≤D₂≤1.0 mm, where D₂<D₁. The degree of cold working by cold rolling may be >40%, preferably >80%.

In one embodiment, the ingot is mechanically formed to form a billet by means of hot rolling at temperatures between 900° C. and 1300° C. and then mechanically formed to form a wire by means of cold drawing. The degree of cold working due to cold drawing may be >40%, preferably >80%.

Intermediate annealing may be carried out in a continuous furnace or a stationary furnace at an intermediate dimension in order to reduce work hardening and so to set the desired degree of cold working.

The Curie temperature of the alloy may be taken into account when selecting the temperatures T₁ and/or T₂. For example, T_{Ü1}>T_{c}, where T_{c} is the Curie temperature and T_{c}≥900° C. In one embodiment, T_{Ü1}>T₂>T_{c}.

In compositions in which there is a separation of the two-phase region and the Curie temperature T_{c}, there is a further temperature range with higher self diffusion. This allows a larger BCC grain structure and thus better soft magnetic properties as a result of heat treatment in this region or cooling through this region. The separation of the two-phase region and the Curie temperature T_{c} also signifies that during cooling both the passage through the two-phase BCC/FCC region and the transition to the BCC-only phase region take place entirely in the paramagnetic state. The soft magnetic properties can be further improved by selecting temperature T₂ so that T_{Ü1}>T₂>T_{c}.

In one embodiment, the average grain size after final annealing is at least 100 μm, preferably at least 200 μm, preferably at least 250 μm.

In one embodiment, the measured density of the annealed alloy is more than 0.10% lower than the density calculated using the rule of three from the average atomic weight of the metallic elements of the alloy, the average atomic weight of the metallic elements of the corresponding binary FeCo alloy and the measured density of this annealed binary FeCo-alloy.

Owing to the heat treatment, the sulphur content in the finished alloy may be lower than that in the molten mass. For example, the upper limit of the sulphur content in the molten mass may be 0.025 per cent by weight, while in the finished soft magnetic alloy the upper limit is 0.015 per cent by weight.

In one embodiment, the preliminary product is also coated with an oxide layer for electrical insulation. This embodiment may, for example, be used if the preliminary product is used in a laminated core. The laminations or the laminated core can be coated with an oxide layer. The preliminary product may be coated with a layer of magnesium methylate or preferably zirconium propylate that transforms into an insulating oxide layer during heat treatment. The preliminary product may be heated treated in an atmosphere containing oxygen or water vapour to form an electrically insulating layer.

In one embodiment, laminations stamped, laser-cut or electrical discharge machined from the preliminary product are also subjected to final annealing, after which the annealed single sheets are then stuck together by means of an insulating adhesive to form a laminated core, or the annealed single sheets are surface-oxidised to form an insulating layer and then stuck, welded or laser-welded together to form a laminated core, or the annealed single sheets are coated with an inorganic-organic hybrid coating such as Remisol C5, for example, and then further processed to form a laminated core.

The soft magnetic alloy according to any one of the preceding embodiments, which can be produced using any one of the methods described here, may be used in an electric machine, e.g. as or in a stator and/or rotor of an electric motor and/or a generator, and/or in a transformer and/or in an electromagnetic actuator.

### BRIEF DESCRIPTION OF THE DRAWINGS

Embodiments of the invention are described in greater detail below with reference to the drawings and the following examples.

FIG. 1 shows a schematic illustration (not to scale) of three variants of the heat treatment according to the invention.

FIG. 2 shows a typical course of a DSC heating and cooling curve during phase transition using the example of batch 930423.

FIG. 3 shows an illustration of the first onset temperatures of the phase transition of the Fe-17Co—Cr—V alloys according to the invention with increasing V content in comparison to the binary Fe-17Co molten mass for heating (DSC) and cooling (DSC). The course of maximum permeability μₘₐₓ is plotted against a second y-axis.

FIG. 4 shows coefficients of the induction value B after multi-linear regression.

FIG. 5 shows coefficients of electrical resistance after multi-linear regression.

FIG. 6 shows coercive field strength H_{c} of batch 930329 (Fe-17Co1.5V-0.5Cr) as a function of the reciprocal of the grain diameter d for various annealing processes.

FIG. 7 shows the transition temperatures T_{Ü1} and T_{Ü2} and the best coercive field strength H_{c} achieved for this Fe-17Co special molten mass with different V contents for various batches. The alloys also contain up to a total of 0.6 wt % of Cr and/or Si. The data for FIG. 7 including details of the corresponding annealing process are given in Table 29.

FIG. 8 shows maximum permeability and coercive field strength after step annealing in the first annealing step.

FIG. 9 shows maximum permeability and coercive field strength after step annealing in the second annealing step below the phase transition after a previous first annealing step of 4 h at 1000° C. above the phase to transition.

FIG. 10 shows the coercive field strength H_{c} of batches 930329 (Fe-17Co-0.5Cr-1.5V) and 930330 (Fe-17Co-2.0V) dependent on the degree of cold working.

FIG. 11 shows (200) pole figures for batch 93/0330 (Fe-17Co-2V).
a) Cold formed: top left
b) After final annealing at 910° C. for 10 h: top centre
c) After final annealing at 1050° C. for 4 h: top right
d) After final annealing at 1050° C. for 4 h and 910° C. for 10 h: bottom

FIG. 12 shows the coercive field strength H_{c} of batch 930330 (Fe-17Co-2V) measured parallel to the direction of rolling (“longitudinally”), at 45° to the direction of rolling and perpendicular to the direction of rolling (“transversely”) for the specified annealing.

FIG. 13 shows the coercive field strength H_{c} of batch 930335 (Fe-23Co-2V) measured parallel to the direction of rolling (“longitudinally”), at 45° to the direction of rolling and perpendicular to the direction of rolling (“transversely”) for the specified annealing.

FIG. 14 shows new curves for batches 930329 (Fe-17Co-1.5V-0.5Cr), 930505 (Fe-17Co-1.4V-0.4Si) and 930330 (Fe-17Co-2V) according to the invention after optimum annealing in comparison to a typical SiFe alloy (TRAFOPERM N4) and a typical FeCo alloy.

FIG. 15 shows the permeability of batches 930329 (Fe-17Co-1.5V-0.5Cr), 930505 (Fe-17Co-1.4V-0.4Si) and 930330 (Fe-17Co-2V) according to the invention after optimum annealing in comparison to a typical SiFe alloy (TRAFOPERM N4) and typical FeCo alloys.

FIG. 16 shows losses of batches 930329 (Fe-17Co-1.5V-0.5Cr) and 930330 (Fe-17Co-2V) according to the invention after optimum annealing at an induction amplitude of 1.5T in comparison to a typical SiFe alloy (TRAFOPERM N4) and FeCo alloys. In each case the sheet thickness was 0.35 mm.

FIG. 17 shows a diagram of maximum permeability as a function of the relative density difference Δρ for Fe-17Co-based alloys for the data in Table 25.

### DETAILED DESCRIPTION OF EXAMPLE EMBODIMENTS

According to the invention, a soft magnetic alloy is provided that consists essentially of:

| | | | | |
|---|---|---|---|---|
| 5 | wt % | ≤ Co | ≤ 25 | wt % |
| 0.3 | wt % | ≤ V | ≤ 5.0 | wt % |
| 0 | wt % | ≤ Cr | ≤ 3.0 | wt % |
| 0 | wt % | ≤ Si | ≤ 3.0 | wt % |
| 0 | wt % | ≤ Mn | ≤ 3.0 | wt % |
| 0 | wt % | ≤ Al | ≤ 3.0 | wt % |
| 0 | wt % | ≤ Ta | ≤ 0.5 | wt % |
| 0 | wt % | ≤ Ni | ≤ 0.5 | wt % |
| 0 | wt % | ≤ Mo | ≤ 0.5 | wt % |
| 0 | wt % | ≤ Cu | ≤ 0.2 | wt % |
| 0 | wt % | ≤ Nb | ≤ 0.25 | wt % |
| 0 | wt % | ≤ Ti | ≤ 0.05 | wt % |
| 0 | wt % | ≤ Ce | ≤ 0.05 | wt % |
| 0 | wt % | ≤ Ca | ≤ 0.05 | wt % |
| 0 | wt % | ≤ Mg | ≤ 0.05 | wt % |
| 0 | wt % | ≤ C | ≤ 0.02 | wt % |
| 0 | wt % | ≤ Zr | ≤ 0.1 | wt % |
| 0 | wt % | ≤ O | ≤ 0.025 | wt % |
| 0 | wt % | ≤ S | ≤ 0.015 | wt % |

and up to 0.2 wt % of other impurities due to melting. The impurities may, for example, be one or more of the elements B, P, N, W, Hf, Y, Re, Sc, Be or other lanthanides other than Ce.

In order to increase electrical resistance, it is also possible, in addition to the alloy element vanadium, to add one or more of the group of Cr, Si, Al and Mn in an amount that satisfies the following sum:

0.05 wt %≤Cr+Si+Al+Mn≤3.0 wt %.

The alloy according to the present invention is preferably melted in vacuum induction furnaces, though it can also be processed using vacuum arc remelting or electroslag remelting. The molten mass first solidifies into an ingot from which the oxide skin is removed and then forged or hot rolled at temperatures between 900° C. and 1300° C. Alternatively, the removal of the oxide skin can also take place on bars that have previously been forged or hot rolled. The desired dimensions can be achieved by hot working strips, billets or bars. Surface oxides can be removed from hot rolled stock by blasting, grinding or stripping. Alternatively, however, the desired final dimensions can also be achieved by cold working strips, bars or wires. In the case of cold rolled strips, a grinding process can be integrated to remove embedded oxides caused by the hot rolling process. If cold working leads to excessive solidification, one or more intermediate annealing processes may be carried out at temperatures between 400° C. and 1300° C. for recovery and re-crystallisation. The thickness or diameter for the intermediate annealing should be selected such that cold working of preferably >40%, particularly preferably >80%, is achieved by the final thickness.

The last processing step is heat treatment at temperatures between 700° C. and the solidus temperature Tₘ (typically at most 1200° C.), which is also referred to as final magnetic annealing. Final annealing is preferably carried out in a clean, dry hydrogen atmosphere. Annealing in an insert gas or vacuum is also possible.

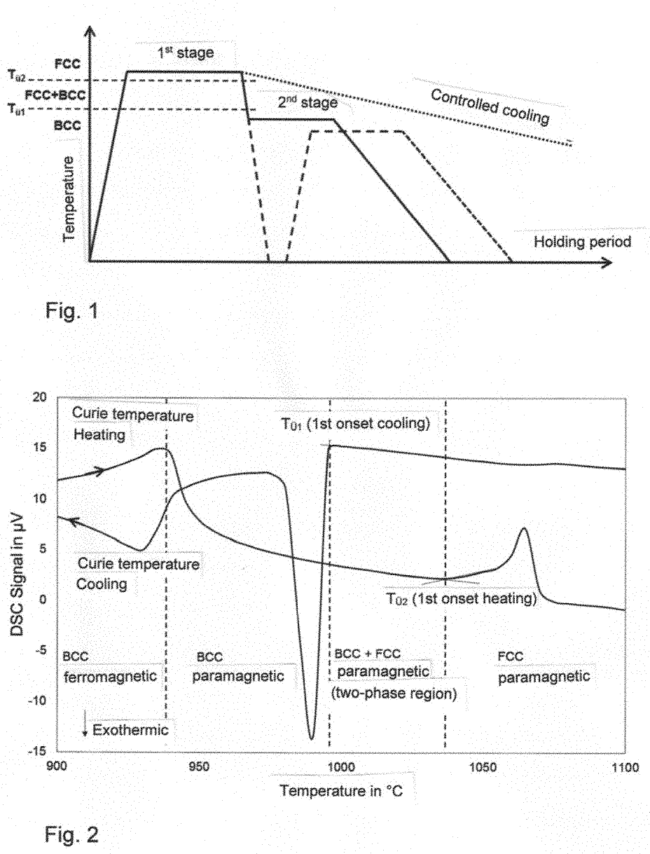

FIG. 1 shows a schematic illustration of three variants of the heat treatment according to the invention in relation to the phase transitions and in particular to the FCC, FCC+BCC and BCC regions.

In variant 1, which is illustrated by the continuous line in FIG. 1, a first annealing step in the FCC region is followed immediately by a second annealing step in the BCC region. The second annealing step is optional and can be used to further improve soft magnetic properties, in particular permeability and hysteresis losses. In variant 2, which is illustrated by the broken line in FIG. 1, the first annealing step in the FCC region is followed by cooling to room temperature. The second annealing step in the BCC region takes place at a later stage. In variant 3, which is illustrated by the dotted line in FIG. 1, the annealing step in the FCC region is followed by controlled cooling to room temperature. This type of controlled cooling can also take place in variant 1 during cooling from the first step to the second step (not shown in FIG. 1).

According to the invention, annealing may therefore take place either in two steps or by controlled cooling from a temperature above the upper transition temperature. Controlled cooling signifies that there is a defined cooling rate for creating the optimum soft magnetic properties. In all cases, one of the annealing steps takes place in the FCC region. The annealing processes according to the invention may be carried out in either a continuous furnace or a stationary furnace.

During the annealing process according to the invention, the alloy is annealed at least once at a temperature above T_{Ü2} between 900° C. (if T_{Ü2}>900° C., then above T_{Ü2}) and Tₘ in the austenitic FCC region in order to produce a large grain, to exploit the cleaning effect of the hydrogen and to remove potential magnetically disadvantageous textures. This final annealing step above T_{Ü2} takes place either in a stationary annealing process or in a continuous furnace. Alternatively, this heat treatment step may also take place on the strip stock in a continuous furnace. The alloy is then cooled at a rate of 10 to 50,000° C. per hour, preferably at a rate of 20 to 1000° C. per hour, to room temperature or to a temperature between 700° C. and 1000° C. in the BCC region.

A second annealing step may comprise either heating up or maintaining the temperature at between 700° C. and 1000° C. (if T_{Ü1}<1000° C., then below T_{Ü1}) in the ferritic BCC region in order to remove any potential remnants of the FCC phase. Following completed final magnetic annealing, the alloy is then cooled from the annealing temperature at a rate of 10 to 50,000° C. per hour, preferably at a rate of 20 to 1000° C. per hour.

The alloys according to the invention exhibit a phase transition from a BCC phase region to a mixed BCC/FCC region and at a slightly higher temperature a further phase transition from the mixed BCC/FCC region to a FCC phase region, as the temperature increases the phase transition taking place at a first transition temperature T_{Ü1} between the BCC phase region and the mixed BCC/FCC region and, as the temperature continues to increase, the transition taking place at a second transition temperature T_{Ü2} between the mixed BCC/FCC region and the FCC phase region, as shown in FIG. 2.

The temperature at which the phase transitions from a BCC phase region to a mixed BCC/FCC region and from the mixed BCC/FCC region to an FCC phase region occur can be determined by means of DSC measurements. FIG. 2 shows the typical course of a DSC heating and cooling curve at phase transition using the example of batch 930423. FIG. 2 also shows the Curie temperature and the first onset temperatures of the phase transition.

The figures that follow show the results of DSC measurements carried out using a dynamic heat-flow differential scanning calorimeter from the company Netzsch. Two identical corundum (Al₂O₃) crucibles are placed in a furnace, one containing a real measuring sample, the other containing a reference calibration sample. Both crucibles are subjected to the same temperature programme, which may consist of a combination of heating, cooling or isothermal sections. The thermal flow difference is determined quantitatively by measuring the temperature difference at a defined heat conduction path between sample and reference. The various maxima and minima (peaks) determined by DSC measurement can be allocated to certain types of phase transformations on the basis of their curve shapes. The result is typical curve shapes that are material-specific but also dependent on the measurement conditions, in particular on the sample mass and the heating and cooling rates. To guarantee the comparability of the measurements, identical instrument heating and cooling rates and identical sample masses were used. The heating and cooling rates used in these tests were 10 K/min; the sample mass was 50 mg.

The transition temperatures T_{Ü1} and T_{Ü2} are determined by means of DSC measurement by heating a sample of a defined mass at a defined heating rate. In this measurement the transition temperatures are represented by the first onset. This parameter is defined in DIN 51005 (“Thermal analysis”) and is also referred to as the extrapolated peak onset temperature. It represents the onset of the phase transformation and is defined as the intersection point of the extrapolated baseline with the tangent through the linear part of an increasing or decreasing peak flank. The advantage of this parameter is that it is independent of sample mass and heating and cooling rates. The width of the two-phase region is defined as the difference between the first onset temperatures:

$$\begin{matrix}{T}_{1 st onset} ( B C C + F C C \to F C C ) \\ ( from DSC heating )\end{matrix} - \begin{matrix}{T}_{1 st onset} ( B C C + F C C \to B C C ) = {T}_{\ddot{U} 2} - {T}_{\ddot{U} 1} \\ ( from DSC cooling )\end{matrix}$$

The influence of composition on the transition temperatures T_{Ü1} and T_{Ü2} is determined by means of DSC measurement.

FIG. 3 shows an illustration of the first onset temperatures of the phase transition of the Fe-17Co-Cr-V alloys as V content increases (circles) in comparison to the binary Fe-17Co alloy (squares) for heating (solid symbols) and cooling (hollow symbols). The compositions of the alloys are specified in Tables 1 to 4.

The peak Curie temperatures T_{c} of heating (DSC) and cooling (DSC) are indicated by diamonds. For the special molten masses with lower V contents, T_{c} is the temperature of the phase transition. The highest measured maximum permeability μₘₐₓ (triangle) is plotted on the secondary axis. The highest maximum permeabilities are achieved for V contents of between 1 and 3 wt %.

FIG. 3 shows that as the V content increases phase transitions T_{Ü2} and T_{Ü1} take place at higher temperatures and that the width of the two-phase BCC+FCC regions, i.e. (T_{Ü2}−T_{Ü1}), increases.

Final annealing is carried out to set the soft magnetic properties. In this test it was always carried out in a H₂ protective atmosphere. The H₂ quality used was always stets hydrogen 3.0 (or technical hydrogen) with a H₂ percentage >99.9%, where H₂O ≤40 ppm-mol, O₂≤10 ppm-mol, N₂≤100 ppm-v.

The magnetic properties of the alloys were tested using strip stock manufactured from 5 kg heavy ingots. The alloys were melted in a vacuum and then poured into a flat mould at approx. 1500° C. Once the oxide skin had been milled off the individual ingots, they were hot rolled into 3.5 mm thick strips at a temperature of approx. 1000° C. to 1300° C. The resulting hot-rolled strips were then pickled to remove the oxide skin and cold rolled to a thickness of 0.35 mm. Sample rings were stamped and resistor strips were cut out of the strip in order to characterise the magnetic properties. The electrical resistance p was determined on the resistor strips. Maximum permeability μₘₐₓ, coercive field strength H_{c}, inductions B at field strengths of 20, 25, 50, 90, 100 and 160A/cm, remanence Bᵣ and hysteresis losses P_{Hys} were measured on the sample rings in the annealed state at room temperature. Hysteresis losses were determined by measuring the losses at an induction amplitude of 1.5T for various frequencies. The axis intercept determined by linear regression in the plot P/f over f gives the hysteresis losses.

A disc was sawn off the ingots to analyse the elements. The results of the analysis appear in Tables 1 to 4. Table 1 shows the wet-chemical analysis of the metallic elements in order to determine the basic composition. Residual iron and other elements <0.01% are not indicated, the data being given in wt %. Table 2 shows the analysis by hot gas extraction of non-metal impurities in the batches from Table 1, the data being given in wt %. Table 3 shows the wet-chemical analysis of the metallic elements in order to fine-tune the basic composition and to limit the composition ranges and impurities. Residual iron and other elements <0.01% are not specified. Data is given in wt %. In batches 930502 and 930503 the feed material used was iron with a high level of impurities. Table 4 shows the analysis by hot gas extraction of non-metallic impurities in the batches from Table 3, the data being given in wt %.

Table 3 also shows the analysis of the metallic elements in two large melts. Residual iron and the P content of large melt 76/4988 is 0.003 wt %, the P content of large melt 76/5180 is 0.002 wt %, other elements <0.01% are not specified. Table 4 also shows the analysis by hot gas extraction of non-metallic impurities in the two large melts from Table 3, the data being given in in wt %.

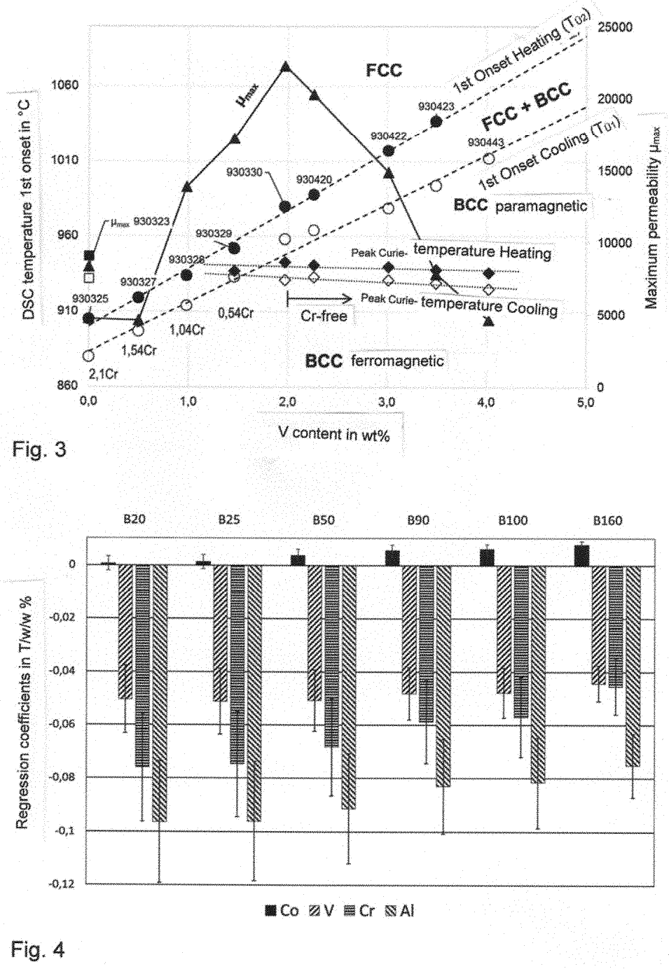

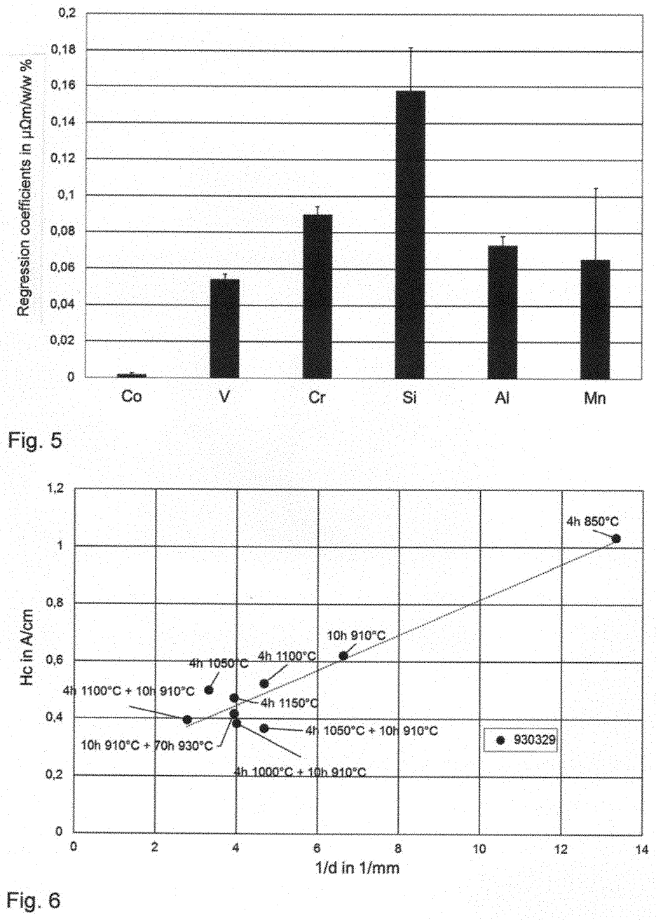

FIGS. 4 and 5 show a statistical evaluation of the influence of the main alloy elements cobalt, vanadium and chromium on induction values after optimum annealing and on electrical resistance using multi-linear regression.

FIG. 4 shows coefficients of the induction value B after multi-linear regression. The figures following the B values (e.g. B20) indicate the field strength in A/cm. The bars show the change in induction values with the addition of 1 wt %. Only those elements with a regression value greater than the regression error are shown.

FIG. 5 shows coefficients of electrical resistance after multi-linear regression. The bars indicate the change in electrical resistance with the addition of 1 wt % of the relevant element.

These figures indicate that vanadium reduces low inductions less strongly than chromium and that chromium increases electrical resistance more strongly than vanadium at the same decrease in saturation (B160). Co increases saturation (B160) but has less influence on low induction values and on electrical resistance.

Table 7 shows annealing variants according to the invention of batch 93/0330 with a strip thickness of 0.35 mm in comparison to annealing variants not according to the invention (see FIG. 1). The cooling rate is 150° C./h unless otherwise indicated. No demagnetisation was carried out prior to measuring.

FIG. 6 shows the coercive field strength H_{c} of batch 930329 (Fe-17Co1.5V-0.5Cr) as a function of the reciprocal grain diameter d for various annealing processes. Table 5 shows the average grain sizes d, coercive field strengths H_{c} and maximum permeabilities μₘₐₓ after the specified annealing (see FIG. 4). The cooling rate was 150° C./h.

Table 6 shows DSC transition temperatures and Curie temperatures T_{c}. Temperatures are given in ° C. #NV signifies that no signal is discernible in the DSC measurement.

One of the reasons for the very good soft magnetic properties is the grain structure achieved in the FCC region after annealing, which is unusually large for Fe—Co alloys. After a short period of annealing of 4 h at 1050° C. in batch 93/0330 (Fe-17Co-2V), for example, grain sizes of 354 to 447 μm were determined. Similarly large grains could only be achieved by annealing in the BCC range after annealing lasting several days. FIG. 6 shows the coercive field strength H_{c} compared to reciprocal grain size in batch 930329 by way of example. It shows a linear relationship.

Batch 930330 was tested by way of example to compare the aforementioned annealing variants. Table 8 shows the results after step annealing annealing in the first annealing step (batch 93/0330) (see FIG. 6). The cooling rate is 150° C./h. As long as initial annealing takes place in the lower FCC region (in this case at 1050° C.), all annealing variants show very good soft magnetic properties that are substantially better than annealing in the BCC region alone. A second annealing step in the upper BCC range following the first annealing step in the FCC region improves the values still further.

FIG. 7 shows the transition temperatures T_{Ü1} and T_{Ü2} as a function of the best oercive field strength H_{c} achieved for the Fe-17Co special melts with different V contents. The labels indicate the V content. FIG. 7 shows that the V content is crucial in setting the soft magnetic properties. If the V content is too low, T_{Ü1} is not increased. If the V content is too high, the soft magnetic properties deteriorate because the two-phase region (T_{Ü2}−T_{Ü1}) is broadened by vanadium (see also FIG. 3 and Table 6). As a result, the minimum coercive field strength H_{c} occurs at approx. 1.4 to 2 wt % vanadium.

To find the optimum annealing temperature, samples are annealed at different annealing temperatures and then measured. If the number of annealing processes required is greater than the number of samples available, the same set of samples is generally annealed at different temperatures. This so-called “step annealing” starts at a low starting temperature and anneals at successively higher temperatures. Step annealing can be used to detect precipitation regions, recrystallization temperatures and phase transformations, for example, that have a direct influence on magnetic characteristics.

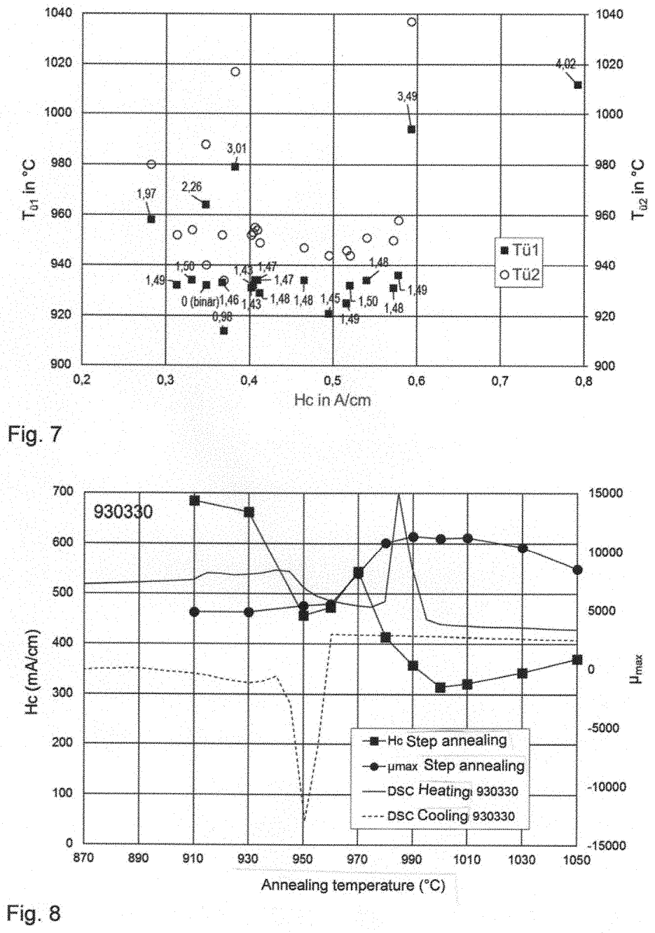

FIG. 8 shows maximum permeability and coercive field strength after step annealing in the first annealing step. Table 9 shows the results after the step annealing of batch 93/0330 below the phase transition following a first annealing step of 4 h at 1000° C. above the phase transition. The cooling rate is 150° C./h. An extended maximum can be identified at approx. 1000° C. The corresponding DSC measurement is also shown to provide a comparison with the phase position.

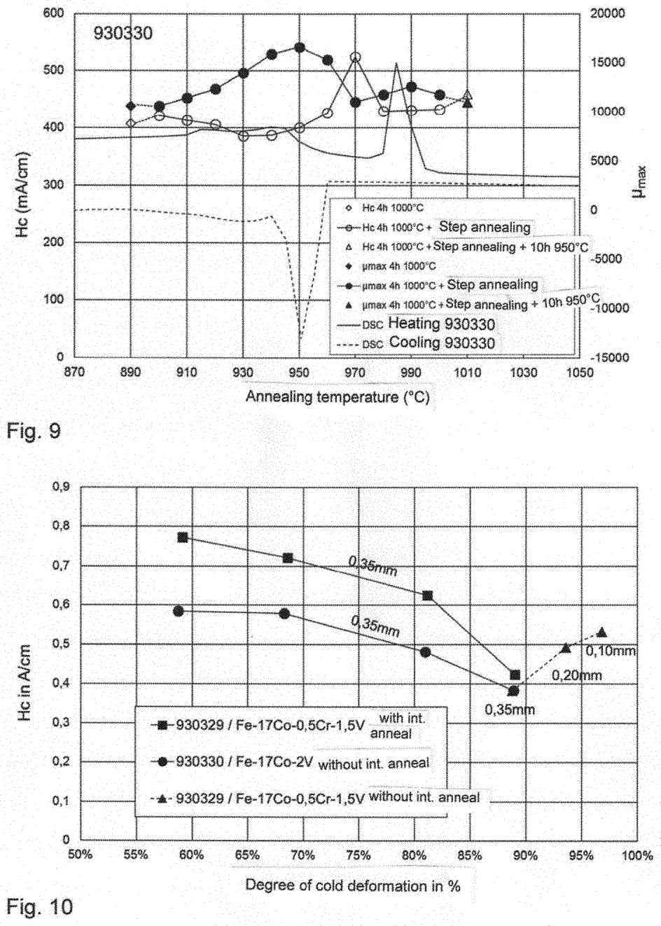

FIG. 9 shows maximum permeability and coercive field strength after step annealing in the second annealing step below the phase transition (circles) after a first annealing step for 4 h at 1000° C. above the phase transition (diamonds). No demagnetisation was carried out before measuring the static values. A maximum can be seen at 950° C. After the last annealing step in the step annealing process at 1000° C. the samples were annealed against for 10 h at 950° C. (triangles). This time the original values for step annealing at 950° C. were not achieved. Passing through the two-phase BCC+FCC region again impairs the soft magnetic properties.

The magnetic properties were measured for alloys of various compositions after various annealing processes. The results are given in Tables 10 to 24, giving values B₂₀, B₂₅, B₅₀, B₉₀, B₁₀₀, B₁₆₀ (T) H_{c} (A/cm), μₘₐₓ, Br (T) and P_{Hys} 1.5T (Ws/kg).

Table 10 shows the results after annealing a selection of batches at 850° C. for 4 h at a cooling rate of 150° C./h. These embodiments are not in accordance with the invention.

Table 11 shows the results after annealing a selection of batches for 10 h at 910° C. at a cooling rate of 150° C./h. No demagnetisation was carried out prior to measuring the static values. These embodiments are not in accordance with the invention.

Table 12 shows the results after annealing a selection of batches for 10 h at 910° C. and cooling to room temperature, followed by annealing for 70 h at 930° C. The cooling rate is 150° C./h. No demagnetisation was carried out prior to measuring the static values. These embodiments are not in accordance with the invention.

Table 13 shows the results after annealing a selection of batches for 4 h at 1000° C. Cooling rate 150° C./h. No demagnetisation was carried out prior to measuring the static values.

Table 14 shows the results after annealing a selection of batches in the first annealing step for 4 h at 1000° C. with cooling to room temperature, following by a second annealing step for 10 h at 910° C. The cooling rate is 150° C./h. No demagnetisation was carried out prior to measuring the static values.

Table 15 shows the results after annealing all the Fe—Co—V—Cr batches for 4 h at 1050° C. Cooling rate 150° C./h. No demagnetisation was carried out prior to measuring the static values. The resistances of batches 930322 to 930339 were measured after annealing for 4 h at 850° C. In V-rich batches 930422 and 930423 T_{Ü2} was only just below 1050° C. Adjusted annealing steps are indicated in Table 18.

Table 16 shows the results after annealing all the Fe—Co—V—Cr batches in a first annealing step for 4 h at 1050° C. with cooling to room temperature, followed by a second annealing step for 10 h at 910° C. Cooling rate 150° C./h. Demagnetisation was carried out prior to measuring. In the batches marked in grey, T_{Ü1} is either not far enough above or too far above 910° C. Adjusted annealing steps are indicated in Table 17.

Table 17 shows the results after adjustment of the annealing processes on the batches in which the transition temperatures of the DSC measurement (Table 6) do not or only just coincide with annealing for 4 h at 1050° C.+10 h at 910° C. (Tables 15 and 16). The cooling rate is 150° C./h. When annealing was carried out for 4 h at 1050° C. no demagnetisation was carried out prior to measuring. In all other cases demagnetisation was carried out prior to measuring.

Table 18 shows the results after annealing of batch 930423 in various phase regions to clarify the influences of the ferromagnetic and paramagnetic BCC region on magnetic properties (see also FIG. 2). The cooling rate is 150° C./h. When annealing was carried out for 4 h at 1050° C. no demagnetisation was carried out prior to measuring. In all other cases demagnetisation was carried out prior to measuring.

Table 19 shows the results after annealing a selection of batches for 4 h at 1050° C. followed by slow cooling to room temperature at 50° C./h. No demagnetisation was carried out prior to measuring the static values.

Table 20 shows the results after annealing a selection of batches for 4 h at 1050° C. with slow cooling to room temperature at 50° C./h and a second annealing step for 10 h at 910° C. with furnace cooling at approx. 150° C./h. No demagnetisation was carried out prior to measuring the static values.

Table 21 shows the results after annealing a selection of batches for 4 h at 1100° C. The cooling rate is 150° C./h. No demagnetisation was carried out prior to measuring the static values except on batches 930422 and 930423.

Table 22 shows the results after annealing a selection of batches in a first annealing step for 4 h at 1100° C. and cooling to room temperature followed by a second annealing step for 10 h at 910° C. The cooling rate is 150° C./h. No demagnetisation was carried out prior to measuring the static values.

Table 23 shows the results after annealing a selection of batches for 4 h at 1150° C. The cooling rate is 150° C./h. No demagnetisation was carried out prior to measuring the static values except on batch 930442.

Table 24 shows the results after annealing a selection of batches in a first annealing step for 4 h at 1150° C. and cooling to room temperature followed by a second annealing step for 10 h at 910° C. The cooling rate is 150° C./h. No demagnetisation was carried out prior to measuring the static values.

Table 25 shows the data for maximum permeability and density for various Fe-17Co alloy compositions with various additives. Based on the binary alloy Fe-16.98Co, its measured density of 7.942 g/cm³ and its average atomic weight of 56.371 g/mol (calculated from the metallic alloy element contents analysed), the fictitious density of Fe-17Co alloys with added V, Cr, Mn, Si, Al and other metallic elements is calculated using their average atomic weights and compared with the measured density. For the alloy Fe-17.19Co-1.97V (batch 93/0330), for example, the average atomic weight is 56.281 g/mol. It is then possible, using the rule of three (7.942 g/cm³×56.281/56.371=7,929 g/cm³), to calculate the fictitious density that this alloy Fe-17.19Co-1.97V should have if its lattice constant were unchanged in relation to the binary Fe-16.98Co alloy. In reality, however, the density measured for this alloy, 7.909 g/cm³, is −0.26% lower than the fictitious density of 7.929 g/cm³. This signifies that the lattice constant of this alloy must be approx. 0.085% greater than that of the binary alloy.

Table 26 shows the data for selected batches and annealing processes that have both particularly high maximum permeabilities and low hysteresis losses at the same time as a very high level of induction B at 100 A/cm (B₁₀₀).

Table 27 shows the data for the impurities C and S in ppm for selected batches and annealing processes. These impurities are effectively reduced by annealing at 1050° C. in hydrogen.

Table 28 shows magnetic values for the two large melts 76/4988 and 76/5180. The letters A and B refer to ingots A and B; the molten masses were poured into two moulds. The specific resistance of batch 76/4988 is 0.306 μΩm; that of batch 76/5180 is 0.318 μΩm.

Table 29 shows for various batches the transition temperatures T_{Ü1} and T_{Ü2} and the best coercive field strength H_{c} achieved for these Fe-17Co special melts with different V contents, including details of the annealing treatment. The alloys also contain up to a total of 0.6 wt % Cr and/or Si. FIG. 7 represents this data in graphic form.

FIGS. 8 and 9 show that the BCC/FCC phase transition present in the alloy 930330 according to the invention has a strong influence on maximum permeability and coercive field strength.

In the first annealing step (FIG. 8) the first onset of cooling (=T_{Ü1}, lower limit two-phase region) coincides with the rise in μₘₐₓ and μₘₐₓ reaches its maximum value and H_{c} reaches its minimum value above the first onset of heating (=T_{Ü2}, upper limit two-phase region). Magnetic characteristics deteriorate again at higher temperatures in the FCC region.

In the second annealing step (FIG. 9) μₘₐₓ reaches its maximum value below T_{Ü1} and drops as it enters the two-phase region. If the two-phase region is exceeded and annealing is repeated below T_{Ü1} (here 950° C.), the maximum μₘₐₓ value is no longer reached, presumably because this sample has passed through the mixed BCC+FCC region twice and this causes the formation of additional grain boundaries.

In summary, it can be said that the best magnetic properties are achieved if the first annealing step takes place at above T_{Ü2} and the second annealing step takes place at below T_{Ü1}.

The influence of the degree of cold deformation on the magnetic properties is tested.

FIG. 10 shows the coercive field strength H_{c} for batches 930329 (Fe-17Co-0.5Cr-1.5V) and 930330 (Fe-17Co-2.0V) dependent on the degree of cold deformation. At “without intermediate annealing” the hot rolling thickness corresponds to a cold deformation of 0%; at “with intermediate annealing” the thickness of the intermediate annealing corresponds to a cold deformation of 0%.

Cold deformation (KV) on strip stock with a final thickness D₂ is defined as the percentage reduction in thickness in relation to a non-cold-deformed starting thickness D₁ since expansion during rolling can be disregarded. The non-cold-deformed starting thickness D₁ may, for example, be achieved by hot rolling or by intermediate annealing (ZGL or int. anneal).

KV[%]=[(D₁−D₂)/D₁]×100

In FIG. 10 the coercive field strength H_{c} shows by way of example that as cold deformation increases magnetic properties improve by up to approx. 90% cold deformation as a result of intermediate annealing at different D₁ values (1.3 mm, 1.0 mm, 0.60 mm) and identical final thickness D₂ values (0.35 mm).

Assuming a constant D₁ of 3.5 mm (hot rolling thickness), cold deformation achieved by a high degree of rolling to 0.20 mm and 0.10 mm once again results in an increase in H_{c}, as indicated by the broken line. This can be explained by the fact that too many nucleation sites for grains occur at the highest degrees of cold deformation and the grains obstruct one another's growth during annealing. As a result, the alloy in batch 930329 (Fe-17Co-0.5Cr-1.5V) (in wt %) produced without intermediate annealing after final annealing for 4 h at T₁=1000° C. and for 10 h at T₂=910° C. has an average grain size of 0.25 mm at a final thickness of 0.35 mm; an average grain size of 0.21 mm at a final thickness of 0.20 mm; and an average grain size of 0.15 mm at a final thickness of 0.10 mm. There is therefore an optimum degree of cold deformation of approx. 90%.

In order to test whether texture formation is a significant factor for magnetic properties, the texture was determined by means of X-ray diffraction on sheets measuring 50 mm×45 mm.

FIG. 11 shows (200) pole figures from batch 93/0330 (Fe-17Co-2V). On the left-hand side is the result for an unannealed sheet with a rolling texture. In the centre is the result for a sheet annealed at 910° C. for 10 h that has only a very indistinct texture. On is the right-hand side is the result for sheet annealed at 1050° C. for 4 h annealed that has no texture. At the bottom is the result for sheet annealed at 1050° C. for 4 h and at 910° C. for 10 h that has no texture.

Here the sample was subject to angle-dependent Cu-K_{α}=0.154059295 nm radiation and the diffracted intensity was measured with a 2 mm pinhole aperture. A Lynxexe semi-conductor strip detector with 2° angular range and energy-dispersive operation was used as the detector. As shown by the (200) pole figures, for example, a rolling texture is present in the unannealed, full hard state that dissolves completely after annealing in the FCC region for 4 h at 1050° C. in H₂.

The lack of texture also corresponds to the measurements of the directional H_{c}. Five H_{c} strips with dimensions of 50 mm×10 mm were taken from various directions relative to the direction of rolling (longitudinally=0°, diagonal=45°, transversely=90°) and measured in a Förster coercimeter.

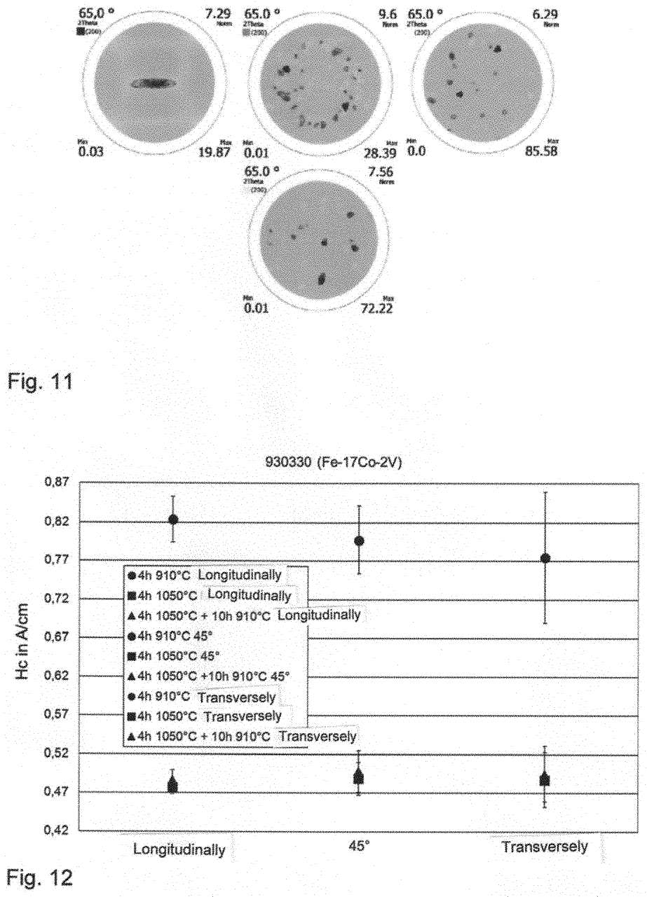

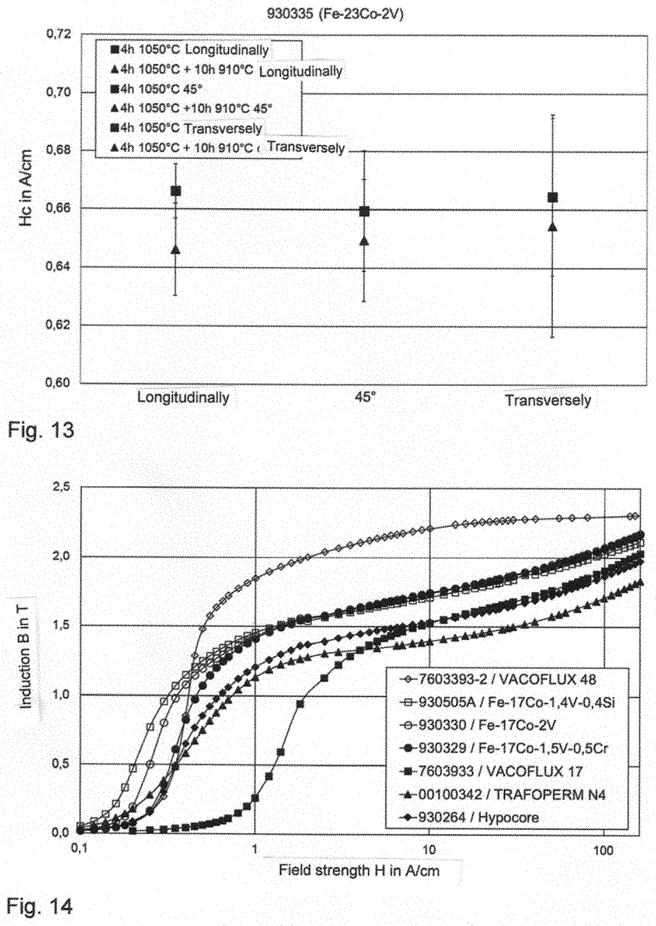

FIG. 12 shows the coercive field strength H_{c} for batch 930330 (Fe-17Co-2V) measured parallel to the direction of rolling (“longitudinally”), at 45° to the direction of rolling and perpendicular to the direction of rolling (“transversely”) for the annealing processes specified. Each point represents the mean value from a series of five measurements. The error bars represent standard deviation.

FIG. 13 shows the coercive field strength H_{c} for batch 930335 (Fe-23Co-2V) measured parallel to the direction of rolling (“longitudinally”), at 45° to the direction of rolling and perpendicular to the direction of rolling (“transversely”) for the annealing processes specified. Each point represents the mean value from a series of five measurements. The error bars represent standard deviation.

Following annealing for 4 h at 910° C., the mean values exhibit anisotropic behaviour, though this anisotropy is not significant if statistical errors are taken into account. However, this slight anisotropy corresponds to residual texture from the corresponding pole figure (top centre image in FIG. 11). Almost identical mean values are obtained in H_{c} after annealing for 4 h at 1050° C. and for 4 h at 1050° C.+10 h at 910° C. The annealing in the FCC region at 1050° C. completely removes any texture present and the subsequent second annealing step in the BCC region at 910° C. produces no new texture.

Below, the magnetic properties of the alloy according to the invention are compared with comparative alloys based on the example of batches 930329 (Fe-17Co-1.5V-0.5Cr) and 930330 (Fe-17Co-2.0V) according to the invention. The comparative alloys shown are TRAFOPERM N4 (Fe-2,5Si—Al—Mn), a typical electrical steel; three FeCo VACOFLUX 17 alloys (Fe-17Co-2Cr—Mo—V—Si); VACOFLUX 48 (Fe-49Co-1.9V) and a HYPOCORE special melt. The HYPOCORE special melt was melted according to the composition published by Carpenter Technologies (Fe-5Co-2.3Si-1Mn-0.3Cr— values in wt %).

FIG. 14 shows new curves for batches 930329 (Fe-17Co-1.5V-0.5Cr), 930505 (Fe-17Co-1.4V-0.4Si) and 930330 (Fe-17Co-2V) according to the invention after optimum annealing in comparison with a SiFe (TRAFOPERM N4) and FeCo comparative alloys.

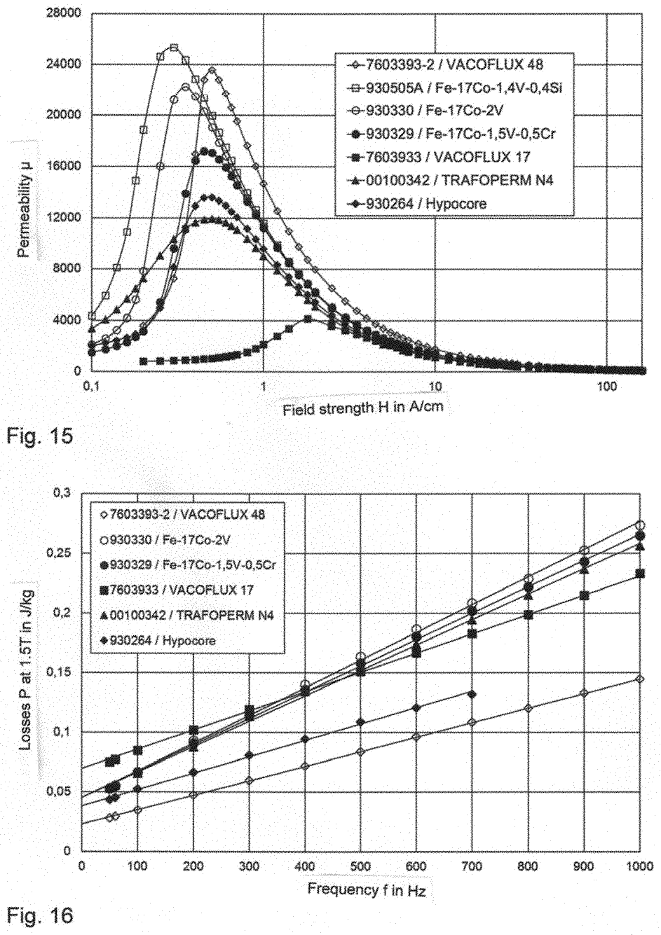

FIG. 15 shows the permeabilities for batches 930329 (Fe-17Co-1.5V-0.5Cr), 930505 (Fe-17Co-1.4V-0.4Si) and 930330 (Fe-17Co-2V) according to the invention following optimum annealing in comparison with a SiFe (TRAFOPERM N4) and FeCo comparative alloys.

FIG. 16 shows losses for batches 930329 (Fe-17Co-1.5V-0.5Cr) and 930330 (Fe-17Co-2V) according to the invention following optimum annealing at an amplitude of 1.5T in comparison with a SiFe (TRAFOPERM N4) and FeCo comparative alloys. The hysteresis losses (y-axis intercept) of 930329, 930330 and TRAFOPERM N4 are similar. The sheet thickness was 0.35 mm.

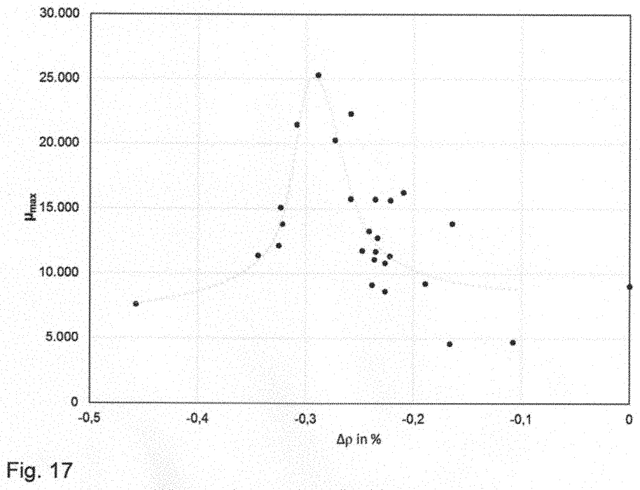

FIG. 17 shows maximum permeability as a function of the relative density difference Δρ for Fe-17Co-based alloys (see data in Table 25). High maximum permeabilities are obtained for alloys having a relative density difference of −0.10% to −0.35% and particularly high maximum permeabilities are obtained for alloys having a relative density difference of −0.20% to −0.35%. Ultimately, this relative density difference compared to the binary Fe-17Co-alloy signifies that the lattice constant of these alloys needs to be somewhat larger than that of the binary alloy. Owing to the larger inter-atomic distance in the crystal lattice, a larger lattice constant signifies lower activation energy for place change processes and so better diffusion. This also contributes to grain growth and so to lower coercive field strength and higher permeability.

In order to test the properties of the alloys according to the invention on a production scale, two large melts were carried out using the normal manufacturing process. 2.2 t of the desired composition were melted in a vacuum induction furnace and, once the exact composition had been set and analysed, poured into two round moulds with a diameter of 340 mm. After solidification and cooling, the round ingots were removed from the moulds and heated to a temperature of 1170° C. for hot rolling in a gas-fired rotary hearth furnace. The heated ingots were then hot rolled on a blooming roll to form slabs with a cross section of 231×96 mm². These slabs were then ground on all sides to a dimension of 226×93 mm² to remove the oxide skin.

Both slabs obtained from batch 76/4988 in this manner were rolled out on a hot rolling mill to form hot strip. To this end, the slabs were first heated at a temperature of 1130° C. and then, once sufficiently warmed through, rolled to form hot strip. The final thickness chosen for one of the strips was 2.6 mm. The final rolling temperature of this band was 900° C., the reeling temperature 828° C. The final thickness chosen for the other strip was 1.9 mm. The final rolling temperature of this strip was 871° C., the reeling temperature 718° C. Both hot strips were then blasted to remove the oxide skin. One part of the hot-rolled strip was intermediate annealed for 1 h at 750° C. in an H₂ inert gas atmosphere. Another part of the hot-rolled strip was intermediately annealed for 1 h at 1050° C. in a H₂ inert gas atmosphere. A remaining part of the hot-rolled strip did not undergo intermediate annealing. The strips were then rolled to their final thicknesses, oxides being removes from both sides of the strips at an intermediate thickness. Before the strip was hot rolled, sections with a thickness of 15 mm were also sawn off the slabs and made into a strip by hot rolling (to a thickness of 3.5 mm), pickling the hot strip thus obtained and then cold rolling in the pilot plant. The results obtained are also presented for the purposes of comparison.

In the case of batch 76/5180, a disc with a thickness of 15 mm was sawn off either end of the two slabs. These discs were preheated at 1200° C. and then hot rolled to form a strip with a thickness of 3.5 mm. The hot strips obtained in this manner were picked to remove oxides, then cold rolled to a thickness of 0.35 mm.

Stamped rings were produced from all the strips obtained in this way and then subjected to an annealing process. Table 28 shows the results obtained for the magnetic values. The specific resistance of batch 76/4988 is 0.306 μΩm; that of batch 76/5180 is 0.318 μΩm.

As is apparent from Table 28, better magnetic properties are measured for samples from the large melt than for the commercially available alloys with a Co content of below 30 per cent by weight such as VACOFLUX 17. For a sample from the large melt 76/5180B, a maximum permeability of above 20,000 was measured. The alloy according to the invention is therefore suitable for the industrial-scale production of strip stock with improved magnetic properties.

The alloy according to the invention exhibits higher inductions than VACOFLUX 17 for all field strengths. At inductions above the inflection point, the new alloy lies between TRAFOPERM N4 and VACOFLUX 48. For both batches, the air flow-corrected induction B at a field strength of 400 A/cm close to magnetic saturation is 2.264 T (corresponding to a polarisation J of 2.214 T). In the operating range of typical electric motors and generators torque for the new alloy will therefore be higher to than for VACOFLUX 17 and TRAFOPERM N4.

A comparison of 930329 and 930330 indicates that vanadium in conjunction with the heat treatment described above increases the rectangularity of the hysteresis loop to such an extent that, depending on the additive, maximum permeability is almost as high as that of VACOFLUX 48. This is surprising, not to say astounding, since the anisotropy constant K₁ shows a zero crossing at approx. 50% Co that is not present at 17% Co. By contrast, at 17% Co the anisotropy constant K₁ in the Fe—Co system is very high.

Very good soft magnetic properties are also apparent in the hysteresis losses, which are on a level comparable with those of TRAFOPERM N4. As frequency rises, TRAFOPERM N4 losses at identical strip thickness increase due to the higher electrical resistance, though less strongly than with the new alloy. It is, however, possible to compensate for this effect by selecting a somewhat smaller strip thickness with correspondingly lower eddy current losses.

In summary, a high permeability soft magnetic alloy is provided that offers both better soft magnetic properties, e.g. appreciably higher permeability and lower hysteresis losses, and higher saturation than existing, commercially available FeCo alloys. At the same time, however, this new alloy also offers significantly lower hysteresis losses than previously known commercially available alloys with Co contents between 10 and 30 wt % and, above all, an appreciably higher level of permeability never previously achieved for this type of alloy. The alloy according to the invention can also be produced cost effectively on an industrial scale.

TABLE 1

| Batch | | | | | | | | | | |
|---|---|---|---|---|---|---|---|---|---|---|
| 93/ | Co | Ni | Cr | Mn | V | Si | Al | Mo | Be | Cer |
| 0322 | 17.80 | <0.01 | 0.01 | <0.01 | <0.01 | <0.01 | <0.01 | 2.50 | <0.01 | — |
| 0323 | 16.98 | <0.01 | <0.01 | <0.01 | <0.01 | <0.01 | <0.01 | <0.01 | <0.01 | — |
| 0324 | 23.20 | <0.01 | <0.01 | <0.01 | <0.01 | <0.01 | <0.01 | <0.01 | <0.01 | — |
| 0325 | 17.05 | <0.01 | 2.01 | <0.01 | <0.01 | <0.01 | <0.01 | <0.01 | <0.01 | — |
| 0326 | 23.25 | <0.01 | 2.03 | <0.01 | <0.01 | <0.01 | <0.01 | <0.01 | <0.01 | — |
| 0327 | 17.14 | <0.01 | 1.54 | <0.01 | 0.50 | <0.01 | <0.01 | <0.01 | <0.01 | — |
| 0328 | 17.08 | <0.01 | 1.04 | <0.01 | 0.98 | <0.01 | <0.01 | <0.01 | <0.01 | — |
| 0329 | 17.12 | <0.01 | 0.54 | <0.01 | 1.46 | <0.01 | <0.01 | <0.01 | <0.01 | — |
| 0330 | 17.19 | <0.01 | <0.01 | <0.01 | 1.97 | <0.01 | <0.01 | <0.01 | <0.01 | — |
| 0331 | 23.09 | 0.012 | 1.04 | <0.01 | 0.99 | <0.01 | <0.01 | <0.01 | <0.01 | — |
| 0332 | 22.97 | <0.01 | 1.04 | <0.01 | 0.99 | 0.19 | <0.01 | <0.01 | <0.01 | — |
| 0333 | 22.96 | <0.01 | 1.03 | <0.01 | 0.98 | <0.01 | 0.18 | <0.01 | <0.01 | — |
| 0334 | 23.01 | 0.022 | 1.04 | <0.01 | 0.98 | <0.01 | <0.01 | <0.01 | 0.06 | — |
| 0335 | 22.93 | <0.01 | <0.01 | <0.01 | 1.95 | <0.01 | <0.01 | <0.01 | <0.01 | — |
| 0336 | 23.07 | <0.01 | 1.04 | <0.01 | 0.98 | <0.01 | <0.01 | <0.01 | <0.01 | <0.001 |
| | | | | | | | | | | (used: |
| | | | | | | | | | | 0.02) |
| 0337 | 22.93 | <0.01 | 1.03 | <0.01 | 0.98 | <0.01 | <0.01 | <0.01 | <0.01 | <0.001 |
| | | | | | | | | | | (used: |
| | | | | | | | | | | 0.01) |
| 0338 | 23.07 | <0.01 | 1.04 | <0.01 | 0.98 | <0.01 | <0.01 | <0.01 | <0.01 | <0.001 |
| | | | | | | | | | | (used: |
| | | | | | | | | | | 0.005) |
| 0339 | 23.06 | 0.017 | <0.01 | <0.01 | <0.01 | <0.01 | 1.96 | <0.01 | <0.01 | — |

TABLE 2

| Batch 93/ | C | S | O | N |
|---|---|---|---|---|
| 0322 | 0.0050 | 0.0012 | 0.0016 | 0.0012 |
| 0323 | 0.0045 | 0.0010 | 0.0150 | 0.0011 |
| 0324 | 0.0038 | 0.0010 | 0.0130 | 0.0009 |
| 0325 | 0.0031 | 0.0011 | 0.0100 | 0.0011 |
| 0326 | 0.0032 | 0.0011 | 0.0085 | 0.0012 |
| 0327 | 0.0032 | 0.0011 | 0.0097 | 0.0011 |
| 0328 | 0.0029 | 0.0011 | 0.0100 | 0.0013 |
| 0329 | 0.0028 | 0.0012 | 0.0093 | 0.0013 |
| 0330 | 0.0024 | 0.0011 | 0.0092 | 0.0014 |
| 0331 | 0.0030 | 0.0011 | 0.0087 | 0.0011 |
| 0332 | 0.0022 | 0.0011 | 0.0068 | 0.0012 |
| 0333 | 0.0040 | 0.0011 | 0.0014 | 0.0011 |
| 0334 | 0.0036 | 0.0010 | 0.0022 | 0.0013 |
| 0335 | 0.0034 | 0.0010 | 0.0120 | 0.0016 |
| 0336 | 0.0040 | 0.0010 | 0.0088 | 0.0014 |
| 0337 | 0.0039 | 0.0010 | 0.0058 | 0.0012 |
| 0338 | 0.0036 | 0.0011 | 0.0082 | 0.0012 |
| 0339 | 0.0025 | 0.0009 | 0.0026 | 0.0010 |

TABLE 3

| Batch | | | | | | | | | | | | | |
|---|---|---|---|---|---|---|---|---|---|---|---|---|---|
| 93/ | Co | V | Cr | Mn | Ni | Nb | Mo | Si | Al | Ta | Ti | Cer | Cu |
| 0420 | 17.03 | 2.26 | <0.01 | <0.01 | 0.011 | <0.01 | <0.01 | <0.01 | <0.01 | <0.01 | <0.01 | <0.01 | <0.01 |
| 0421 | 20.01 | 2.29 | <0.01 | <0.01 | 0.012 | <0.01 | <0.01 | <0.01 | <0.01 | <0.01 | <0.01 | <0.01 | <0.01 |
| 0422 | 16.98 | 3.01 | <0.01 | <0.01 | 0.010 | <0.01 | <0.01 | <0.01 | <0.01 | <0.01 | <0.01 | <0.01 | <0.01 |
| 0423 | 17.04 | 3.49 | <0.01 | <0.01 | 0.011 | <0.01 | <0.01 | <0.01 | <0.01 | <0.01 | <0.01 | <0.01 | <0.01 |
| 0424 | 9.94 | 1.47 | 0.50 | <0.01 | <0.01 | <0.01 | <0.01 | <0.01 | <0.01 | <0.01 | <0.01 | <0.01 | <0.01 |
| 0425 | 13.97 | 1.49 | 0.50 | <0.01 | <0.01 | <0.01 | <0.01 | <0.01 | <0.01 | <0.01 | <0.01 | <0.01 | <0.01 |
| 0426 | 20.03 | 1.48 | 0.50 | <0.01 | 0.012 | <0.01 | <0.01 | <0.01 | <0.01 | <0.01 | <0.01 | <0.01 | <0.01 |
| 0427 | 25.00 | 1.50 | 0.50 | <0.01 | 0.015 | <0.01 | <0.01 | <0.01 | <0.01 | <0.01 | <0.01 | <0.01 | <0.01 |
| 0428 | 16.95 | 1.48 | 0.50 | <0.01 | 0.010 | <0.01 | <0.01 | <0.01 | <0.01 | <0.01 | <0.01 | <0.01 | <0.01 |
| 0429 | 16.94 | 1.48 | 0.49 | <0.01 | 0.010 | <0.01 | <0.01 | <0.01 | <0.01 | <0.01 | <0.01 | <0.01 | <0.01 |
| 0430 | 17.04 | 1.50 | 0.50 | <0.01 | 0.010 | <0.01 | <0.01 | <0.01 | <0.01 | <0.01 | <0.01 | <0.01 | <0.01 |
| 0431 | 16.97 | 1.48 | 0.50 | 0.094 | 0.010 | <0.01 | <0.01 | <0.01 | <0.01 | <0.01 | <0.01 | <0.01 | <0.01 |
| 0432 | 17.00 | 1.49 | 0.50 | 0.27 | 0.010 | <0.01 | <0.01 | <0.01 | <0.01 | <0.01 | <0.01 | <0.01 | <0.01 |
| 0433 | 17.02 | 1.48 | 0.50 | <0.01 | 0.12 | <0.01 | <0.01 | <0.01 | <0.01 | <0.01 | <0.01 | <0.01 | <0.01 |
| 0434 | 16.99 | 1.45 | 0.50 | <0.01 | 0.32 | <0.01 | <0.01 | <0.01 | <0.01 | <0.01 | <0.01 | <0.01 | <0.01 |
| 0435 | 17.01 | 1.43 | 0.50 | <0.01 | <0.01 | 0.057 | <0.01 | <0.01 | <0.01 | <0.01 | <0.01 | <0.01 | <0.01 |
| 0436 | 17.03 | 1.43 | 0.50 | <0.01 | <0.01 | <0.01 | 0.30 | <0.01 | <0.01 | <0.01 | <0.01 | <0.01 | <0.01 |
| 0437 | 17.02 | 1.47 | 0.50 | <0.01 | <0.01 | <0.01 | <0.01 | 0.055 | <0.01 | <0.01 | <0.01 | <0.01 | <0.01 |
| 0438 | 16.95 | 1.47 | 0.50 | <0.01 | 0.016 | <0.01 | <0.01 | 0.026 | <0.01 | 0.086 | <0.01 | <0.01 | <0.01 |
| 0439 | 17.00 | 1.49 | 0.50 | <0.01 | 0.012 | <0.01 | <0.01 | 0.021 | <0.01 | <0.01 | 0.078 | <0.01 | <0.01 |
| 0440 | 17.02 | 1.50 | 0.50 | <0.01 | 0.010 | <0.01 | <0.01 | 0.022 | <0.01 | <0.01 | <0.01 | 0.006 | <0.01 |
| | | | | | | | | | | | | (used: | |
| | | | | | | | | | | | | 0.05) | |
| 0441 | 17.04 | 1.49 | 0.50 | <0.01 | 0.010 | <0.01 | <0.01 | 0.022 | <0.01 | <0.01 | <0.01 | <0.01 | 0.11 |
| 0442 | 16.99 | <0.01 | <0.01 | <0.01 | 0.010 | <0.01 | <0.01 | 0.019 | 1.97 | <0.01 | <0.01 | — | <0.01 |
| 0443 | 17.05 | 4.02 | <0.01 | <0.01 | 0.011 | <0.01 | <0.01 | <0.01 | <0.01 | <0.01 | <0.01 | <0.01 | <0.01 |
| 0502 | 16.96 | 1.66 | 0.32 | 0.04 | 0.025 | <0.01 | <0.01 | <0.01 | <0.01 | <0.01 | <0.01 | 0.01 | |
| 0503 | 16.97 | 1.68 | 0.32 | 0.04 | 0.024 | <0.01 | <0.01 | <0.01 | <0.01 | <0.01 | <0.01 | <0.001 | 0.01 |
| | | | | | | | | | | | | (used: | |
| | | | | | | | | | | | | 0.10) | |
| 0504 | 16.94 | 1.68 | <0.01 | <0.01 | 0.011 | <0.01 | <0.01 | 0.20 | <0.01 | <0.01 | <0.01 | <0.01 | <0.01 |
| 0505 | 16.97 | 1.39 | <0.01 | <0.01 | 0.011 | <0.01 | <0.01 | 0.40 | <0.01 | <0.01 | <0.01 | <0.01 | <0.01 |
| Large melts: | | | | | | | | | | | | | |
| 76/4988 | 16.81 | 2.29 | 0.013 | 0.024 | 0.028 | <0.001 | <0.001 | 0.016 | <0.001 | <0.001 | <0.001 | <0.001 | 0.005 |
| 76/5180 | 17.11 | 1.47 | 0.011 | 0.094 | 0.008 | <0.001 | <0.001 | 0.28 | <0.001 | <0.001 | <0.001 | <0.005 | 0.006 |

TABLE 4

| Batch 93/ | C | S | O | N |
|---|---|---|---|---|
| 0420 | 0.0034 | 0.0012 | 0.0130 | 0.0016 |
| 0421 | 0.0021 | 0.0012 | 0.0110 | 0.0014 |
| 0422 | 0.0021 | 0.0012 | 0.0110 | 0.0015 |
| 0423 | 0.0034 | 0.0012 | 0.0100 | 0.0014 |
| 0424 | 0.0028 | 0.0011 | 0.0110 | 0.0010 |
| 0425 | 0.0032 | 0.0012 | 0.0089 | 0.0012 |
| 0426 | 0.0020 | 0.0012 | 0.0081 | 0.0011 |
| 0427 | 0.0022 | 0.0011 | 0.0084 | 0.0010 |
| 0428 | 0.0026 | 0.0012 | 0.0086 | 0.0013 |
| 0429 | 0.0056 | 0.0012 | 0.0070 | 0.0012 |
| 0430 | 0.0170 | 0.0012 | 0.0048 | 0.0012 |
| 0431 | 0.0014 | 0.0013 | 0.0094 | 0.0013 |
| 0432 | 0.0019 | 0.0013 | 0.0096 | 0.0012 |
| 0433 | 0.0019 | 0.0012 | 0.0100 | 0.0012 |
| 0434 | 0.0017 | 0.0025 | 0.0110 | 0.0010 |
| 0435 | 0.0030 | 0.0032 | 0.0150 | 0.0007 |
| 0436 | 0.0022 | 0.0030 | 0.0110 | 0.0007 |
| 0437 | 0.0023 | 0.0017 | 0.0110 | 0.0006 |
| 0438 | 0.0027 | 0.0010 | 0.0093 | 0.0011 |
| 0439 | 0.0050 | 0.0010 | 0.0023 | 0.0006 |
| 0440 | 0.0022 | 0.0008 | 0.0050 | 0.0010 |
| 0441 | 0.0020 | 0.0009 | 0.0075 | 0.0008 |
| 0442 | 0.0027 | 0.0008 | 0.0017 | 0.0005 |
| 0443 | 0.0032 | 0.0009 | 0.0130 | 0.0070 |
| 0502 | 0.0038 | 0.0028 | 0.0120 | 0.0029 |
| 0503 | 0.0058 | 0.0022 | 0.0035 | 0.0028 |
| 0504 | 0.0025 | 0.0010 | 0.0092 | 0.0008 |
| 0505 | 0.0024 | 0.0010 | 0.0063 | 0.0008 |
| Large melts | | | | |
| 76/4988 | 0.0010 | 0.0042 | 0.0121 | 0.0023 |
| 76/5180 | 0.0021 | 0.0062 | 0.0073 | 0.0026 |

TABLE 5

| | Strip | | Average | | | |
|---|---|---|---|---|---|---|
| Batch | thickness | | grain size | 1/d | H_{c} | |
| 93/ | mm | Annealing | d mm | 1/mm | A/cm | μₘₐₓ |
| 0329 | 0.35 | 4 h 850° C. | 0.075 | 13.33 | 1.035 | 3584 |
| 0329 | 0.35 | 10 h 910° C. | 0.151 | 6.62 | 0.622 | 5090 |
| 0329 | 0.35 | 10 h 910° C. + | 0.254 | 3.94 | 0.418 | 5737 |
| | | 70 h 930° C. | | | | |
| 0329 | 0.35 | 4 h 1100° C. | 0.214 | 4.67 | 0.524 | 7497 |
| 0329 | 0.35 | 4 h 1100° C. + | 0.360 | 2.78 | 0.396 | 12084 |
| | | 10 h 910° C. | | | | |
| 0329 | 0.35 | 4 h 1050° C. | 0.302 | 3.31 | 0.501 | 7943 |
| 0329 | 0.35 | 4 h 1050° C. + | 0.214 | 4.67 | 0.367 | 14291 |
| | | 10 h 910° C. | | | | |
| 0329 | 0.35 | 4 h 1150° C. | 0.254 | 3.94 | 0.473 | 7860 |
| 0325 | 0.35 | 4 h 1050° C. | 0.197 | 5.08 | 1.004 | 3554 |
| 0328 | 0.35 | 4 h 1050° C. | 0.278 | 3.60 | 0.625 | 5387 |
| 0330 | 0.35 | 4 h 1050° C. | 0.401 | 2.49 | 0.353 | 11509 |
| 0329 | 0.35 | 4 h 1000° C. + | 0.250 | 4.00 | 0.384 | 15658 |
| | | 10 h 910° C. | | | | |
| 0329 | 0.20 | 4 h 1000° C. + | 0.213 | 4.69 | 0.474 | 10978 |
| | | 10 h 910° C. | | | | |
| 0329 | 0.10 | 4 h 1000° C. + | 0.151 | 6.62 | 0.523 | 10965 |
| | | 10 h 910° C. | | | | |

TABLE 6

| Batch | 1st onset | Peak | 1^{st} onset | Peak | T_{c} peak | T_{c} peak | Middle |
|---|---|---|---|---|---|---|---|
| 93/ | heating (T\ddot{_{U}}2) | heating | cooling (T\ddot{_{U}}1) | cooling | heating | cooling | T_{c} peak |
| 0322 | 928 | 938 | 908 | 897 | #NV | #NV | #NV |
| 0323 | 940 | 951 | 932 | 919 | #NV | #NV | #NV |
| 0324 | 950 | 964 | 944 | 928 | #NV | #NV | #NV |
| 0325 | 905 | 918 | 880 | 859 | #NV | #NV | #NV |
| 0326 | 921 | 937 | 884 | 862 | #NV | #NV | #NV |
| 0327 | 919 | 930 | 897 | 879 | #NV | #NV | #NV |
| 0328 | 934 | 943 | 914 | 898 | #NV | #NV | #NV |
| 0329 | 952 | 958 | 933 | 926 | 937 | #NV | #NV |
| 0330 | 980 | 987 | 958 | 951 | 943 | 931 | 937 |
| 0331 | 934 | 946 | 913 | 895 | #NV | #NV | #NV |
| 0332 | 931 | 945 | 910 | 893 | #NV | #NV | #NV |
| 0333 | 937 | 950 | 915 | 898 | #NV | #NV | #NV |
| 0334 | 933 | 945 | 912 | 895 | #NV | #NV | #NV |
| 0335 | 962 | 974 | 953 | 939 | #NV | #NV | #NV |
| 0336 | 933 | 947 | 912 | 895 | #NV | #NV | #NV |
| 0337 | 933 | 947 | 912 | 895 | #NV | #NV | #NV |
| 0338 | 934 | 947 | 913 | 895 | #NV | #NV | #NV |
| 0339 | 1070 | 1088 | 1020 | 1011 | 962 | 950 | 956 |
| 0420 | 988 | 995 | 964 | 958 | 941 | 933 | 937 |
| 0421 | 971 | 978 | 956 | 947 | 960 | #NV | #NV |
| 0422 | 1017 | 1026 | 979 | 974 | 940 | 931 | 936 |
| 0423 | 1037 | 1063 | 994 | 988 | 938 | 929 | 934 |
| 0424 | 993 | 997 | 952 | 947 | 886 | 878 | 882 |
| 0425 | 965 | 971 | 939 | 933 | 916 | 907 | 912 |
| 0426 | 949 | 958 | 935 | 923 | #NV | #NV | #NV |
| 0427 | 951 | 963 | 939 | 924 | #NV | #NV | #NV |
| 0428 | 951 | 960 | 934 | 923 | 936 | #NV | #NV |
| 0429 | 947 | 960 | 934 | 922 | 938 | #NV | #NV |
| 0430 | 944 | 952 | 932 | 917 | 938 | #NV | #NV |
| 0431 | 950 | 958 | 931 | 920 | 937 | #NV | #NV |
| 0432 | 946 | 953 | 925 | 912 | 935 | #NV | #NV |
| 0433 | 949 | 957 | 929 | 919 | 938 | #NV | #NV |
| 0434 | 944 | 952 | 921 | 911 | 937 | #NV | #NV |
| 0435 | 953 | 961 | 932 | 924 | 938 | #NV | #NV |
| 0436 | 952 | 959 | 931 | 922 | 935 | #NV | #NV |
| 0437 | 954 | 961 | 934 | 926 | 937 | #NV | #NV |
| 0438 | 955 | 962 | 934 | 926 | 938 | #NV | #NV |
| 0439 | 958 | 965 | 936 | 926 | 934 | #NV | #NV |
| 0440 | 954 | 961 | 934 | 925 | 936 | #NV | #NV |
| 0441 | 952 | 959 | 932 | 924 | 937 | #NV | #NV |
| 0442 | #NV | #NV | (1065) | (1050) | 924 | 916 | 920 |
| 0443 | #NV | #NV | 1012 | 1001 | 936 | 925 | 931 |
| 0502 | 960 | 968 | 941 | 930 | 939 | #NV | #NV |
| 0503 | 959 | 968 | 941 | 929 | 939 | #NV | #NV |
| 0504 | 975 | 982 | 956 | 949 | 939 | 929 | 934 |
| 0505 | 970 | 977 | 953 | 946 | 936 | 926 | 931 |
| 76/4988 | 989 | 995 | 962 | 957 | 939 | 929 | 934 |
| 76/5180 | 965 | 974 | 949 | 942 | 938 | #NV | #NV |

TABLE 7

| | | | | | | | | | | | P_{Hys} |
|---|---|---|---|---|---|---|---|---|---|---|---|
| | Annealing | B20 | B25 | B50 | B90 | B100 | B160 | H_{c} in | | Br in | 1.5T |
| Annealing | variant | in T | in T | in T | in T | in T | in T | A/cm | μₘₐₓ | T | Ws/kg |
| 4 h 1050° C. | 1 | 1.813 | 1.84 | 1.933 | 2.025 | 2.043 | 2,. 21 | 0.296 | 19653 | 1.505 | 0.045 |
| Cool. 50° C./h + | | | | | | | | | | | |
| 10 h, 910° C. | | | | | | | | | | | |
| 4 h 1050° C. + | 1 | 1.814 | 1.84 | 1.931 | 2.024 | 2.042 | 2.12 | 0.340 | 17767 | 1.525 | 0.046 |
| 10 h 910° C | | | | | | | | | | | |
| 10 h 1050° C. | 1 | 1.760 | 1.788 | 1.888 | 1.990 | 2.010 | 2.102 | 0.316 | 14358 | 1.457 | 0.050 |
| Cool. 30° C./h + | | | | | | | | | | | |
| 10 h 910° C. | | | | | | | | | | | |
| 4 h 1050° C. + | 1 | 1.790 | 1.817 | 1.916 | 2.015 | 2.034 | 2.122 | 0.346 | 12584 | 1.378 | 0.049 |
| 10 h 910° C. | | | | | | | | | | | |
| 4 h 1050° C. | 1 | 1.643 | 1.672 | 1.776 | 1.892 | 1.917 | 2.035 | 0.660 | 6010 | 1.392 | 0.075 |
| Cooling zone | | | | | | | | | | | |
| 10 h, 910° C. | | | | | | | | | | | |
| 4 h 1050° C., | 2 | 1.799 | 1.825 | 1.921 | 2.018 | 2.037 | 2.124 | 0.326 | 14586 | 1.542 | 0.043 |
| 10 h 910° C. | | | | | | | | | | | |
| 4 h 1050° C., | 2 | 1.795 | 1.820 | 1.915 | 2.012 | 2.032 | 2.119 | 0.341 | 13837 | 1.532 | 0.043 |
| 2 h 930° C. | | | | | | | | | | | |
| 4 h 1050° C., | 2 | 1.798 | 1.824 | 1.921 | 2.018 | 2.037 | 2.125 | 0.354 | 13105 | 1.517 | 0.044 |
| 2 h 910° C. | | | | | | | | | | | |
| 2 h 1050° C., | 2 | 1.798 | 1.824 | 1.919 | 2.016 | 2.036 | 2.123 | 0.380 | 12581 | 1.508 | 0.046 |
| 4 h 910° C. | | | | | | | | | | | |
| 10 h 1050° C. | 2 | 1.749 | 1.776 | 1.877 | 1.982 | 2.003 | 2.098 | 0.293 | 12494 | 1.482 | 0.045 |
| Cool., 50° C./h | | | | | | | | | | | |
| to 930° C. 10 h | | | | | | | | | | | |
| 4 h 1050° C., | 2 | 1.790 | 1.817 | 1.914 | 2.012 | 2.031 | 2.119 | 0.413 | 9787 | 1.384 | 0.051 |
| 2 h 910° C. | | | | | | | | | | | |
| 4 h 1050° C. | 3 | 1.812 | 1.839 | 1.932 | 2.025 | 2.043 | 2.122 | 0.305 | 14015 | 1.518 | 0.043 |
| Cool. 50° C./h | | | | | | | | | | | |
| 4 h 1050° C. | 3 | 1.812 | 1.838 | 1.929 | 2.021 | 2.04 | 2.119 | 0.347 | 12670 | 1.502 | 0.045 |
| Cool. 150° C./h | | | | | | | | | | | |
| 10 h 1050° C. | 3 | 1.756 | 1.783 | 1.885 | 1.986 | 2.007 | 2.095 | 0.342 | 10419 | 1.438 | 0.051 |
| Cool. 30° C./h | | | | | | | | | | | |
| 4 h 1050° C. | 3 | 1.791 | 1.819 | 1.917 | 2.016 | 2.036 | 2.124 | 0.359 | 10348 | 1.405 | 0.047 |
| Cool. 150° C./h | | | | | | | | | | | |
| 10 h 910° C. + | Not acc. to | 1.595 | 1.622 | 1.723 | 1.838 | 1.863 | 1.991 | 0.456 | 5415 | 1.271 | 0.072 |
| 70 h 930° C. + | invention | | | | | | | | | | |
| 61 h 950° C. | | | | | | | | | | | |
| 10 h 910° C. + | Not acc. to | 1.613 | 1.640 | 1.740 | 1.853 | 1.877 | 1.999 | 0.662 | 4868 | 1.148 | 0.072 |
| 70 h 930° C. | invention | | | | | | | | | | |
| 10 h 910° C. | Not acc. to | 1.615 | 1.642 | 1.74 | 1.848 | 1.873 | 1.989 | 0.684 | 4868 | 1.112 | 0.074 |
| | invention | | | | | | | | | | |
| 4 h 1050° C. | Not acc. to | 1.635 | 1.667 | 1.775 | 1.893 | 1.917 | 2.035 | 0.740 | 3769 | 0.969 | 0.095 |
| Cooling zone | invention | | | | | | | | | | |
| 4 h 850° C. | Not acc. to | 1.648 | 1.677 | 1.776 | 1.883 | 1.906 | 2.019 | 1.052 | 3533 | 0.867 | 0.081 |
| | invention | | | | | | | | | | |

TABLE 8

| | B20 | B25 | B50 | B90 | B100 | B160 | H_{c} in | | |
|---|---|---|---|---|---|---|---|---|---|
| Annealing | in T | in T | in T | in T | in T | in T | A/cm | μₘₐₓ | Br in T |
| 10 h 910° C. | 1.615 | 1.642 | 1.740 | 1.848 | 1.873 | 1.989 | 0.684 | 4868 | 1.112 |
| 10 h 910° C. + 70 h 930° C. | 1.613 | 1.640 | 1.740 | 1.853 | 1.877 | 1.999 | 0.662 | 4868 | 1.148 |
| 10 h 910° C. + 70 h 930° C. + | 1.595 | 1.622 | 1.723 | 1.838 | 1.863 | 1.991 | 0.456 | 5415 | 1.271 |
| 61 h 950° C. | | | | | | | | | |
| 10 h 910° C. + 70 h 930° C. + | 1.596 | 1.623 | 1.722 | 1.838 | 1.863 | 1.990 | 0.473 | 5557 | 1.222 |
| 61 h 950° C. + 4 h 960° C. | | | | | | | | | |
| 10 h 910° C. + 70 h 930° C. + | 1.713 | 1.742 | 1.842 | 1.948 | 1.969 | 2.070 | 0.544 | 8117 | 1.391 |
| 61 h 950° C. + 4 h 960° C. + | | | | | | | | | |
| 4 h 970° C. | | | | | | | | | |
| 10 h 910° C. + 70 h 930° C. + | 1.783 | 1.811 | 1.909 | 2.011 | 2.030 | 2.119 | 0.414 | 10784 | 1.452 |
| 61 h 950° C. + 4 h 960° C. + | | | | | | | | | |
| 4 h 970° C. + 4 h 980° C. | | | | | | | | | |
| 10 h 910° C. + 70 h 930° C. + | 1.792 | 1.822 | 1.923 | 2.025 | 2.045 | 2.131 | 0.358 | 11337 | 1.432 |
| 61 h 950° C. + 4 h 960° C. + | | | | | | | | | |
| 4 h 970° C. + 4 h 980° C. + | | | | | | | | | |
| 4 h 990° C. | | | | | | | | | |
| 10 h 910° C. + 70 h 930° C. + | 1.779 | 1.808 | 1.911 | 2.015 | 2.035 | 2.117 | 0.315 | 11155 | 1.406 |
| 61 h 950° C. + 4 h 960° C. + | | | | | | | | | |
| 4 h 970° C. + 4 h 980° C. + | | | | | | | | | |
| 4 h 990° C. + 4 h 1000° C. | | | | | | | | | |
| 10 h 910° C. + 70 h 930° C. + | 1.772 | 1.803 | 1.908 | 2.015 | 2.036 | 2.128 | 0.321 | 11227 | 1.397 |
| 61 h 950° C. + 4 h 960° C. + | | | | | | | | | |
| 4 h 970° C. + 4 h 980° C. + | | | | | | | | | |
| 4 h 990° C. + 4 h 1000° C. + | | | | | | | | | |
| 4 h 1010° C. | | | | | | | | | |
| 10 h 910° C. + 70 h 930° C. + | 1.757 | 1.787 | 1.892 | 2.002 | 2.023 | 2.120 | 0.343 | 10375 | 1.387 |
| 61 h 950° C. + 4 h 960° C. + | | | | | | | | | |
| 4 h 970° C. + 4 h 980° C. + | | | | | | | | | |
| 4 h 990° C. + 4 h 1000° C. + | | | | | | | | | |
| 4 h 1010° C. + 4 h 1030° C. | | | | | | | | | |
| 10 h 910° C. + 70 h 930° C. + | 1.703 | 1.734 | 1.844 | 1.962 | 1.986 | 2.095 | 0.371 | 8527 | 1.343 |
| 61 h 950° C. + 4 h 960° C. + | | | | | | | | | |
| 4 h 970° C. + 4 h 980° C. + | | | | | | | | | |
| 4 h 990° C. + 4 h 1000° C. + | | | | | | | | | |
| 4 h 1010° C. + 4 h 1030° C. + | | | | | | | | | |
| 4 h 1050° C. | | | | | | | | | |

TABLE 9

| | B20 | B25 | B50 | B90 | B100 | B160 | H_{c} in | | Br | |
|---|---|---|---|---|---|---|---|---|---|---|
| Annealing | in T | in T | in T | in T | in T | in T | A/cm | μₘₐₓ | in T | Demagnetised? |
| 4 h 1000° C. | 1.801 | 1.828 | 1.923 | 2.019 | 2.038 | 2.123 | 0.407 | 10618 | 1.444 | No |
| 4 h 1000° C. + 4 h 900° C. + | 1.796 | 1.825 | 1.921 | 2.018 | 2.038 | 2.124 | 0.422 | 10593 | 1.324 | No |
| 4 h 1000° C. + 4 h 900° C. + | 1.796 | 1.824 | 1.921 | 2.018 | 2.037 | 2.123 | 0.414 | 11436 | 1.359 | No |
| 4 h 910° C. | | | | | | | | | | |
| 4 h 1000° C. + 4 h 900° C. + | 1. 795 | 1.822 | 1.918 | 2.015 | 2.034 | 2.119 | 0.406 | 12326 | 1.363 | No |
| 4 h 910° C. + 4 h 920° C. + | | | | | | | | | | |
| 4 h 1000° C. + 4 h 900° C. | | | | | | | | | | |
| 4 h 910° C. + 4 h 920° C. + | 1.799 | 1.826 | 1.921 | 2.017 | 2.036 | 2.121 | 0.386 | 13961 | 1.410 | No |
| 4 h 930° C. | | | | | | | | | | |
| 4 h 1000° C. + 4 h 900° C. + | 1.791 | 1.818 | 1.916 | 2.013 | 2.031 | 2.119 | 0.387 | 15856 | 1.511 | Yes |
| 4 h 910° C. + 4 h 920° C. + | | | | | | | | | | |
| 4 h 930° C. + 4 h 940° C. | | | | | | | | | | |
| 4 h 1000° C. + 4 h 900° C. + | 1. 793 | 1.819 | 1.916 | 2.013 | 2.032 | 2.119 | 0.401 | 16609 | 1.550 | Yes |
| 4 h 910° C. + 4 h 920° C. + | | | | | | | | | | |
| 4 h 930° C. + 4 h 940° C. + | | | | | | | | | | |
| 4 h 950° C. | | | | | | | | | | |
| 4 h 1000° C. + 4 h 900° C. + | 1. 794 | 1.820 | 1.916 | 2.012 | 2.031 | 2.117 | 0.427 | 15298 | 1.554 | Yes |
| 4 h 910° C. + 4 h 920° C. + | | | | | | | | | | |
| 4 h 930° C. + 4 h 940° C. + | | | | | | | | | | |
| 4 h 950° C. + 4 h 960° C. | | | | | | | | | | |
| 4 h 1000° C. + 4 h 900° C. + | 1.767 | 1.794 | 1.890 | 1.990 | 2.009 | 2.102 | 0.525 | 11053 | 1.497 | Yes |
| 4 h 910° C. + 4 h 920° C. + | | | | | | | | | | |
| 4 h 930° C. + 4 h 940° C. + | | | | | | | | | | |
| 4 h 950° C. + 4 h 960° C. + | | | | | | | | | | |
| 4 h 970° C. | | | | | | | | | | |
| 4 h 1000° C. + 4 h 900° C. + | 1.787 | 1.815 | 1.917 | 2.017 | 2.036 | 2.123 | 0.433 | 9550 | 1.469 | No |
| 4 h 910° C. + 4 h 920° C. + | | | | | | | | | | |
| 4 h 930° C. + 4 h 940° C. + | | | | | | | | | | |
| 4 h 950° C. + 4 h 960° C. + | | | | | | | | | | |
| 4 h 970° C. + 4 h 980° C. | | | | | | | | | | |
| 4 h 1000° C. + 4 h 900° C. + | 1.787 | 1.815 | 1.917 | 2.018 | 2.037 | 2.124 | 0.430 | 11789 | 1.463 | Yes |
| 4 h 910° C. + 4 h 920° C. + | | | | | | | | | | |
| 4 h 930° C. + 4 h 940° C. + | | | | | | | | | | |
| 4 h 950° C. + 4 h 960° C. + | | | | | | | | | | |
| 4 h 970° C. + 4 h 980° C. | | | | | | | | | | |
| 4 h 1000° C. + 4 h 900° C. + | 1. 782 | 1.811 | 1.910 | 2.011 | 2.031 | 2.119 | 0.431 | 12585 | 1.482 | Yes |
| 4 h 910° C. + 4 h 920° C. + | | | | | | | | | | |
| 4 h 930° C. + 4 h 940° C. + | | | | | | | | | | |
| 4 h 950° C. + 4 h 960° C. + | | | | | | | | | | |
| 4 h 970° C. + 4 h 980° C. + | | | | | | | | | | |
| 4 h 990° C. | | | | | | | | | | |
| 4 h 1000° C. + 4 h 900° C. + | 1. 783 | 1.812 | 1.912 | 2.012 | 2.032 | 2.120 | 0.429 | 9965 | 1.485 | No |
| 4 h 910° C. + 4 h 920° C. + | | | | | | | | | | |
| 4 h 930° C. + 4 h 940° C. + | | | | | | | | | | |
| 4 h 950° C. + 4 h 960° C. + | | | | | | | | | | |
| 4 h 970° C. + 4 h 980° C. + | | | | | | | | | | |
| 4 h 990° C. | | | | | | | | | | |
| 4 h 1000° C. + 4 h 900° C. + | 1.778 | 1.807 | 1.907 | 2.009 | 2.028 | 2.117 | 0.433 | 11762 | 1.424 | Yes |
| 4 h 910° C. + 4 h 920° C. + | | | | | | | | | | |
| 4 h 930° C. + 4 h 940° C. + | | | | | | | | | | |
| 4 h 950° C. + 4 h 960° C. + | | | | | | | | | | |
| 4 h 970° C. + 4 h 980° C. + | | | | | | | | | | |
| 4 h 990° C. + 4 h 1000° C. | | | | | | | | | | |
| 4 h 1000° C. + 4 h 900° C. + | 1.779 | 1.807 | 1.908 | 2.009 | 2.029 | 2.118 | 0.437 | 9405 | 1.425 | No |
| 4 h 910° C. + 4 h 920° C. + | | | | | | | | | | |
| 4 h 930° C. + 4 h 940° C. + | | | | | | | | | | |
| 4 h 950° C. + 4 h 960° C. + | | | | | | | | | | |
| 4 h 970° C. + 4 h 980° C. + | | | | | | | | | | |
| 4 h 990° C. + 4 h 1000° C. | | | | | | | | | | |
| 4 h 1000° C. + 4 h 900° C. + | 1. 775 | 1.804 | 1.905 | 2.007 | 2.026 | 2.116 | 0.460 | 11012 | 1.430 | Yes |
| 4 h 910° C. + 4 h 920° C. + | | | | | | | | | | |
| 4 h 930° C. + 4 h 940° C. + | | | | | | | | | | |
| 4 h 950° C. + 4 h 960° C. + | | | | | | | | | | |
| 4 h 970° C. + 4 h 980° C. + | | | | | | | | | | |
| 4 h 990° C. + 4 h 1000° C. + | | | | | | | | | | |
| 10 h 950° C. | | | | | | | | | | |

TABLE 10

| | | | | | | | | | | | P_{Hys} |
|---|---|---|---|---|---|---|---|---|---|---|---|
| Batch | B20 | B25 | B50 | B90 | B100 | B160 | H_{c} | | Bᵣ | rho in | 1.5T |
| 93/ | T | T | T | T | T | T | A/cm | μₘₐₓ | T | μΩm | Ws/kg |
| 0322 | 1.676 | 1.709 | 1.815 | 1.924 | 1.947 | 2.056 | 1.465 | 3130 | 1.098 | 0.3081 | 0.107 |
| 0323 | 1.765 | 1.795 | 1.892 | 1.995 | 2.016 | 2.121 | 1.120 | 3815 | 1.015 | 0.1872 | 0.079 |
| 0324 | 1.800 | 1.836 | 1.949 | 2.059 | 2.082 | 2.189 | 1.451 | 2544 | 0.766 | 0.1570 | 0.093 |
| 0325 | 1.700 | 1.729 | 1.830 | 1.937 | 1.959 | 2.068 | 0.894 | 4195 | 0.919 | 0.3360 | 0.067 |
| 0326 | 1.715 | 1.753 | 1.873 | 1.992 | 2.016 | 2.133 | 1.144 | 2735 | 0.533 | 0.3739 | 0.074 |
| 0327 | 1.665 | 1.694 | 1.794 | 1.904 | 1.926 | 2.039 | 0.890 | 4059 | 0.908 | 0.3287 | 0.070 |
| 0328 | 1.656 | 1.686 | 1.787 | 1.895 | 1.918 | 2.031 | 0.928 | 3890 | 0.945 | 0.3154 | 0.076 |
| 0329 | 1.651 | 1.681 | 1.780 | 1.887 | 1.911 | 2.024 | 1.035 | 3584 | 0.876 | 0.3042 | 0.079 |
| 0330 | 1.648 | 1.677 | 1.776 | 1.883 | 1.906 | 2.019 | 1.052 | 3533 | 0.867 | 0.2859 | 0.081 |
| 0331 | 1.693 | 1.729 | 1.847 | 1.967 | 1.991 | 2.110 | 1.167 | 2639 | 0.551 | 0.3326 | 0.080 |
| 0332 | 1.681 | 1.719 | 1.837 | 1.956 | 1.980 | 2.098 | 1.229 | 2633 | 0.588 | 0.3580 | 0.083 |
| 0333 | 1.703 | 1.740 | 1.856 | 1.972 | 1.996 | 2.109 | 1.328 | 2788 | 0.756 | 0.3518 | 0.088 |
| 0334 | 1.788 | 1.822 | 1.929 | 2.035 | 2.055 | 2.151 | 0.968 | 3656 | 0.692 | 0.3475 | 0.069 |
| 0335 | 1.673 | 1.710 | 1.826 | 1.945 | 1.970 | 2.089 | 1.248 | 2643 | 0.658 | 0.2857 | 0.089 |
| 0336 | 1.696 | 1.733 | 1.850 | 1.969 | 1.992 | 2.109 | 1.198 | 2626 | 0.586 | 0.3396 | 0.081 |
| 0337 | 1.698 | 1.735 | 1.852 | 1.969 | 1.992 | 2.107 | 1.270 | 2563 | 0.578 | 0.3388 | 0.082 |
| 0338 | 1.696 | 1.734 | 1.852 | 1.970 | 1.994 | 2.110 | 1.241 | 2653 | 0.636 | 0.3334 | 0.084 |

TABLE 11

| | | | | | | | | | | | P_{Hys} |
|---|---|---|---|---|---|---|---|---|---|---|---|
| Batch | B20 | B25 | B50 | B90 | B100 | B160 | H_{c} | | Bᵣ | rho in | 1.5T |
| 93/ | T | T | T | T | T | T | A/cm | μₘₐₓ | T | μΩm | Ws/kg |
| 0328 | 1.623 | 1.652 | 1.751 | 1.864 | 1.887 | 2.005 | 0.627 | 4902 | 1.022 | — | 0.067 |
| 0329 | 1.618 | 1.646 | 1.746 | 1.858 | 1.881 | 2.002 | 0.622 | 5090 | 1.129 | — | 0.069 |
| 0330 | 1.615 | 1.642 | 1.74 | 1.848 | 1.873 | 1.989 | 0.684 | 4868 | 1.112 | — | 0.074 |
| 0331 | 1.657 | 1.69 | 1.807 | 1.933 | 1.961 | 2.09 | 0.659 | 3795 | 0.502 | — | 0.074 |
| 0334 | 1.799 | 1.832 | 1.938 | 2.039 | 2.059 | 2.148 | 0.659 | 4556 | 0.81 | — | 0.059 |
| 0335 | 1.652 | 1.686 | 1.801 | 1.923 | 1.948 | 2.073 | 0.928 | 3059 | 0.587 | — | 0.082 |

TABLE 12

| Batch | B20 | B25 | B50 | B90 | B100 | B160 | H_{c} | | Bᵣ | Rho in | P_{Hys} 1.5T |
|---|---|---|---|---|---|---|---|---|---|---|---|
| 93/ | T | T | T | T | T | T | A/cm | μₘₐₓ | T | μΩm | Ws/kg |
| 0328 | 1.771 | 1.802 | 1.911 | 2.017 | 2.036 | 2.126 | 0.473 | 6912 | 1.164 | — | 0.061 |
| 0329 | 1.598 | 1.624 | 1.725 | 1.842 | 1.868 | 1.997 | 0.418 | 5737 | 1.168 | — | 0.061 |
| 0330 | 1.613 | 1.64 | 1.74 | 1.853 | 1.877 | 1.999 | 0.662 | 4868 | 1.148 | — | 0.072 |
| 0331 | 1.658 | 1.693 | 1.811 | 1.941 | 1.967 | 2.098 | 1.265 | 2702 | 0.938 | — | 0.104 |
| 0334 | 1.787 | 1.820 | 1.931 | 2.038 | 2.060 | 2.155 | 1.289 | 3228 | 1.158 | — | 0.099 |
| 0335 | 1.652 | 1.688 | 1.809 | 1.943 | 1.972 | 2.116 | 0.978 | 3246 | 0.546 | — | 0.084 |

TABLE 13

| | | | | | | | | | | Rho | P_{Hys} |
|---|---|---|---|---|---|---|---|---|---|---|---|
| Batch | B20 | B25 | B50 | B90 | B100 | B160 | H_{c} | | Bᵣ | in | 1.5 T |
| 93/ | T | T | T | T | T | T | A/cm | μₘₐₓ | T | μΩm | Ws/kg |
| 0323 | 1.719 | 1.75 | 1.855 | 1.973 | 1.997 | 2.111 | 0.492 | 5433 | 1.003 | 0.189 | 0.071 |
| 0328 | 1.768 | 1.797 | 1.895 | 1.994 | 2.013 | 2.102 | 0.643 | 5392 | 1.212 | 0.317 | 0.065 |
| 0329 | 1.803 | 1.83 | 1.923 | 2.017 | 2.035 | 2.117 | 0.509 | 7929 | 1.377 | 0.310 | 0.055 |
| 0330 | 1.809 | 1.836 | 1.927 | 2.019 | 2.037 | 2.117 | 0.369 | 16218 | 1.498 | 0.291 | 0.046 |
| 0331 | 1.703 | 1.739 | 1.86 | 1.985 | 2.01 | 2.127 | 1.033 | 2980 | 0.967 | 0.335 | 0.091 |
| 0334 | 1.707 | 1.742 | 1.860 | 1.979 | 2.002 | 2.113 | 1.145 | 2994 | 0.958 | 0.350 | 0.091 |
| 0335 | 1.801 | 1.833 | 1.942 | 2.046 | 2.067 | 2.155 | 0.414 | 6043 | 1.168 | 0.289 | 0.064 |
| 0339 | 1.707 | 1.739 | 1.851 | 1.968 | 1.990 | 2.089 | 0.297 | 7651 | 0.869 | — | 0.051 |

TABLE 14

| | | | | | | | | | | Rho | P_{Hys} |
|---|---|---|---|---|---|---|---|---|---|---|---|
| Batch | B20 | B25 | B50 | B90 | B100 | B160 | H_{c} | | Bᵣ | in | 1.5 T |
| 93/ | T | T | T | T | T | T | A/cm | μₘₐₓ | T | μΩm | Ws/kg |
| 0323 | 1.72 | 1.748 | 1.853 | 1.971 | 1.995 | 2.11 | 0.402 | 7983 | 1.312 | 0.189 | 0.060 |
| 0328 | 1.777 | 1.805 | 1.902 | 2.001 | 2.02 | 2.108 | 0.415 | 11322 | 1.493 | 0.317 | 0.049 |
| 0329 | 1.808 | 1.834 | 1.927 | 2.02 | 2.038 | 2.12 | 0.383 | 13490 | 1.529 | 0.311 | 0.046 |
| 0330 | 1.807 | 1.834 | 1.927 | 2.02 | 2.039 | 2.119 | 0.353 | 14673 | 1.529 | 0.290 | 0.047 |
| 0331 | 1.701 | 1.734 | 1.854 | 1.982 | 2.008 | 2.129 | 0.926 | 4382 | 1.277 | 0.335 | 0.081 |
| 0334 | 1.705 | 1.738 | 1.855 | 1.975 | 1.999 | 2.113 | 0.998 | 4145 | 1.184 | 0.348 | 0.087 |
| 0335 | 1.802 | 1.834 | 1.941 | 2.047 | 2.066 | 2.156 | 0.401 | 5998 | 1.234 | 0.288 | 0.065 |

TABLE 15

| | | | | | | | | | | | P_{Hys} |
|---|---|---|---|---|---|---|---|---|---|---|---|
| Batch | B20 | B25 | B50 | B90 | B100 | B160 | H_{c} | | Bᵣ | rho in | 1.5 T |
| 93/ | T | T | T | T | T | T | A/cm | μₘₐₓ | T | μΩm | Ws/kg |
| 0322 | 1.691 | 1.722 | 1.828 | 1.942 | 1.965 | 2.077 | 0.731 | 4574 | 1.093 | — | 0.074 |
| 0323 | 1.713 | 1.742 | 1.852 | 1.972 | 1.997 | 2.114 | 0.456 | 5732 | 0.998 | — | 0.074 |
| 0324 | 1.757 | 1.79 | 1.908 | 2.036 | 2.063 | 2.186 | 0.713 | 4522 | 1.051 | — | 0.078 |
| 0325 | 1.680 | 1.710 | 1.816 | 1.929 | 1.952 | 2.063 | 1.004 | 3554 | 0.925 | — | 0.082 |
| 0326 | 1.695 | 1.732 | 1.858 | 1.988 | 2.014 | 2.136 | 1.336 | 2397 | 0.899 | — | 0.107 |
| 0327 | 1.674 | 1.705 | 1.813 | 1.929 | 1.953 | 2.068 | 0.826 | 4061 | 0.948 | — | 0.078 |
| 0328 | 1.767 | 1.796 | 1.893 | 1.993 | 2.012 | 2.103 | 0.625 | 5387 | 1.179 | — | 0.066 |
| 0329 | 1.809 | 1.836 | 1.928 | 2.021 | 2.039 | 2.12 | 0.501 | 7943 | 1.388 | — | 0.054 |
| 0330 | 1.812 | 1.838 | 1.929 | 2.021 | 2.040 | 2.119 | 0.347 | 12670 | 1.502 | — | 0.045 |
| 0331 | 1.707 | 1.743 | 1.863 | 1.986 | 2.012 | 2.125 | 0.969 | 3049 | 0.948 | — | 0.088 |
| 0332 | 1.700 | 1.734 | 1.854 | 1.977 | 2.002 | 2.115 | 0.974 | 2982 | 0.894 | — | 0.087 |
| 0333 | 1.677 | 1.712 | 1.833 | 1.960 | 1.986 | 2.109 | 0.921 | 3259 | 0.903 | — | 0.084 |
| 0334 | 1.704 | 1.740 | 1.857 | 1.976 | 2.000 | 2.112 | 1.071 | 3042 | 0.925 | — | 0.087 |
| 0335 | 1.809 | 1.840 | 1.947 | 2.051 | 2.070 | 2.159 | 0.480 | 5631 | 1.194 | — | 0.068 |
| 0336 | 1.701 | 1.735 | 1.855 | 1.979 | 2.004 | 2.120 | 0.931 | 3140 | 0.907 | — | 0.085 |
| 0337 | 1.703 | 1.737 | 1.857 | 1.983 | 2.007 | 2.125 | 0.950 | 3157 | 0.926 | — | 0.087 |
| 0338 | 1.707 | 1.743 | 1.860 | 1.982 | 2.006 | 2.121 | 1.058 | 2934 | 0.912 | — | 0.089 |
| 0339 | 1.674 | 1.716 | 1.849 | 1.971 | 1.993 | 2.094 | 0.623 | 3911 | 0.552 | — | 0.053 |
| 0420 | 1.792 | 1.817 | 1.910 | 2.001 | 2.019 | 2.101 | 0.393 | 11121 | 1.483 | 0.3000 | 0.049 |
| 0421 | 1.795 | 1.822 | 1.919 | 2.017 | 2.037 | 2.124 | 0.459 | 7856 | 1.387 | 0.3013 | 0.058 |
| 0422 | 1.749 | 1.774 | 1.866 | 1.960 | 1.978 | 2.064 | 0.472 | 9770 | 1.441 | 0.3289 | 0.052 |
| 0423 | 1.577 | 1.604 | 1.703 | 1.815 | 1.838 | 1.956 | 0.798 | 5361 | 1.287 | 0.3552 | 0.079 |
| 0424 | 1.728 | 1.752 | 1.840 | 1.934 | 1.953 | 2.039 | 0.352 | 13523 | 1.458 | 0.2683 | 0.045 |
| 0425 | 1.783 | 1.808 | 1.898 | 1.989 | 2.007 | 2.089 | 0.404 | 11119 | 1.464 | 0.2928 | 0.048 |
| 0426 | 1.783 | 1.812 | 1.913 | 2.017 | 2.037 | 2.129 | 0.562 | 5515 | 1.229 | 0.2993 | 0.064 |
| 0427 | 1.782 | 1.817 | 1.934 | 2.049 | 2.071 | 2.171 | 0.765 | 3805 | 1.013 | 0.3137 | 0.078 |
| 0428 | 1.764 | 1.790 | 1.885 | 1.981 | 2.001 | 2.089 | 0.580 | 6594 | 1.284 | 0.3004 | 0.059 |
| 0429 | 1.780 | 1.806 | 1.900 | 1.996 | 2.015 | 2.102 | 0.514 | 7120 | 1.276 | 0.3019 | 0.055 |
| 0430 | 1.777 | 1.804 | 1.898 | 1.993 | 2.012 | 2.097 | 0.637 | 5092 | 0.997 | 0.2999 | 0.061 |
| 0431 | 1.796 | 1.822 | 1.913 | 2.005 | 2.023 | 2.106 | 0.672 | 6160 | 1.263 | 0.3069 | 0.059 |
| 0432 | 1.795 | 1.821 | 1.910 | 1.997 | 2.015 | 2.099 | 0.746 | 5357 | 1.204 | 0.3149 | 0.064 |
| 0433 | 1.774 | 1.801 | 1.897 | 1.995 | 2.014 | 2.104 | 0.544 | 6782 | 1.291 | 0.3038 | 0.058 |
| 0434 | 1.746 | 1.775 | 1.873 | 1.976 | 1.998 | 2.094 | 0.683 | 5514 | 1.255 | 0.3057 | 0.066 |
| 0435 | 1.795 | 1.821 | 1.915 | 2.010 | 2.029 | 2.113 | 0.488 | 8261 | 1.437 | 0.3020 | 0.057 |
| 0436 | 1.769 | 1.798 | 1.896 | 1.995 | 2.015 | 2.105 | 0.500 | 6983 | 1.322 | 0.3128 | 0.059 |
| 0437 | 1.763 | 1.791 | 1.889 | 1.991 | 2.010 | 2.101 | 0.436 | 7917 | 1.336 | 0.3064 | 0.056 |
| 0438 | 1.804 | 1.830 | 1.924 | 2.016 | 2.034 | 2.116 | 0.470 | 8359 | 1.370 | 0.3065 | 0.054 |
| 0439 | 1.643 | 1.673 | 1.780 | 1.898 | 1.923 | 2.041 | 0.578 | 5351 | 1.228 | 0.3026 | 0.076 |
| 0440 | 1.800 | 1.828 | 1.921 | 2.016 | 2.035 | 2.117 | 0.391 | 10119 | 1.301 | 0.2996 | 0.052 |
| 0441 | 1.800 | 1.828 | 1.925 | 2.021 | 2.039 | 2.121 | 0.353 | 8636 | 1.260 | 0.3053 | 0.053 |
| 0442 | 1.654 | 1.684 | 1.791 | 1.903 | 1.926 | 2.026 | 0.243 | 8863 | 0.803 | 0.3464 | 0.050 |
| 0443 | 1.561 | 1.590 | 1.693 | 1.807 | 1.830 | 1.949 | 0.792 | 4639 | 1.133 | 0.3869 | 0.078 |
| 0502 | 1.742 | 1.770 | 1.871 | 1.974 | 1.996 | 2.092 | 0.615 | 7186 | 1.307 | 0.2999 | 0.063 |
| 0503 | 1.751 | 1.779 | 1.878 | 1.979 | 1.999 | 2.094 | 0.547 | 6764 | 1.157 | 0.3019 | 0.057 |
| 0504 | 1.772 | 1.801 | 1.899 | 1.998 | 2.018 | 2.109 | 0.394 | 10716 | 1.303 | 0.3059 | 0.055 |
| 0505 | 1.785 | 1.814 | 1.912 | 2.012 | 2.031 | 2.119 | 0.334 | 12009 | 1.264 | 0.3085 | 0.051 |

TABLE 16

| Batch | B20 | B25 | B50 | B90 | B100 | B160 | H_{c} | | Bᵣ | P_{Hys} 1.5 T |
|---|---|---|---|---|---|---|---|---|---|---|
| 931 | T | T | T | T | T | T | A/cm | μₘₐₓ | T | Ws/kg |
| 0322 | 1.693 | 1.722 | 1.826 | 1.940 | 1.964 | 2.077 | 0.586 | 8599 | 1.373 | 0.061 |
| 0323 | 1.715 | 1.744 | 1.852 | 1.973 | 1.996 | 2.114 | 0.400 | 9047 | 1.272 | 0.062 |
| 0324 | 1.753 | 1.786 | 1.903 | 2.032 | 2.058 | 2.180 | 0.718 | 4769 | 1.126 | 0.079 |
| 0325 | 1.669 | 1.701 | 1.815 | 1.936 | 1.960 | 2.075 | 0.813 | 3928 | 0.961 | 0.082 |
| 0326 | 1.694 | 1.731 | 1.856 | 1.986 | 2.013 | 2.135 | 1.782 | 1959 | 0.886 | 0.131 |
| 0327 | 1.704 | 1.736 | 1.849 | 1.965 | 1.988 | 2.093 | 0.653 | 4605 | 1.034 | 0.075 |
| 0328 | 1.773 | 1.800 | 1.896 | 1.995 | 2.014 | 2.102 | 0.410 | 13856 | 1.488 | 0.050 |
| 0329 | 1.808 | 1.833 | 1.925 | 2.018 | 2.035 | 2.115 | 0.369 | 17227 | 1.528 | 0.046 |
| 0330 | 1.813 | 1.839 | 1.930 | 2.021 | 2.039 | 2.118 | 0.354 | 19591 | 1.514 | 0.046 |
| 0331 | 1.717 | 1.750 | 1.868 | 1.993 | 2.018 | 2.132 | 0.883 | 4899 | 1.281 | 0.079 |
| 0332 | 1.704 | 1.738 | 1.855 | 1.980 | 2.004 | 2.119 | 0.852 | 4964 | 1.267 | 0.076 |
| 0333 | 1.671 | 1.705 | 1.824 | 1.953 | 1.979 | 2.104 | 0.771 | 5067 | 1.240 | 0.073 |
| 0334 | 1.707 | 1.740 | 1.855 | 1.976 | 2.000 | 2.114 | 0.944 | 4607 | 1.187 | 0.080 |
| 0335 | 1.817 | 1.846 | 1.951 | 2.053 | 2.073 | 2.161 | 0.451 | 9277 | 1.273 | 0.064 |
| 0336 | 1.713 | 1.746 | 1.864 | 1.989 | 2.014 | 2.131 | 0.766 | 5201 | 1.271 | 0.073 |
| 0337 | 1.707 | 1.74 | 1.859 | 1.986 | 2.011 | 2.131 | 0.792 | 5153 | 1.275 | 0.074 |
| 0338 | 1.71 | 1.743 | 1.859 | 1.981 | 2.006 | 2.120 | 0.904 | 4893 | 1.239 | 0.078 |
| 0339 | 1.684 | 1.723 | 1.850 | 1.968 | 1.990 | 2.089 | 0.512 | 4711 | 0.596 | 0.052 |
| 0420 | 1.786 | 1.811 | 1.904 | 1.997 | 2.015 | 2.098 | 0.445 | 12018 | 1.506 | 0.058 |
| 0421 | 1.797 | 1.824 | 1.920 | 2.018 | 2.037 | 2.122 | 0.489 | 8162 | 1.433 | 0.066 |
| 0422 | 1.746 | 1.773 | 1.866 | 1.962 | 1.980 | 2.066 | 0.512 | 9799 | 1.423 | 0.062 |
| 0423 | 1.573 | 1.601 | 1.702 | 1.814 | 1.838 | 1.955 | 0.845 | 5155 | 1.282 | 0.092 |
| 0424 | 1.726 | 1.750 | 1.839 | 1.931 | 1.949 | 2.035 | 0.383 | 14713 | 1.504 | 0.053 |
| 0425 | 1.780 | 1.806 | 1.896 | 1.987 | 2.005 | 2.089 | 0.399 | 15271 | 1.553 | 0.053 |
| 0426 | 1.785 | 1.814 | 1.915 | 2.017 | 2.038 | 2.129 | 0.561 | 6785 | 1.415 | 0.067 |
| 0427 | 1.791 | 1.825 | 1.941 | 2.055 | 2.077 | 2.176 | 0.823 | 4271 | 1.173 | 0.083 |
| 0428 | 1.772 | 1.799 | 1.893 | 1.990 | 2.009 | 2.097 | 0.540 | 8640 | 1.450 | 0.061 |
| 0429 | 1.781 | 1.807 | 1.901 | 1.996 | 2.015 | 2.103 | 0.465 | 10832 | 1.486 | 0.056 |
| 0430 | 1.782 | 1.809 | 1.901 | 1.995 | 2.014 | 2.101 | 0.520 | 9229 | 1.463 | 0.057 |
| 0431 | 1.801 | 1.827 | 1.918 | 2.010 | 2.027 | 2.110 | 0.572 | 9119 | 1.503 | 0.060 |
| 0432 | 1.815 | 1.840 | 1.927 | 2.017 | 2.033 | 2.113 | 0.516 | 11109 | 1.491 | 0.050 |
| 0433 | 1.782 | 1.808 | 1.903 | 2.000 | 2.020 | 2.108 | 0.412 | 12767 | 1.478 | 0.050 |
| 0434 | 1.752 | 1.780 | 1.877 | 1.980 | 2.001 | 2.095 | 0.495 | 11386 | 1.467 | 0.054 |
| 0435 | 1.795 | 1.821 | 1.914 | 2.009 | 2.027 | 2.111 | 0.404 | 15751 | 1.542 | 0.049 |
| 0436 | 1.775 | 1.802 | 1.900 | 1.998 | 2.017 | 2.104 | 0.402 | 13814 | 1.480 | 0.049 |
| 0437 | 1.767 | 1.793 | 1.891 | 1.993 | 2.013 | 2.103 | 0.409 | 13273 | 1.488 | 0.053 |
| 0438 | 1.810 | 1.836 | 1.929 | 2.021 | 2.039 | 2.120 | 0.406 | 15090 | 1.547 | 0.047 |
| 0439 | 1.647 | 1.676 | 1.783 | 1.901 | 1.925 | 2.042 | 0.761 | 4766 | 1.319 | 0.087 |
| 0440 | 1.801 | 1.829 | 1.921 | 2.016 | 2.033 | 2.115 | 0.347 | 15730 | 1.499 | 0.047 |
| 0441 | 1.804 | 1.832 | 1.927 | 2.022 | 2.040 | 2.120 | 0.327 | 16232 | 1.493 | 0.048 |
| 0442 | 1.655 | 1.685 | 1.792 | 1.903 | 1.925 | 2.026 | 0.256 | 9205 | 0.784 | 0.050 |
| 0443 | 1.559 | 1.590 | 1.694 | 1.808 | 1.831 | 1.946 | 0.865 | 4148 | 1.143 | 0.097 |
| 0502 | 1.744 | 1.772 | 1.869 | 1.973 | 1.993 | 2.089 | 0.527 | 10468 | 1.423 | 0.056 |
| 0503 | 1.757 | 1.784 | 1.879 | 1.980 | 2.000 | 2.095 | 0.453 | 11708 | 1.408 | 0.050 |
| 0504 | 1.776 | 1.803 | 1.900 | 1.999 | 2.019 | 2.109 | 0.351 | 14009 | 1.396 | 0.051 |
| 0505 | 1.787 | 1.813 | 1.912 | 2.011 | 2.031 | 2.118 | 0.297 | 15480 | 1.362 | 0.047 |

| | | | | | | | | | | | P_{Hys} |
|---|---|---|---|---|---|---|---|---|---|---|---|
| | | B20 | B25 | B50 | B90 | B100 | B160 | H_{c} | | Bᵣ | 1.5 T |
| Batch 93/ | Annealing | T | T | T | T | T | T | A/cm | μₘₐₓ | T | Ws/kg |
| 0322 | 4 h 1000° C. | 1.724 | 1.754 | 1.859 | 1.969 | 1.991 | 2.097 | 0.768 | 4338 | 1.069 | 0.079 |
| | +10 h 880° C. | 1.729 | 1.759 | 1.862 | 1.972 | 1.995 | 2.102 | 0.737 | 5449 | 1.261 | 0.074 |
| 0323 | 4 h 1000° C. | 1.719 | 1.750 | 1.858 | 1.976 | 2.000 | 2.116 | 0.486 | 5242 | 0.913 | 0.079 |
| | +10 h 880° C. | 1.721 | 1.750 | 1.858 | 1.978 | 2.002 | 2.118 | 0.483 | 5573 | 0.968 | 0.075 |
| 0325 | 4 h 1000° C. | 1.684 | 1.716 | 1.824 | 1.938 | 1.962 | 2.073 | 0.999 | 3559 | 0.940 | 0.083 |
| | +10 h 850° C. | 1.687 | 1.716 | 1.823 | 1.939 | 1.963 | 2.075 | 0.903 | 4733 | 1.224 | 0.077 |
| 0326 | 4 h 1000° C. | 1.711 | 1.749 | 1.873 | 1.996 | 2.021 | 2.137 | 1.485 | 2412 | 0.911 | 0.110 |
| | +10 h 850° C. | 1.710 | 1.745 | 1.866 | 1.992 | 2.018 | 2.137 | 1.478 | 2945 | 1.010 | 0.102 |
| 0327 | 4 h 1000° C. | 1.688 | 1.719 | 1.827 | 1.941 | 1.964 | 2.072 | 0.830 | 4123 | 0.992 | 0.076 |
| | +10 h 850° C. | 1.689 | 1.720 | 1.828 | 1.942 | 1.965 | 2.073 | 0.890 | 4324 | 1.130 | 0.080 |
| 0328 | 4 h 1000° C. | 1.768 | 1.795 | 1.892 | 1.991 | 2.011 | 2.101 | 0.655 | 5130 | 1.160 | 0.068 |
| | +10 h 880° C. | 1.772 | 1.799 | 1.896 | 1.995 | 2.014 | 2.104 | 0.637 | 6179 | 1.368 | 0.067 |
| 0331 | 4 h 1000° C. | 1.716 | 1.753 | 1.873 | 1.995 | 2.019 | 2.132 | 1.053 | 3037 | 0.942 | 0.090 |
| | +10 h 880° C. | 1.717 | 1.752 | 1.870 | 1.992 | 2.016 | 2.130 | 1.192 | 3336 | 1.065 | 0.093 |
| 0332 | 4 h 1000° C. | 1.706 | 1.741 | 1.862 | 1.986 | 2.011 | 2.124 | 0.994 | 3212 | 0.950 | 0.088 |
| | +10 h 880° C. | 1.709 | 1.745 | 1.865 | 1.988 | 2.013 | 2.128 | 1.079 | 3460 | 1.153 | 0.095 |
| 0333 | 4 h 1000° C. | 1.691 | 1.726 | 1.843 | 1.964 | 1.989 | 2.105 | 1.147 | 3036 | 0.944 | 0.090 |
| | +10 h 880° C. | 1.683 | 1.718 | 1.837 | 1.961 | 1.986 | 2.107 | 1.089 | 3858 | 0.972 | 0.081 |
| 0334 | 4 h 1000° C. | 1.707 | 1.742 | 1.860 | 1.979 | 2.003 | 2.115 | 1.144 | 3075 | 0.928 | 0.090 |
| | +10 h 880° C. | 1.706 | 1.742 | 1.859 | 1.978 | 2.001 | 2.114 | 1.100 | 3581 | 1000 | 0.089 |
| 0336 | 4 h 1000° C. | 1.732 | 1.766 | 1.883 | 2.001 | 2.024 | 2.133 | 1.035 | 3128 | 0.893 | 0.085 |
| | +10 h 880° C. | 1.736 | 1.770 | 1.885 | 2.003 | 2.027 | 2.137 | 1.092 | 3634 | 1.125 | 0.088 |
| 0337 | 4 h 1000° C. | 1.707 | 1.741 | 1.861 | 1.985 | 2.010 | 2.127 | 1.027 | 3190 | 0.943 | 0.089 |
| | +10 h 880° C. | 1.704 | 1.738 | 1.857 | 1.982 | 2.007 | 2.123 | 1.095 | 3449 | 1.108 | 0.095 |
| 0338 | 4 h 1000° C. | 1.712 | 1.749 | 1.866 | 1.986 | 2.010 | 2.122 | 1.161 | 2888 | 0.919 | 0.092 |
| | +10 h 880° C. | 1.713 | 1.748 | 1.864 | 1.986 | 2.010 | 2.125 | 1.260 | 3421 | 1.057 | 0.094 |
| 0339 | 4 h 1100° C. | 1.686 | 1.722 | 1.841 | 1.961 | 1.983 | 2.085 | 0.587 | 5345 | 0.897 | 0.059 |
| | +10 h 910° C. | 1.687 | 1.723 | 1.843 | 1.963 | 1.986 | 2.087 | 0.507 | 6186 | 0.952 | 0.058 |
| | +4 h 1000° C. | 1.692 | 1.726 | 1.841 | 1.960 | 1.983 | 2.086 | 0.438 | 6989 | 0.984 | 0.061 |
| 0420 | 4 h 1050° C. | 1.788 | 1.813 | 1.905 | 1.998 | 2.018 | 2.101 | 0.420 | 11185 | 1.479 | — |
| | +10 h 910° C. | 1.789 | 1.816 | 1.907 | 2.000 | 2.017 | 2.098 | 0.444 | 11842 | 1.514 | 0.058 |
| | +10 h 950° C. | 1.794 | 1.820 | 1.912 | 2.004 | 2.023 | 2.102 | 0.433 | 14222 | 1.540 | 0.056 |
| 0421 | 4 h 1050° C. | 1.795 | 1.822 | 1.919 | 2.017 | 2.037 | 2.124 | 0.459 | 7856 | 1.387 | 0.058 |
| | +10 h 910° C. | 1.797 | 1.824 | 1.920 | 2.018 | 2.037 | 2.122 | 0.489 | 8162 | 1.433 | — |
| | +10 h 940° C. | 1.798 | 1.825 | 1.921 | 2.018 | 2.037 | 2.121 | 0.467 | 11468 | 1.519 | 0.061 |
| 0422 | 4 h 1100° C. | 1.733 | 1.760 | 1.856 | 1.955 | 1.974 | 2.063 | 0.432 | 11411 | 1.408 | 0.053 |
| | +10 h 960° C. | 1.736 | 1.764 | 1.859 | 1.958 | 1.978 | 2.068 | 0.382 | 14880 | 1.448 | 0.048 |
| 0423 | 4 h 1100° C. | 1.635 | 1.662 | 1.760 | 1.867 | 1.888 | 1.993 | 0.653 | 6647 | 1.280 | 0.065 |
| | +10 h 950° C. | 1.634 | 1.661 | 1.760 | 1.868 | 1.891 | 1.998 | 0.621 | 7626 | 1.296 | 0.064 |
| 0424 | 4 h 1050° C. | 1.728 | 1.752 | 1.840 | 1.934 | 1.953 | 2.039 | 0.352 | 13523 | 1.458 | 0.045 |
| | +10 h 910° C. | 1.726 | 1.750 | 1.839 | 1.931 | 1.949 | 2.035 | 0.383 | 14713 | 1.504 | — |
| | +10 h 940° C. | 1.716 | 1.743 | 1.836 | 1.930 | 1.948 | 2.033 | 0.329 | 12908 | 1.217 | 0.055 |
| 0425 | 4 h 1050° C. | 1.783 | 1.808 | 1.898 | 1.989 | 2.007 | 2.089 | 0.404 | 11119 | 1.464 | 0.048 |
| | +10 h 910° C. | 1.780 | 1.806 | 1.896 | 1.987 | 2.005 | 2.089 | 0.399 | 15271 | 1.553 | — |
| | +10 h 925° C. | 1.781 | 1.807 | 1.897 | 1.988 | 2.006 | 2.088 | 0.361 | 18225 | 1.559 | 0.047 |

TABLE 17

| | | | | | | | | | | | |
|---|---|---|---|---|---|---|---|---|---|---|---|
| 0432 | 4 h 1000° C. | 1.797 | 1.824 | 1.915 | 2.009 | 2.027 | 2.112 | 0.640 | 6876 | 1.329 | 0.059 |
| | +10 h 900° C. | 1.799 | 1.826 | 1.917 | 2.010 | 2.028 | 2.113 | 0.541 | 10118 | 1.509 | 0.058 |
| 0434 | 4 h 1000° C. | 1.739 | 1.767 | 1.868 | 1.973 | 1.995 | 2.094 | 0.675 | 5583 | 1.235 | 0.067 |
| | +10 h 900° C. | 1.737 | 1.765 | 1.865 | 1.971 | 1.992 | 2.092 | 0.617 | 7890 | 1.420 | 0.064 |
| 0443 | 60 h 980° C. | 1.564 | 1.595 | 1.701 | 1.813 | 1.836 | 1.949 | 1.022 | 3991 | 1.245 | 0.108 |

TABLE 18

| | | | | | | | | | | | P_{Hys} |
|---|---|---|---|---|---|---|---|---|---|---|---|
| Batch | | B20 | B25 | B50 | B90 | B100 | B160 | H_{c} | | Bᵣ | 1.5 T |
| 93/ | Annealing | T | T | T | T | T | T | A/cm | μₘₐₓ | T | Ws/kg |
| 0423 | 4 h 1050° C. | 1.577 | 1.604 | 1.703 | 1.815 | 1.838 | 1.956 | 0.798 | 5361 | 1.287 | 0.079 |
| | +10 h 910° C. | 1.573 | 1.601 | 1.702 | 1.814 | 1.838 | 1.955 | 0.845 | 5155 | 1.282 | 0.092 |
| 0423 | 4 h 1100° C. | 1.635 | 1.662 | 1.760 | 1.867 | 1.888 | 1.993 | 0.653 | 6647 | 1.280 | 0.065 |
| | +10 h 950° C. | 1.634 | 1.661 | 1.760 | 1.868 | 1.891 | 1.998 | 0.621 | 7626 | 1.296 | 0.064 |
| 0423 | 4 h 1100° C. | 1.639 | 1.666 | 1.764 | 1.871 | 1.893 | 1.998 | 0.630 | 6814 | 1.278 | 0.065 |
| | +4 h 910° C. | 1.636 | 1.664 | 1.762 | 1.869 | 1.890 | 1.996 | 0.715 | 6508 | 1.241 | 0.071 |
| | +4 h 950° C. | 1.635 | 1.662 | 1.761 | 1.870 | 1.892 | 1.998 | 0.616 | 7820 | 1.321 | 0.065 |
| | +4 h 1030° C. | 1.635 | 1.662 | 1.762 | 1.870 | 1.892 | 1.999 | 0.874 | 5103 | 1.303 | 0.076 |
| 0423 | 4 h 910° C. | 1.597 | 1.625 | 1.723 | 1.831 | 1.853 | 1.964 | 0.777 | 4524 | 0.974 | 0.077 |
| 0423 | 20 h 910° C. | 1.588 | 1.616 | 1.716 | 1.825 | 1.847 | 1.962 | 0.744 | 4412 | 1.016 | 0.074 |
| 0423 | 4 h 950° C. | 1.576 | 1.604 | 1.703 | 1.816 | 1.839 | 1.959 | 0.593 | 4901 | 1.117 | 0.071 |
| 0423 | 20 h 950° C. | 1.579 | 1.607 | 1.705 | 1.814 | 1.837 | 1.952 | 0.608 | 4782 | 1.193 | 0.080 |

TABLE 19

| | | | | | | | | | | P_{Hys} |
|---|---|---|---|---|---|---|---|---|---|---|
| Batch | B20 | B25 | B50 | B90 | B100 | B160 | H_{c} | | Bᵣ | 1.5 T |
| 93/ | T | T | T | T | T | T | A/cm | μₘₐₓ | T | Ws/kg |
| 0325 | 1.691 | 1.721 | 1.829 | 1.945 | 1.968 | 2.079 | 0.804 | 4377 | 1.139 | 0.079 |
| 0328 | 1.77 | 1.798 | 1.898 | 1.999 | 2.019 | 2.108 | 0.530 | 6309 | 1.283 | 0.060 |
| 0330 | 1.812 | 1.839 | 1.932 | 2.025 | 2.043 | 2.122 | 0.305 | 14015 | 1.518 | 0.043 |

TABLE 20

| | | | | | | | | | | P_{Hys} |
|---|---|---|---|---|---|---|---|---|---|---|
| Batch | B20 | B25 | B50 | B90 | B100 | B160 | H_{c} | | Bᵣ | 1.5 T |
| 93/ | T | T | T | T | T | T | A/cm | μₘₐₓ | T | Ws/kg |
| 0325 | 1.679 | 1.71 | 1.822 | 1.941 | 1.966 | 2.078 | 0.657 | 4347 | 1.054 | 0.078 |
| 0328 | 1.773 | 1.801 | 1.899 | 1.999 | 2.019 | 2.108 | 0.369 | 9970 | 1.417 | 0.050 |
| 0330 | 1.813 | 1.84 | 1.933 | 2.025 | 2.043 | 2.121 | 0.296 | 19653 | 1.505 | 0.045 |

TABLE 21

| | | | | | | | | | | | P_{Hys} |
|---|---|---|---|---|---|---|---|---|---|---|---|
| Batch | B20 | B25 | B50 | B90 | B100 | B160 | H_{c} | | Bᵣ | Rho in | 1.5 T |
| 93/ | T | T | T | T | T | T | A/cm | μₘₐₓ | T | μΩm | Ws/kg |
| 0322 | 1.674 | 1.705 | 1.813 | 1.929 | 1.953 | 2.069 | 0.694 | 4737 | 1.067 | 0.3155 | 0.071 |
| 0323 | 1.681 | 1.711 | 1.820 | 1.945 | 1.971 | 2.095 | 0.473 | 6562 | 1.154 | 0.1891 | 0.065 |
| 0324 | 1.747 | 1.781 | 1.903 | 2.034 | 2.061 | 2.185 | 0.655 | 4720 | 1.025 | 0.1572 | 0.078 |
| 0325 | 1.652 | 1.684 | 1.797 | 1.917 | 1.941 | 2.061 | 0.845 | 3729 | 0.878 | 0.3393 | 0.081 |
| 0326 | 1.685 | 1.724 | 1.852 | 1.984 | 2.012 | 2.136 | 1.283 | 2410 | 0.895 | 0.3731 | 0.108 |
| 0327 | 1.649 | 1.680 | 1.793 | 1.917 | 1.942 | 2.061 | 0.712 | 4155 | 0.909 | 0.3274 | 0.077 |
| 0328 | 1.726 | 1.754 | 1.854 | 1.958 | 1.980 | 2.077 | 0.685 | 4958 | 1.097 | 0.3171 | 0.069 |
| 0329 | 1.797 | 1.824 | 1.918 | 2.012 | 2.031 | 2.114 | 0.524 | 7497 | 1.347 | 0.3019 | 0.053 |
| 0330 | 1.786 | 1.814 | 1.910 | 2.009 | 2.028 | 2.117 | 0.382 | 10051 | 1.414 | 0.2904 | 0.051 |
| 0331 | 1.689 | 1.724 | 1.847 | 1.975 | 2.002 | 2.123 | 0.935 | 3003 | 0.884 | 0.3356 | 0.088 |
| 0332 | 1.679 | 1.715 | 1.838 | 1.968 | 1.995 | 2.115 | 0.907 | 3034 | 0.863 | 0.3624 | 0.089 |
| 0333 | 1.664 | 1.699 | 1.821 | 1.951 | 1.978 | 2.103 | 0.828 | 3402 | 0.869 | 0.3557 | 0.085 |
| 0334 | 1.718 | 1.754 | 1.872 | 1.992 | 2.016 | 2.126 | 0.979 | 2986 | 0.826 | 0.3533 | 0.083 |
| 0335 | 1.811 | 1.843 | 1.948 | 2.051 | 2.071 | 2.158 | 0.479 | 5484 | 1.141 | 0.2922 | 0.066 |
| 0336 | 1.687 | 1.723 | 1.845 | 1.972 | 1.998 | 2.117 | 0.877 | 3184 | 0.843 | 0.3372 | 0.086 |
| 0337 | 1.679 | 1.715 | 1.839 | 1.970 | 1.996 | 2.120 | 0.865 | 3245 | 0.882 | 0.3346 | 0.087 |
| 0338 | 1.703 | 1.739 | 1.858 | 1.979 | 2.004 | 2.119 | 0.999 | 2916 | 0.865 | 0.3356 | 0.088 |
| 0339 | 1.686 | 1.722 | 1.841 | 1.961 | 1.983 | 2.085 | 0.587 | 5345 | 0.897 | 0.3027 | 0.059 |
| 0422 | 1.733 | 1.760 | 1.856 | 1.955 | 1.974 | 2.063 | 0.432 | 11411 | 1.408 | — | 0.053 |
| 0423 | 1.635 | 1.662 | 1.760 | 1.867 | 1.888 | 1.993 | 0.653 | 6647 | 1.280 | — | 0.065 |

TABLE 22

| | | | | | | | | | | P_{Hys} |
|---|---|---|---|---|---|---|---|---|---|---|
| Batch | B20 | B25 | B50 | B90 | B100 | B160 | H_{c} | | Bᵣ | 1.5 T |
| 93/ | T | T | T | T | T | T | A/cm | μₘₐₓ | T | Ws/kg |
| 0322 | 1.674 | 1.702 | 1.808 | 1.926 | 1.950 | 2.069 | 0.471 | 7929 | 1.376 | 0.056 |
| 0323 | 1.684 | 1.714 | 1.823 | 1.946 | 1.971 | 2.096 | 0.383 | 8883 | 1.353 | 0.058 |
| 0324 | 1.750 | 1.783 | 1.903 | 2.034 | 2.060 | 2.184 | 0.695 | 4542 | 1.113 | 0.080 |
| 0325 | 1.649 | 1.681 | 1.796 | 1.921 | 1.946 | 2.066 | 0.783 | 3975 | 0.968 | 0.085 |
| 0326 | 1.690 | 1.728 | 1.854 | 1.986 | 2.012 | 2.137 | 1.644 | 1987 | 0.915 | 0.131 |
| 0327 | 1.667 | 1.699 | 1.813 | 1.936 | 1.961 | 2.075 | 0.616 | 4476 | 0.992 | 0.080 |
| 0328 | 1.730 | 1.757 | 1.856 | 1.962 | 1.982 | 2.080 | 0.489 | 8729 | 1.393 | 0.054 |
| 0329 | 1.805 | 1.831 | 1.923 | 2.016 | 2.034 | 2.116 | 0.396 | 12084 | 1.520 | 0.047 |
| 0330 | 1.787 | 1.814 | 1.908 | 2.006 | 2.025 | 2.113 | 0.378 | 9892 | 1.457 | 0.054 |
| 0331 | 1.693 | 1.726 | 1.846 | 1.974 | 2.001 | 2.123 | 0.854 | 4279 | 1.237 | 0.080 |
| 0332 | 1.679 | 1.714 | 1.834 | 1.964 | 1.990 | 2.113 | 0.817 | 4486 | 1.233 | 0.080 |
| 0333 | 1.664 | 1.698 | 1.817 | 1.949 | 1.977 | 2.104 | 0.656 | 5334 | 1.274 | 0.071 |
| 0334 | 1.722 | 1.755 | 1.869 | 1.987 | 2.011 | 2.121 | 0.851 | 4767 | 1.253 | 0.078 |
| 0335 | 1.815 | 1.845 | 1.948 | 2.051 | 2.070 | 2.158 | 0.457 | 5600 | 1.258 | 0.064 |
| 0336 | 1.696 | 1.729 | 1.849 | 1.977 | 2.002 | 2.125 | 0.747 | 4965 | 1.228 | 0.075 |
| 0337 | 1.685 | 1.719 | 1.841 | 1.972 | 1.999 | 2.123 | 0.738 | 4623 | 1.226 | 0.078 |
| 0338 | 1.712 | 1.745 | 1.861 | 1.983 | 2.008 | 2.125 | 0.897 | 4543 | 1.246 | 0.081 |
| 0339 | 1.687 | 1.723 | 1.843 | 1.963 | 1.986 | 2.087 | 0.507 | 6186 | 0.952 | 0.058 |

TABLE 23

| | | | | | | | | | | | P_{Hys} |
|---|---|---|---|---|---|---|---|---|---|---|---|
| Batch | B20 | B25 | B50 | B90 | B100 | B160 | H_{c} | | Bᵣ | Rho in | 1.5 T |
| 93/ | T | T | T | T | T | T | A/cm | μₘₐₓ | T | μΩm | Ws/kg |
| 0323 | 1.678 | 1.708 | 1.818 | 1.943 | 1.97 | 2.095 | 0.397 | 6506 | 1.087 | 0.1929 | 0.069 |
| 0328 | 1.692 | 1.721 | 1.823 | 1.933 | 1.956 | 2.063 | 0.683 | 4863 | 1.088 | 0.3146 | 0.070 |
| 0329 | 1.778 | 1.806 | 1.902 | 1.999 | 2.018 | 2.106 | 0.473 | 7860 | 1.346 | 0.3022 | 0.053 |
| 0330 | 1.756 | 1.784 | 1.882 | 1.985 | 2.005 | 2.096 | 0.362 | 10568 | 1.438 | 0.2927 | 0.048 |
| 0334 | 1.683 | 1.719 | 1.84 | 1.967 | 1.992 | 2.113 | 0.856 | 3306 | 0.874 | 0.3474 | 0.083 |
| 0335 | 1.748 | 1.780 | 1.893 | 2.008 | 2.031 | 2.137 | 0.486 | 5009 | 1.119 | 0.2891 | 0.067 |
| 0339 | 1.599 | 1.641 | 1.776 | 1.910 | 1.938 | 2.062 | 0.489 | 4985 | 0.770 | — | 0.066 |
| 0442 | 1.612 | 1.654 | 1.780 | 1.897 | 1.919 | 2.022 | 0.412 | 5510 | 0.606 | — | 0.057 |

TABLE 24

| | | | | | | | | | | P_{Hys} |
|---|---|---|---|---|---|---|---|---|---|---|
| Batch | B20 | B25 | B50 | B90 | B100 | B160 | H_{c} | | Bᵣ | 1.5 T |
| 93/ | T | T | T | T | T | T | A/cm | μₘₐₓ | T | Ws/kg |
| 0323 | 1.672 | 1.701 | 1.811 | 1.937 | 1.964 | 2.089 | 0.348 | 8185 | 1.297 | 0.064 |
| 0328 | 1.693 | 1.721 | 1.823 | 1.934 | 1.957 | 2.063 | 0.511 | 8157 | 1.37 | 0.057 |
| 0329 | 1.778 | 1.804 | 1.9 | 1.998 | 2.017 | 2.105 | 0.383 | 11748 | 1.475 | 0.048 |
| 0330 | 1.759 | 1.786 | 1.883 | 1.983 | 2.004 | 2.093 | 0.344 | 14191 | 1.46 | 0.049 |
| 0334 | 1.684 | 1.717 | 1.837 | 1.966 | 1.992 | 2.113 | 0.753 | 4701 | 1.202 | 0.076 |
| 0335 | 1.749 | 1.781 | 1.892 | 2.008 | 2.031 | 2.136 | 0.457 | 5275 | 1.174 | 0.070 |

TABLE 25

| | | | Av. atomic | Density | |
|---|---|---|---|---|---|
| | | | weight of | using the | |
| Batch | μₘₐₓ | | main | rule of | |
| 93/ | (g/cm³) | Density | elements | three | Δρ (%) |
| 323 | 9.047 | 7.942 | 56.371 | 7.942 | 0.00% |
| 325 | 4.722 | 7.923 | 56.296 | 7.931 | −0.11% |
| 327 | 4.605 | 7.918 | 56.292 | 7.931 | −0.17% |
| 328 | 13.859 | 7.917 | 56.286 | 7.930 | −0.16% |
| 329 | 15.658 | 7.912 | 56.283 | 7.930 | −0.22% |
| 330 | 22.271 | 7.909 | 56.281 | 7.929 | −0.26% |
| 420 | 20.281 | 7.905 | 56.262 | 7.927 | −0.27% |
| 422 | 11.411 | 7.894 | 56.224 | 7.921 | −0.34% |
| 423 | 7.626 | 7.882 | 56.202 | 7.918 | −0.46% |
| 428 | 8.640 | 7.911 | 56.279 | 7.929 | −0.23% |
| 429 | 10.832 | 7.911 | 56.279 | 7.929 | −0.23% |
| 430 | 9.229 | 7.914 | 56.280 | 7.929 | −0.19% |
| 431 | 9.119 | 7.910 | 56.278 | 7.929 | −0.24% |
| 432 | 11.109 | 7.910 | 56.277 | 7.929 | −0.24% |
| 433 | 12.767 | 7.911 | 56.284 | 7.930 | −0.23% |
| 434 | 11.386 | 7.913 | 56.290 | 7.931 | −0.22% |
| 435 | 15.751 | 7.912 | 56.304 | 7.933 | −0.26% |
| 436 | 13.814 | 7.921 | 56.403 | 7.947 | −0.32% |
| 437 | 13.273 | 7.908 | 56.266 | 7.927 | −0.24% |
| 438 | 15.090 | 7.917 | 56.380 | 7.943 | −0.32% |
| 440 | 15.730 | 7.910 | 56.274 | 7.928 | −0.24% |
| 441 | 16.232 | 7.913 | 56.283 | 7.930 | −0.21% |
| 76/4988 | 12.150 | 7.899 | 56.249 | 7.925 | −0.33% |
| 0502 | 11.770 | 7.909 | 56.277 | 7.929 | −0.25% |
| 0503 | 11.708 | 7.910 | 56.276 | 7.929 | −0.24% |
| 0504 | 21.461 | 7.898 | 56.232 | 7.922 | −0.31% |
| 0505 | 25.320 | 7.894 | 56.192 | 7.917 | −0.29% |

TABLE 26

| | | | | | | | | | | | P_{Hys} |
|---|---|---|---|---|---|---|---|---|---|---|---|
| Batch | | B20 | B25 | B50 | B90 | B100 | B160 | H_{c} | | Bᵣ in | 1.5 T |
| 93/ | Annealing | T | T | T | T | T | T | A/cm | μₘₐₓ | T | Ws/kg |
| 0329 | 4 h 1050° C. + | 1.808 | 1.833 | 1.925 | 2.018 | 2.035 | 2.115 | 0.369 | 17227 | 1.528 | 0.046 |
| | 10 h 910° C. | | | | | | | | | | |
| 0330 | 4 h 1050° C. + | 1.813 | 1.839 | 1.930 | 2.021 | 2.039 | 2.118 | 0.354 | 19591 | 1.514 | 0.046 |
| | 10 h 910° C. | | | | | | | | | | |
| 0330 | 4 h 1050° C. | 1.815 | 1.840 | 1.934 | 2.027 | 2.045 | 2.122 | 0.305 | 22271 | 1.514 | 0.045 |
| | Cooling + | | | | | | | | | | |
| | 10 h, 910° C. | | | | | | | | | | |
| 0420 | 4 h 1000° C. + | 1.798 | 1.824 | 1.914 | 2.006 | 2.024 | 2.104 | 0.347 | 20281 | 1.548 | 0.042 |
| | 60 h 950° C. | | | | | | | | | | |
| 0420 | 4 h 1050° C. | 1.767 | 1.793 | 1.889 | 1.988 | 2.007 | 2.094 | 0.378 | 14388 | 1.456 | 0.049 |
| | Cooling | | | | | | | | | | |
| | 150° C/h | | | | | | | | | | |
| 0505 | 4 h 1050° C. | 1.809 | 1.837 | 1.935 | 2.031 | 2.049 | 2.129 | 0.279 | 13981 | 1.290 | 0.046 |
| | Cooling | | | | | | | | | | |
| | 150° C/h | | | | | | | | | | |
| 0505 | 4 h 1050° C. + | 1.787 | 1.813 | 1.912 | 2.011 | 2.031 | 2.118 | 0.297 | 15480 | 1.362 | 0.047 |
| | 10 h 910° C. | | | | | | | | | | |
| 0505 | 4 h 1050° C. + | 1. 790 | 1.817 | 1.914 | 2.012 | 2.032 | 2.117 | 0.244 | 25320 | 1.524 | 0.043 |
| | 10 h 910° C. + | | | | | | | | | | |
| | 10 h 930° C. + | | | | | | | | | | |
| | 10 h 940° C. | | | | | | | | | | |
| 504 | 4 h 1050° C. | 1.772 | 1.801 | 1.899 | 1.998 | 2.018 | 2.109 | 0.394 | 10716 | 1.303 | 0.055 |
| | Cooling | | | | | | | | | | |
| | 150° C/h | | | | | | | | | | |
| 504 | 4 h 1050° C. + | 1.776 | 1.803 | 1.900 | 1.999 | 2.019 | 2.109 | 0.351 | 14009 | 1.396 | 0.051 |
| | 10 h 910° C. | | | | | | | | | | |
| 504 | 4 h 1050° C. + | 1.774 | 1.800 | 1.894 | 1.993 | 2.011 | 2.098 | 0.294 | 21461 | 1.52 | 0.046 |
| | 10 h 910° C. + | | | | | | | | | | |
| | 10 h 930° C. + | | | | | | | | | | |
| | 10 h 940° C. | | | | | | | | | | |

TABLE 27

| | | C in | S in |
|---|---|---|---|
| Batch | Annealing | ppmw | ppmw |
| 93/0435 | Unannealed | 32 | 36 |
| | 4h 1050° C., H₂ + | 15 | 12 |
| | 10h 910° C., H₂ | | |
| | (two annealing processes) | | |
| 93/0440 | Unannealed | 30 | 13 |
| | 4h 1050° C., | 14 | 6 |
| | 10h 910° C., H₂ | | |
| | (one annealing process) | | |
| 93/0505 | unannealed | 30 | 8 |
| | 4h 1050° C., H₂ | 12 | 4 |
| | (one annealing process) | | |
| | 4h 1050° C., H₂ + | 16 | 4 |
| | 10h 910° C., H₂ | | |
| | (two annealing processes) | | |
| 76/4998 | Unannealed | 20 | 48 |
| | 4h 1050° C., H₂, | 21 | 23 |
| | 10h 910° C., H₂ | | |
| | (one annealing process) | | |
| 76/5180 | unannealed | 26 | 60 |
| | 4h 1050° C., H₂ | 17 | 40 |
| | (one annealing process) | | |
| | 4h 1050° C., H₂ + | 15 | 36 |
| | 10h 930° C., H₂ | | |
| | (two annealing processes) | | |
| 76/5180 | Unannealed | 26 | 60 |
| | 6h 1050° C., H₂ | 17 | 31 |
| | (one annealing process) | | |
| | 6h 1050° C., H₂ + | 17 | 28 |
| | 10h 930° C., _{H2} | | |
| | (two annealing processes) | | |

TABLE 28

| | | | | | | | | | | Hc | | P_{Hyst.} at |
|---|---|---|---|---|---|---|---|---|---|---|---|---|
| | | Dims. | final | B20 | B25 | B50 | B90 | B100 | B160 | Rings in | | 1.5 T in |
| batch | sample | (mm) | annealing | in T | in T | in T | in T | in T | in T | A/cm | μₘₐₓ | Ws/kg |
| | from hot rolling thickness of 1.9 mm | | | | | | | | | | | |
| 7604988A | without int. anneal | 0.35 | 4 h, 1050° C. | 1.704 | 1.734 | 1.836 | 1.946 | 1.968 | 2.069 | 0.428 | 10836 | 0.054 |
| 7604988A | without int. anneal | 0.35 | 4 h, 1050° C. + | 1.702 | 1.732 | 1.834 | 1.944 | 1.965 | 2.068 | 0.429 | 11635 | 0.053 |
| | | | 10 h, 910° C. | | | | | | | | | |
| 7604988A | without int. anneal | 0.20 | 4 h, 1050° C. | 1.723 | 1.753 | 1.857 | 1.964 | 1.985 | 2.080 | 0.423 | 10555 | 0.054 |
| 7604988A | without int. anneal | 0.20 | 4 h, 1050° C. + | 1.724 | 1.753 | 1.860 | 1.969 | 1.989 | 2.086 | 0.458 | 10478 | 0.054 |
| | | | 10 h, 910° C. | | | | | | | | | |
| 7604988A | with int. anneal 1 h | 0.20 | 4 h, 1050° C. | 1.736 | 1.764 | 1.868 | 1.972 | 1.993 | 2.086 | 0.417 | 11196 | 0.053 |
| | 750° C. | | | | | | | | | | | |
| 7604988A | with int. anneal 1 h | 0.20 | 4 h, 1050° C. + | 1.738 | 1.766 | 1.868 | 1.973 | 1.994 | 2.088 | 0.421 | 12467 | 0.052 |
| | 750° C. | | 10 h, 910° C. | | | | | | | | | |
| 7604988A | with int. anneal 1 h | 0.20 | 4 h, 1050° C. | 1.740 | 1.769 | 1.872 | 1.976 | 1.996 | 2.088 | 0.437 | 10452 | 0.054 |
| | 1050° C. | | | | | | | | | | | |
| 7604988A | with int. anneal 1 h | 0.20 | 4 h, 1050° C. + | 1.740 | 1.769 | 1.872 | 1.977 | 1.998 | 2.092 | 0.458 | 10668 | 0.054 |
| | 1050° C. | | 10 h, 910° C. | | | | | | | | | |
| | from hot rolling thickness of 2.6 mm | | | | | | | | | | | |
| 7604988B | without int. anneal | 0.35 | 4 h, 1050° C. | 1.707 | 1.735 | 1.838 | 1.945 | 1.968 | 2.067 | 0.394 | 11778 | 0.052 |
| 7604988B | without int. anneal | 0.35 | 4 h, 1050° C. + | 1.709 | 1.737 | 1.839 | 1.948 | 1.970 | 2.072 | 0.406 | 12741 | 0.052 |
| | | | 10 h, 910° C. | | | | | | | | | |
| 7604988B | without int. anneal | 0.20 | 4 h, 1050° C. | 1.736 | 1.766 | 1.869 | 1.974 | 1.994 | 2.087 | 0.416 | 10529 | 0.053 |
| 7604988B | without int. anneal | 0.20 | 4 h, 1050° C. + | 1.734 | 1.763 | 1.867 | 1.974 | 1.994 | 2.089 | 0.441 | 11174 | 0.052 |
| | | | 10 h, 910° C. | | | | | | | | | |
| 7604988B | with int. anneal 1 h | 0.20 | 4 h, 1050° C. | 1.762 | 1.790 | 1.888 | 1.989 | 2.009 | 2.096 | 0.383 | 12943 | 0.050 |
| | 750° C. | | | | | | | | | | | |
| 7604988B | with int. anneal 1 h | 0.20 | 4 h, 1050° C. + | 1.762 | 1.790 | 1.890 | 1.991 | 2.011 | 2.100 | 0.390 | 14125 | 0.049 |
| | 750° C. | | 10 h, 910° C. | | | | | | | | | |
| 7604988B | with int. anneal 1 h | 0.20 | 4 h, 1050° C. | 1.753 | 1.783 | 1.883 | 1.985 | 2.005 | 2.094 | 0.395 | 12036 | 0.052 |
| | 1050° C. | | | | | | | | | | | |
| 7604988B | with int. anneal 1 h | 0.20 | 4 h, 1050° C. + | 1.758 | 1.786 | 1.886 | 1.989 | 2.009 | 2.098 | 0.399 | 13094 | 0.049 |
| | 1050° C. | | 10 h, 910° C. | | | | | | | | | |
| | from slab section hot and cold rolled in the pilot plant | | | | | | | | | | | |
| 7604988A | without int. anneal | 0.35 | 10 h 1050° C. | 1.728 | 1.757 | 1.858 | 1.963 | 1.984 | 2.078 | 0.299 | 18717 | 0.043 |
| | | | Abk. 50° C./h; | | | | | | | | | |
| | | | 10 h 930° C. OK | | | | | | | | | |
| 7604988A | without int. Anneal | 0.35 | 4 h, 1050° C. | 1.732 | 1.761 | 1.860 | 1.965 | 1.985 | 2.077 | 0.485 | 8633 | 0.050 |
| | | | Abk. 10° C/h | | | | | | | | | |
| 7604988A | without int. anneal | 0.35 | 100 h, 910° C. | 1.584 | 1.612 | 1.711 | 1.824 | 1.849 | 1.972 | 0.578 | 5190 | 0.068 |
| 7604988A | without int. anneal | 0.35 | 4 h, 1050° C. | 1.734 | 1.763 | 1.861 | 1.965 | 1.985 | 2.079 | 0.410 | 9315 | 0.050 |
| 7604988A | without int. anneal | 0.35 | 10 h 1050° C. | 1.725 | 1.754 | 1.855 | 1.961 | 1.982 | 2.077 | 0.311 | 12150 | 0.043 |
| | | | Abk. 50° C/h; | | | | | | | | | |
| | | | 10 h 930° C. OK | | | | | | | | | |
| 7604988A | without int. anneal | 0.35 | 2 h 1050° C.; | 1.735 | 1.765 | 1.867 | 1.972 | 1.993 | 2.090 | 0.422 | 9001 | 0.050 |
| | | | 4 h 910° C. | | | | | | | | | |
| 7605180A | head | 0.35 | 4 h, 1050° C. | 1.760 | 1.787 | 1.888 | 1.990 | 2.010 | 2.101 | 0.388 | 9138 | 0.053 |
| 7605180A | head | 0.35 | 4 h 1050° C. + | 1.759 | 1.786 | 1.886 | 1.986 | 2.006 | 2.097 | 0.368 | 14130 | 0.050 |
| | | | 10 h 930° C. | | | | | | | | | |
| 7605180B | head | 0.35 | 6 h 1050° C. | 1.782 | 1.810 | 1.908 | 2.008 | 2.028 | 2.114 | 0.334 | 10925 | 0.051 |
| 7605180B | head | 0.35 | 6 h 1050° C. + | 1.782 | 1.809 | 1.907 | 2.005 | 2.025 | 2.111 | 0.254 | 22632 | 0.039 |
| | | | 10 h 930° C. | | | | | | | | | |
| 7605180A | foot | 0.35 | 6 h 1050° C. | 1.784 | 1.811 | 1.907 | 2.004 | 2.023 | 2.109 | 0.370 | 9222 | 0.052 |
| 7605180A | foot | 0.35 | 6 h 1050° C. + | 1.791 | 1.817 | 1.912 | 2.010 | 2.030 | 2.115 | 0.287 | 18397 | 0.041 |
| | | | 10 h 930° C. | | | | | | | | | |

TABLE 29

| | 1^{st} onset | 1^{st} onset | Best Hc | |
|---|---|---|---|---|
| Batch 93/ | heating ( [symbol] ) | cooling ( [symbol] ) | in A/cm | Annealing |
| 323 | 940 | 932 | 0.348 | 4h 1150° C.+ 10h 910° C. |
| 328 | 934 | 914 | 0.369 | 4h 1050° C. Cooling at |
| | | | | 50° C./h + 10h, 910° C. |
| 329 | 952 | 933 | 0.367 | 4h 1050° C. + 10h 910° C. |
| 330 | 980 | 958 | 0.282 | 10h 1050° C. Cooling at |
| | | | | 50° C./h to 930° C. 10h OK |
| 420 | 988 | 964 | 0.347 | 4h 1000° C. + 60h 950° C. |
| 422 | 1017 | 979 | 0.382 | 4h 1100° C. + 10h 960° C. |
| 423 | 1037 | 994 | 0.593 | 4h 950° C. |
| 428 | 951 | 934 | 0.540 | 4h 1050° C. + 10h 910° C. |
| 429 | 947 | 934 | 0.465 | 4h 1050° C. + 10h 910° C. |
| 430 | 944 | 932 | 0.520 | 4h 1050° C. + 10h 910° C. |
| 431 | 950 | 931 | 0.572 | 4h 1050° C. + 10h 910° C. |
| 432 | 946 | 925 | 0.516 | 4h 1050° C. + 10h 910° C. |
| 433 | 949 | 929 | 0.412 | 4h 1050° C. + 10h 910° C. |
| 434 | 944 | 921 | 0.495 | 4h 1050° C. + 10h 910° C. |
| 435 | 953 | 932 | 0.404 | 4h 1050° C. + 10h 910° C. |
| 436 | 952 | 931 | 0.402 | 4h 1050° C. + 10h 910° C. |
| 437 | 954 | 934 | 0.409 | 4h 1050° C. + 10h 910° C. |
| 438 | 955 | 934 | 0.406 | 4h 1050° C. + 10h 910° C. |
| 439 | 958 | 936 | 0.578 | 4h 1050° C. |
| 440 | 954 | 934 | 0.331 | 4h 1050° C. + 10h 910° C. |
| 441 | 952 | 932 | 0.313 | 4h 1050° C. + 10h 910° C. |
| 443 | #NV | 1012 | 0.792 | 4h 1050° C. |
| | | | | OK = Furnace cooling |

| Cooling from T1 at 150K/h unless otherwise indicated | |
|---|---|
| Cooling from T2 at 150K/h unless otherwise indicated | |
| | ″+″ signifies 2 separate annealing processes |

1. A method for the production of a soft magnetic alloy comprising:
providing a preliminary product with a composition consisting essentially of:

| | | | | |
|---|---|---|---|---|
| 5 | wt % | ≤ Co | ≤ 25 | wt % |
| 0.3 | wt % | ≤ V | ≤ 5.0 | wt % |
| 0 | wt % | ≤ Cr | ≤ 3.0 | wt % |
| 0 | wt % | ≤ Si | ≤ 3.0 | wt % |
| 0 | wt % | ≤ Mn | ≤ 3.0 | wt % |
| 0 | wt % | ≤ Al | ≤ 3.0 | wt % |
| 0 | wt % | ≤ Ta | ≤ 0.5 | wt % |
| 0 | wt % | ≤ Ni | ≤ 0.5 | wt % |
| 0 | wt % | ≤ Mo | ≤ 0.5 | wt % |
| 0 | wt % | ≤ Cu | ≤ 0.2 | wt % |
| 0 | wt % | ≤ Nb | ≤ 0.25 | wt % |
| 0 | wt % | ≤ Ti | ≤ 0.05 | wt % |
| 0 | wt % | ≤ Ce | ≤ 0.05 | wt % |
| 0 | wt % | ≤ Ca | ≤ 0.05 | wt % |
| 0 | wt % | ≤ Mg | ≤ 0.05 | wt % |
| 0 | wt % | ≤ C | ≤ 0.02 | wt % |
| 0 | wt % | ≤ Zr | ≤ 0.1 | wt % |
| 0 | wt % | ≤ O | ≤ 0.025 | wt % |
| 0 | wt % | ≤ S | ≤ 0.015 | wt % |

residual iron, Cr+Si+Al+Mn being ≤3.0 wt %, and up to 0.2 wt % of other impurities, heat treating the preliminary product at a temperature T₁ and then cooling from T₁ to room temperature, or
heat treating the preliminary product at a temperature T₁ and then at a temperature T₂, where T₁>T₂,
wherein the preliminary product has a phase transition from a BCC phase region to a mixed BCC/FCC region to an FCC phase region, as the temperature increases the phase transition between the BCC phase region and the mixed BCC/FCC region taking place at a first transition temperature T_{Ü1}, and as the temperature increases further the transition between the mixed BCC/FCC region and the FCC phase region taking place at a second transition temperature T_{Ü2}, where T_{Ü2}>T_{Ü1}, T₁ is above T_{Ü2} and T₂ is below T_{Ü1}.

2. A method according to claim 1, wherein for a sample mass of 50 mg and a DSC heating rate of 10 Kelvin per minute the transition temperature T_{Ü1} is above 900° C.

3. A method according to claim 1, wherein 900° C.≤T₁<Tₘ, 700° C.≤T₂≤1050° C., T₂<T₁, and Tₘ is the solidus temperature.

4. A method according to claim 1, wherein the difference T_{Ü2}−T_{Ü1} is less than 45K.

5. A method according to claim 1, wherein the cooling rate over at least the temperature range T₁ to T₂ is 10° C./h to 50,000° C./h.

6. (canceled)

7. A method according to claim 1, wherein the preliminary product is heat treated for a period of over 30 minutes at above T_{Ü2}, and then cooled to T₂.

8. (canceled)

9. A method according to claim 1, wherein the preliminary product is cooled from T₁ to T₂, heat treated at T₂ for a period t₂, 30 minutes being≤t₂≤20 hours, and then cooled from T₂ to room temperature.

10. A method according to claim 1, wherein the preliminary product is cooled from T₁ to room temperature and then heated from room temperature to T₂.

11. (canceled)

12. (canceled)

13. (canceled)

14. A method according to claim 1, wherein after heat treatment the soft magnetic alloy has a maximum permeability μₘₐₓ≥5,000, and/or an electrical resistance ρ≥0.25 μΩm, hysteresis losses P_{Hys}≤0.07 J/kg at an amplitude of 1.5 T, and/or a coercive field strength H_{c} of ≤0.7 A/cm and/or an induction B≥1.90 T at 100 A/cm.

15. A method according to claim 14, wherein after heat treatment the soft magnetic alloy has a maximum permeability μₘₐₓ≥10,000, and/or an electrical resistance ρ≥0.25 μΩm, and/or hysteresis losses P_{Hys}≤0.06 J/kg at an amplitude of 1.5 T, and/or a coercive field strength H_{c} of ≤0.6 A/cm and an induction B≥1.95 T at 100 A/cm.

16. A method according to claim 15, wherein after heat treatment the soft magnetic alloy has a maximum permeability μₘₐₓ≥12,000, and/or an electrical resistance ρ≥0.30 μΩm, and/or hysteresis losses P_{Hys}≤0.05 J/kg at an amplitude of 1.5 T, and/or a coercive field strength H_{c} of ≤0.5 A/cm, and/or an induction B≥2.00 T at 100 A/cm.

17. A method according to claim 1, wherein a maximum difference in coercive field strength H_{c} measured parallel to the direction of rolling, measured diagonally (45°) to the direction of rolling or measured perpendicular to the direction of rolling between these two directions is at most 6%.

18. A method according to claim 1, wherein the heat treatment is carried out in a hydrogen-containing atmosphere or in an inert gas.

19. (canceled)

20. (canceled)

21. A method according to claim 1, wherein prior to heat treatment the preliminary product has a cold-rolled texture or a fiber texture.

22. A method according to claim 1, wherein the preliminary product has the form of one or more sheets or one or more laminated cores.

23. A method according to claim 1, wherein the preliminary product initially has the form of a strip from which at least one sheet is produced by stamping, laser cutting or water jet cutting, wherein the heat treatment is performed on one or more sheets.

24. A method according to claim 23, wherein following heat treatment several sheets are:
stuck together by an insulating adhesive to form a laminated core, or
surface oxidised to form an insulating layer and then stuck or laser welded together to form a laminated core, or
coated with an inorganic-organic hybrid coating and then further processed to form a laminated core.

25. A method according to claim 1, wherein the preliminary product initially has the form of a laminated core and the heat treatment is carried out on one or more laminated cores.

26. A method according to claim 1, also comprising:
providing by use of vacuum induction melting, electroslag remelting or vacuum arc remelting of a molten mass consisting essentially of:

| | | | | |
|---|---|---|---|---|
| 5 | wt % | ≤ Co | ≤ 25 | wt % |
| 0.3 | wt % | ≤ V | ≤ 5.0 | wt % |
| 0 | wt % | ≤ Cr | ≤ 3.0 | wt % |
| 0 | wt % | ≤ Si | ≤ 3.0 | wt % |
| 0 | wt % | ≤ Mn | ≤ 3.0 | wt % |
| 0 | wt % | ≤ Al | ≤ 3.0 | wt % |
| 0 | wt % | ≤ Ta | ≤ 0.5 | wt % |
| 0 | wt % | ≤ Ni | ≤ 0.5 | wt % |
| 0 | wt % | ≤ Mo | ≤ 0.5 | wt % |
| 0 | wt % | ≤ Cu | ≤ 0.2 | wt % |
| 0 | wt % | ≤ Nb | ≤ 0.25 | wt % |
| 0 | wt % | ≤ Ti | ≤ 0.05 | wt % |
| 0 | wt % | ≤ Ce | ≤ 0.05 | wt % |
| 0 | wt % | ≤ Ca | ≤ 0.05 | wt % |
| 0 | wt % | ≤ Mg | ≤ 0.05 | wt % |
| 0 | wt % | ≤ C | ≤ 0.02 | wt % |
| 0 | wt % | ≤ Zr | ≤ 0.1 | wt % |
| 0 | wt % | ≤ O | ≤ 0.025 | wt % |
| 0 | wt % | ≤ S | ≤ 0.015 | wt % |

residual iron, Cr+Si+Al+Mn being ≤3.0 wt %, and up to 0.2 wt % of other impurities,
solidifying the molten mass to form a ingot,
mechanically forming the ingot, the mechanical forming being carried out by hot rolling and/or forging and/or cold forming.

27. A method according to claim 26, wherein the ingot is mechanically formed by hot rolling at temperatures of between 900° C. and 1300° C. to form a slab and then to form a hot strip with a thickness D₁, and is then formed by cold rolling to form a band with a thickness D₂, 0.05 mm≤D₂≤1.0 mm and D₂<D₁.

28. A method according to claim 26, wherein a hot strip of thickness D₁ is initially produced by continuous casting and then mechanically formed by cold rolling to form a strip of thickness D₂, 0.05 mm≤D₂≤1.0 mm and D₂<D₁.

29. A method according to claim 27, wherein the degree of cold working by cold rolling is >40%.

30. (canceled)

31. (canceled)

32. A method according to claim 29, further comprising an intermediate annealing.

33. A method according to claim 1, wherein T_{Ü1}>T_{c}, wherein T_{c} the Curie temperature and T_{c} is ≥900° C.

34. A method according to claim 33, wherein T_{Ü1}>T₂>T_{c} is selected.

35. A method according to claim 1, wherein after heat treatment the average grain size is at least 100 μm.

36. A method according to claim 1, wherein after heat treatment the measured density of the annealed alloy is more than 0.10% lower than the density calculated using the rule of three from the average atomic weight of the metallic elements in the alloy, the average atomic weight of the metallic elements in the corresponding binary FeCo alloy and the measured density of this annealed binary FeCo alloy.

37. A method according to claim 1, wherein after heat treatment the measured density of the annealed alloy is 0.20% to 0.35% lower than the density calculated using the rule of three from the average atomic weight of the metallic elements in the alloy, the average atomic weight of the metallic elements in the corresponding binary FeCo alloy and the measured density of this annealed binary FeCo alloy.

38. A method according to claim 26, wherein during heat treatment the sulphur content is reduced in a H₂-containing inert gas atmosphere.

39. A method according to claim 1, further comprising coating the preliminary product with an oxide layer for electrical insulation.

40. (canceled)

41. A method according to claim 39, wherein the preliminary product is heat treated in an atmosphere containing oxygen or water vapour to form an electrically insulating layer.

42. A soft magnetic alloy consisting substantially of:

| | | | | |
|---|---|---|---|---|
| 5 | wt % | ≤ Co | ≤ 25 | wt % |
| 0.3 | wt % | ≤ V | ≤ 5.0 | wt % |
| 0 | wt % | ≤ Cr | ≤ 3.0 | wt % |
| 0 | wt % | ≤ Si | ≤ 3.0 | wt % |
| 0 | wt % | ≤ Mn | ≤ 3.0 | wt % |
| 0 | wt % | ≤ Al | ≤ 3.0 | wt % |
| 0 | wt % | ≤ Ta | ≤ 0.5 | wt % |
| 0 | wt % | ≤ Ni | ≤ 0.5 | wt % |
| 0 | wt % | ≤ Mo | ≤ 0.5 | wt % |
| 0 | wt % | ≤ Cu | ≤ 0.2 | wt % |
| 0 | wt % | ≤ Nb | ≤ 0.25 | wt % |
| 0 | wt % | ≤ Ti | ≤ 0.05 | wt % |
| 0 | wt % | ≤ Ce | ≤ 0.05 | wt % |
| 0 | wt % | ≤ Ca | ≤ 0.05 | wt % |
| 0 | wt % | ≤ Mg | ≤ 0.05 | wt % |
| 0 | wt % | ≤ C | ≤ 0.02 | wt % |
| 0 | wt % | ≤ Zr | ≤ 0.1 | wt % |
| 0 | wt % | ≤ O | ≤ 0.025 | wt % |
| 0 | wt % | ≤ S | ≤ 0.015 | wt % |

residual iron, Cr+Si+Al+Mn being ≤3.0 wt %, and up to 0.2 wt % of other impurities, and having a maximum permeability being μₘₐₓ≥5,000.

43. A soft magnetic alloy according to claim 42, wherein the soft magnetic alloy has an electrical resistance ρ≥0.25 μΩm, and/or hysteresis losses of P_{Hys}≤0.07 J/kg at an amplitude of 1.5 T, a coercive field strength H_{c} of ≤0.7 A/cm, and/or an induction B≥1.90 T at 100 A/cm.

44. A soft magnetic alloy according to claim 42, wherein 10 wt %≤Co≤20 wt %.

45. A soft magnetic alloy according to claim 42, wherein 0.5 wt %≤V≤4.0 wt %.

46. A soft magnetic alloy according to claim 42, wherein 0.1 wt %≤Cr≤2.0 wt %.

47. A soft magnetic alloy according to claim 42, wherein 0.1 wt %≤Si≤2.0 wt %.

48. A soft magnetic alloy according to claim 42, wherein 0.1 wt %≤Cr+Si+Al+Mn≤1.5 wt %.

49. An electric machine including a soft magnetic alloy according to claim 42.
